(19) United States
(12) Patent Application Publication
(10) Pub. No.: US 2013/0208100 A1
(43) Pub. Date: Aug. 15, 2013

(54) METHOD AND DEVICE FOR FORMING AND OBSERVING STEREO IMAGES HAVING MAXIMUM SPATIAL RESOLUTION

(71) Applicant: VASILY ALEXANDROVICH EZHOV, Moscow (RU)

(72) Inventor: VASILY ALEXANDROVICH EZHOV, Moscow (RU)

(21) Appl. No.: 13/850,831

(22) Filed: Mar. 26, 2013

Related U.S. Application Data
(63) Continuation-in-part of application No. 13/141,628, filed on Oct. 18, 2011, now abandoned.

(30) Foreign Application Priority Data
Dec. 25, 2008 (RU) 2008151367

(51) Int. Cl. H04N 13/04

(52) U.S. Cl. CPC H04N 13/0409
USPC 348/58

(57) ABSTRACT

Systems and methods are described for forming and observing three-dimensional images and, more particularly, to stereoscopic video technology. The systems and methods can be used to make stereoscopic and autostereoscopic (e.g., glasses-free or naked eye) television sets and monitors based on different optical structures with maximum spatial resolution at each view of the stereo image, equal to full spatial resolution of optical structures. The systems and methods permits the manufacture of flat-panel autostereoscopic displays using crystal (LC) matrices of practically any type and provides for the autocompensation of nonlinearity of the transmission characteristics of the matrices.

### CROSS-REFERENCE TO RELATED APPLICATION

The instant application is a continuation-in-part of and claims priority to U.S. patent application Ser. No. 13/141,628 filed Oct. 18, 2011, pending, is a national phase of PCT International Patent Application Serial No. PCT/IB2009/007865, filed Dec. 22, 2009, expired, and claims priority to Russian Patent Application Serial No. 2008151367, filed Dec. 25, 2008, issued, the entire specifications of all of which are expressly incorporated herein by reference.

### FIELD OF THE INVENTION

The invention relates to technology for forming and observing three-dimensional images and, more particularly, to stereoscopic video technology. The invention can be used to make stereoscopic and autostereoscopic (e.g., glasses-free or naked eye) television sets and monitors based on different optical structures with maximum spatial resolution at each view of the stereo image, equal to full spatial resolution of optical structures. The invention permits the manufacture of flat-panel autostereoscopic displays using crystal (LC) matrices of practically any type and provides for the autocompensation of nonlinearity of the transmission characteristics of the matrices.

### BACKGROUND OF THE INVENTION

A method [e.g., see Ref. 1 below] is known for forming and observing stereo images with maximum spatial resolution comprising: receiving a light wave from an optical source, providing a real-amplitude optical modulator, which is matrix addressed in M rows and N columns, to modulate an intensity of the light wave in the mn^{th} element of the real-amplitude optical modulator in accordance with the sum of the values Bₘₙ^{L} and Bₘₙ^{R} of brightness of mn^{th} elements of images of left and right views, wherein n=1, 2, . . . , N, m=1, 2, . . . , M; providing phase-polarization optical modulator, which is matrix addressed in M rows and N columns, to implement a polarization coding of the light wave in the mn^{th} element of the phase-polarization optical modulator in accordance with trigonometric functions of algebraic relations between values Bₘₙ^{L} and Bₘₙ^{R} of brightness of mn^{th} elements of images of the left and right views; providing passive polarization stereo glasses with the first and second complementary polarization analysers which are arranged in the left and right observation windows of the passive polarization stereo glasses to implement polarization decoding by converting light modulation characteristic into light intensity modulation, whereas forming the first and second light fluxes with intensities Jₘₙ^{L} and Jₘₙ^{R} in the left and right observation windows, wherein the intensity values Jₘₙ^{L} and Jₘₙ^{R} are equal to the values Bₘₙ^{L} and Bₘₙ^{R} of brightness of mn^{th} elements of images of the left and right views respectively.

The basic advantage of the known method [e.g., see Ref. 1 below] is the maximum information content of the stereo image. This is due to simultaneous reproduction of left mn^{th} and right mn^{th} image elements in one mn^{th} display element (e.g., pixel) caused by information-dependent polarization coding-decoding of light flux. Actually, two images of the left and right views are simultaneously reproduced, each with M·N number of resolvable elements, on a single display screen with M·N resolvable elements.

A disadvantage of the prior art is the need for the observer to use special means for stereo image observing—passive stereo glasses, which reduces the comfort of observing.

A method [e.g., see Ref. 2 below] of autostereoscopic (e.g., glasses-free) forming and observation of stereo images with maximum spatial resolution is known, receiving a light wave from an optical source, providing a real-amplitude optical modulator, which is matrix addressed in M rows and N columns, to modulate an intensity of the light wave in the mn^{th} element of the real-amplitude optical modulator in accordance with the sum of the values Bₘₙ^{L} and Bₘₙ^{R} of brightness of mn^{th} elements of images of left and right views, wherein n=1, 2, . . . , N, m=1, 2, . . . , M; providing phase-polarization optical modulator, which is matrix addressed in M rows and N columns, to implement a polarization coding of the light wave in the mn^{th} element of the phase-polarization optical modulator in accordance with trigonometric functions of algebraic relations between values Bₘₙ^{L} and Bₘₙ^{R} of brightness of mn^{th} elements of images of the left and right views; providing a N-column-addressed spatially-selective phase-polarization converter to implement a polarization decoding by converting light modulation characteristic into light intensity modulation to form one group of M·N light beams, carrying M·N elements of the left image view, and directing them to the left observation zone and forming and simultaneously to form another group of M·N light beams, carrying M·N elements of the left image view, and directing them to the right observation zone.

A corresponding device [e.g., see Ref. 2 below] is also known for implementation of the known method of autostereoscopic forming and observing of stereo images with maximum spatial resolution.

The known method and device [e.g., see Ref. 2 below] ensure viewing of the stereo image without stereo glasses with providing maximum full resolution M·N of the display for each of two simultaneously reproduced views.

The known technical disclosures [e.g., see Refs. 1 and 2 below] can be implemented only if the analytical dependence of the light polarization state on the degree of electrically controlled optical anisotropy of the working medium is known. Specifically, the value of an electrically controlled birefringence (ECB) or the ability to rotate the polarization plane—an electrically controlled optical activity (ECOA) should be known. The first case corresponds, for example, to using the phase-polarization optical modulator which comprise an oriented layer of nematic liquid crystal (LC) with positive or negative dielectric anisotropy and with a simple configuration of the control transparent electrodes. Such configuration allows to direct all the electric field force lines orthogonally to the boundary planes of the LC layer. In this case it is possible to determine analytically the dependence of light polarization state on the value of electrically controlled phase delay between ordinary and extraordinary rays in the LC layer. In the second case, for example, the LC twist structure (90°-twist of LC molecules) is used with the same simple configuration of electric field lines. So, in such LC twist structure, it is possible to determine analytically the polarization state of the output light caused by electrically variable value of the angle of rotation of the polarization plane.

However, the polarization encoding algorithm is difficult to define analytically even for simple combinations of the ECB and ECOA effects because it is necessary to take into account the mutual interaction of these effects. But, many fast flat-panel displays with high resolution, contrast and wide viewing angle are developed on base of advanced LC matrices. Such LC matrices are characterized by complicated orientation of LC molecules and three-dimensional structure of electric field lines, leading to extremely complex combinations of various electro-optical effects. For example, the ECOA effect in helical structures of LC molecules (with different values of twisting angle for separate molecules) are combined with the reorientation of LC molecules caused by the ECB effect. So, it is problematic to use such advanced LC structures in the prior art.

Another disadvantage of the prior art is the complexity of accounting for the spurious (reducing stereo image quality) nonlinearities of transmission characteristics of optical structures. It is difficult to determine analytically all the spurious nonlinearities.

Therefore, in fact, only two electrooptic effects (ECOA and ECB) can be used for polarization coding in prior art.

Furthermore, polarization coding is a special case of the general optical encoding. The latter in fact can be implemented using any optical effect, allowing to create two complementary (supplementing each other or mutually opposite to each other) optical encoding states. However, the analytical calculation of each particular optical coding is problematic.

The various kinds of light wave modulation require using the various types of controlled optical components or their combinations. In the general case, it is problematic to calculate analytically the influence of each optical component or their combinations on the resulting intensity value of the light flux in the prior art.

Accordingly, there exists a need for new and improved systems and methods for forming and observing stereo images having maximum spatial resolution that overcome at least one of the aforementioned disadvantages.

### INFORMATION SOURCES

The following list includes reference materials discussed herein and does not constitute an admission that any of the same are prior art to the claimed invention.
1. Ezhov, V., “Method for Forming Stereo Images with Integrated Presentation of Views and Device for its Implementation,” Patent No. RU2306680, published Sep. 20, 2007.
2. Ezhov V., “Stereoscopic Method and a Device for Implementation Thereof,” U.S. Pat. No. 7,929,066, issued Apr. 19, 2011.
3. Blinov, L. M. Electro- and Magneto-optics of Liquid Crystals. M., Nauka, 1974.
4. Yang, D. K., Wu, S. T. Mains of Liquid Crystal Devices. Wiley Publishing House, 2006.
5. Born, M., Volf, E. Mains of Optics. M., Nauka, 1974.
6. Ukai, Y. et al. Current and Future Properties of In-cell Polarizer Technology. Journal of the SID, 2005, v. 13, No. 1, pp. 17-24.
7. Paukshto, M. et al. Optics of Sheared LC Polarizer . . . Journal of the SID, 2005, v. 13, No. 9, pp. 765-772.

### SUMMARY OF THE INVENTION

An object of the invention is to improve the quality of stereo images by providing the possibility to use various advanced optical structures regardless of their complexity and regardless of using stereo glasses.

According to one aspect of the present invention, the sum modulation of the light flux may be implemented in mn^{th} element (pixel) of an optical modulator controlled by a sum signal. Such an optical modulator is referred to as a sum optical modulator. The ratio modulation of the light flux may be implemented in mn^{th} element (pixel) of an optical modulator which control input may be driven by a ratio signal. Such an optical modulator may be referred to as a ratio optical modulator.

In a first embodiment of the method, the optical converters with complementary optical characteristics may be used to convert the sum and ratio modulation of the light flux into light intensity variations in the left formation window W_{form}^{L} and right formation window W_{form}^{R}. Thus the mn^{th} element of left view image with brightness Bₘₙ^{L} may be formed in the left formation window W_{form}^{L} and the mn^{th} element of right view image with brightness Bₘₙ^{R} may be formed in the right formation window W_{form}^{R}. The left and right view images may be observed in the left W_{V}^{L} and right W_{V}^{R} observation windows which may be optically coupled with the left W_{form}^{L} and right W_{form}^{L} formation windows accordingly. The first and second optical converters may be fulfilled, for example, in the form of passive observation glasses.

In a second embodiment of the method, a N-column spatially selective optical converter may be used with complementary optical conversion parameters in its adjacent 2k and (2k−1) columns (wherein k=1, 2, . . . , N) for converting light modulation characteristic into light intensity modulation to form M·N light beams with corresponding number of left image view elements to the left formation zone Z_{form}^{L} and M·N light beams with corresponding number of right image view elements to the right formation zone Z_{form}^{R}. The left and right observation zones Zₘₙ^{L} and Zₘₙ^{R} may be used for autostereoscopic observation.

It a corresponding device, it may be used with a N-column spatial-selective optical converter with complementary optical conversion parameters in its adjacent 2k and (2k−1) columns, wherein k=1, 2, . . . , N; and the axis of symmetry of the left formation zone Z_{form}^{L} may be the common intersection line of the first group of N planes, the axis of symmetry of the right formation zone Z_{form}^{R} may be the common intersection line of second group of N planes, wherein each plane may pass through the symmetry axis of the corresponding column of the N-column spatial-selective optical converter.

Any light modulation effect may be used accordingly with the invention to implement the sum and ratio modulation of the light flux. The characteristics of the sum and ratio modulation may be linearized using the calibration procedures and calculating the inverse or reciprocal functions taken from nonlinear calibration functions. The calibration procedures may be implemented by measuring the intensity of the light flux in the left and right formation windows (zones) while applying the calibration signals to the control inputs of the sum and ratio optical modulators. So, the desired calibration functions of nonlinearity of the sum and ratio modulation of light flux may be obtained. As the result of the linearization, the linear reproduction of the sum Jₘₙ^{L}+Jₘₙ^{R}·Bₘₙ^{L}+Bₘₙ^{R} of the brightness values in both formation windows W_{form}^{L},W_{form}^{R} together with the linear reproduction of the ratio of values Jₘₙ^{L}/Jₘₙ^{R}˜Bₘₙ^{L}/Bₘₙ^{R} between the formation windows may be provided. Joint implementation of these both conditions inevitably leads to fulfillment of the conditions Jₘₙ^{L}=Bₘₙ^{L} and Jₘₙ^{R}=J_{Mn}^{R} corresponding to desired separation of the left and right views in the left and right formation windows (zones).

The result is the enhancement of stereo image quality by providing a possibility to use the various advanced optical structures along with implementing automatic compensation of all nonlinearities of transmission characteristics of the optical structures regardless of their complexity.

A real-amplitude sum modulation in combination with a ratio phase-polarization modulation may be used in the first, second and third embodiments of the method and in the first and second embodiments of the device. A spectral ratio modulation and diffraction (angular) ratio modulation may be used respectively in the third and fourth embodiments of the method. A bistable ratio modulation may be used in the fifth embodiment of the method. The polarization analyzer or spectral analyzer or optical louver analyzer may be used as the particular optical converters to convert accordingly polarization or spectral or angular modulation of the light wave into light intensity variations.

The increase in optical efficiency of image formation may be the additional advantage of the second embodiment of the device.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a schematic view of the implementation of the first embodiment of the method;

FIG. 2 illustrates a schematic view of the calibration (measurement of nonlinearity function) and determination (calculation) of a linearization function for the first embodiment of the method;

FIGS. 3 and 4 illustrate schematic views of the method as a combined performance of two optoelectronic channels, linearized relative to light intensity;

FIGS. 5 and 6 illustrate schematic views of the implementation of the second embodiment of the method;

FIG. 7 illustrates a schematic view of the calibration of the second embodiment of the method;

FIGS. 8 and 9 illustrate schematic views of the implementation and calibration of the preferred variant of the first embodiment of the method;

FIGS. 10 and 11 illustrate graphical views of the sum modulation linearization by taking an inverse function;

FIG. 12 illustrates a graphical view of the sum modulation linearization by calculating reciprocal values;

FIGS. 13 and 14 illustrate graphical views of the ratio modulation linearization by taking an inverse function;

FIG. 15 illustrates a graphical view of the ratio modulation linearization by calculating reciprocal values;

FIGS. 16 and 17 illustrate schematic views of the implementation of the preferred variant of the second embodiment of the method;

FIGS. 18 and 19 illustrate schematic views of a calibration procedure and the selection of views for preferred variant of the second embodiment of the method;

FIG. 20 illustrates a schematic view of the appearance of secondary formation windows;

FIGS. 21-23 illustrate schematic and graphical views of the implementation, calibration schemes and linearization graphs for the third embodiment of the method;

FIGS. 24-27 illustrate schematic and graphical views of the implementation, calibration schemes and linearization graphs for the fourth embodiment of the method;

FIGS. 28-31 illustrate schematic and graphical views of the implementation, calibration schemes and linearization graphs for the fifth embodiment of the method;

FIGS. 32 and 33 illustrate schematic views of the implementation and calibration for the sixth embodiment of the method;

FIG. 34 illustrates a matrix representation of a two-dimensional linearization function of the ratio modulation in the sixth embodiment of the method;

FIG. 35 illustrates a graphical view of the appearance of the asymmetry in the sum modulation graphs in presence of nonlinear interaction between the sum and ratio modulation;

FIGS. 36 and 37 illustrate schematic views of the implementation schemes of the seventh embodiment of the method;

FIG. 38 illustrates a matrix representation of two-dimensional linearization functions for the seventh embodiment of the method;

FIGS. 39 and 40 illustrate schematic views of the first embodiment of the device;

FIGS. 41-43 illustrate a matrix representation of the optical states of the sum and ratio optical modulators and an optical converter in the device;

FIGS. 44 and 45 illustrate schematic view of the operation of the second embodiment of the device;

FIGS. 46-49 illustrate schematic views of the principle of operation of phase-polarization LC cells which is preferable to use for implementation of the ratio modulation;

FIG. 50 illustrates a graphical view of the general description of properties of anisotropic optical elements with the help of a Poincare sphere; and

FIGS. 51-53 illustrate schematic views of the principles of operation of polaroid-less LC cells which can be used for implementation of the sum modulation.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

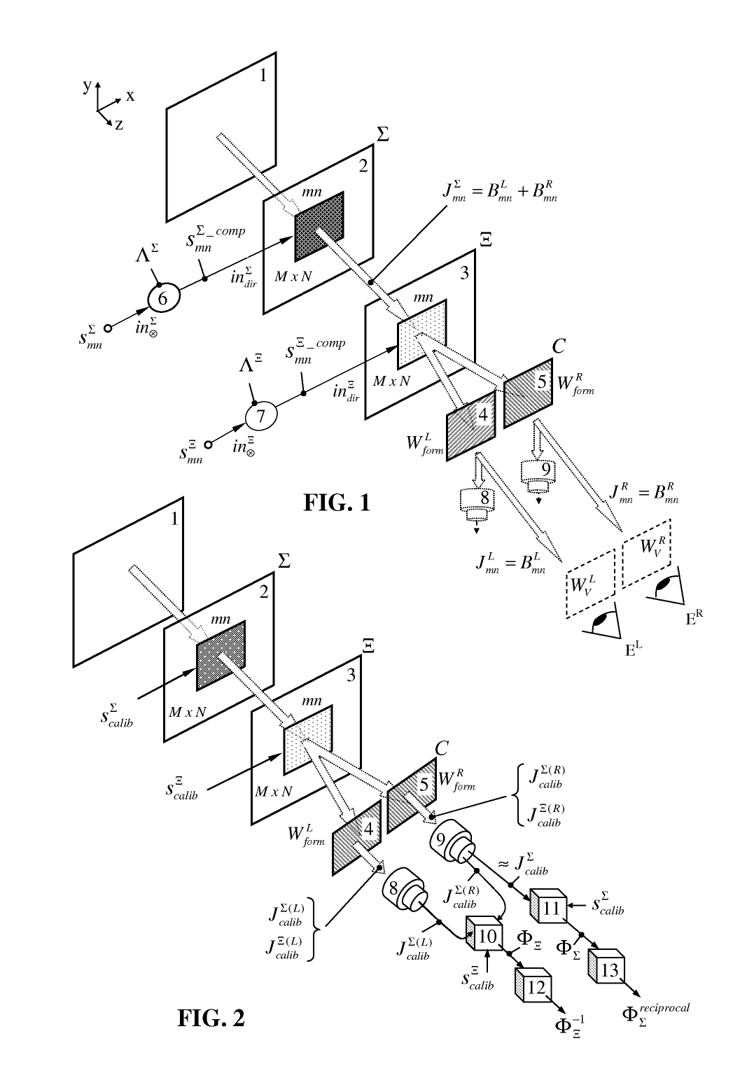

The first embodiment of the method of forming and observing stereo images with maximum spatial resolution (e.g., see FIG. 1), comprises:

receiving a light wave from an optical source 1;

providing the first optical modulator 2, which may be matrix-addressed in M rows and N columns, for modulating light wave intensity to implement a sum modulation of the light wave in the mn^{th} element of the first optical modulator (m=1, 2, . . . M; n=1, 2, . . . N), wherein applying to the control input of the first optical modulator 2 a compensating sum signal sₘₙ^{Σ}^{_{—}}^{comp} which amplitude may be directly proportional to the linearization function Λ^{Σ} of the sum modulation;

providing the second optical modulator 3, that may be matrix-addressed in M rows and N columns, for modulating light wave polarization to implement a ratio modulation of the light wave in the mn^{th} element of the second optical modulator 3, whereas applying to the control input of the second optical modulator 3 a ratio compensating signal sₘₙ^{Ξ}^{_{—}}^{comp} which amplitude may be directly proportional to the linearization function Λ^{Ξ} of the ratio modulation;

providing the first and second optical converters 4, 5 with complementary optical conversion parameters for converting light wave modulation characteristic into light intensity modulation to form the first and second light fluxes in the left W_{form}^{L} and right W_{form}^{R} formation windows with the intensity values Jₘₙ^{L} and Jₘₙ^{R} which may be equal to the values Bₘₙ^{L} and Bₘₙ^{R} of brightness of mn^{th} elements of images of the left and right views respectively; and

observing left and right views of the stereo image in the left W_{V}^{L} and right W_{V}^{R} observation windows, which may be optically coupled with the left W_{form}^{L} and right W_{form}^{R} formation windows respectively.

Various embodiments of the method relate to modulating various characteristics of the light wave to implement the sum and ratio modulation and using corresponding optical converters (e.g., analyzers) with various physical mechanisms to convert the sum and ratio modulation of the light flux into corresponding variations of its intensity. The first (sum) optical modulator may modulate a polarization state or propagation direction or divergence angle or convergence angle or spectrum or phase or combination of the said characteristics to implement the sum modulation of the light wave. Respectively, the second (ratio) optical modulator may modulate the intensity or propagation direction or divergence angle or convergence angle or spectrum or phase of the light wave or combination of the characteristics to implement the ratio modulation.

The first compensating sum signal sₘₙ^{Σ}^{_{—}}^{comp} may be directly proportional to the value of the first linearization function Λ₍₁₎^{Σ} of the sum modulation taken from the sum Bₘₙ^{L}+Bₘₙ^{R} of the values of the brightness of the mn^{th} image elements of the left and right views:

$${s}_{( 1 ) mn}^{Σ \_ comp} \approx {Λ}_{( 1 )}^{Σ} \{ {B}_{mn}^{L} + {B}_{mn}^{R} \} . \qquad ( 1 )$$

The second compensating sum signal s₍₂₎ₘₙ^{Σ}^{_{—}}^{comp} may be directly proportional to the product of the sum Bₘₙ^{L}+Bₘₙ^{R} into the second linearization function Λ₍₂₎^{Σ} of the sum modulation:

$${s}_{( 2 ) mn}^{Σ \_ comp} \approx ( {B}_{mn}^{L} + {B}_{mn}^{R} ) \cdot {Λ}_{( 2 )}^{Σ} , \qquad ( 2 )$$

The first compensating ratio signal s₍₁₎ₘₙ^{Ξ}^{_{—}}^{comp} may be directly proportional to the first linearization function Λ₍₁₎^{Ξ} of the ratio modulation, taken from the ratio Bₘₙ^{L}/Bₘₙ^{R} of the values of the brightness in the mn^{th} image elements of the left and right views:

$${s}_{( 1 ) mn}^{Ξ \_ comp} \approx {Λ}_{( 1 )}^{Ξ} \{ {B}_{mn}^{L} / {B}_{mn}^{R} \} . \qquad ( 3 )$$

The second compensating ratio signal s₍₂₎ₘₙ^{Ξ}^{_{—}}^{comp} may be directly proportional to the product of the ratio Bₘₙ^{L}/Bₘₙ^{R} into the second linearization function Σ₍₂₎^{Ξ} of the ratio modulation:

$${s}_{( 2 ) mn}^{Ξ \_ comp} \approx ( {B}_{mn}^{L} / {B}_{m}^{R} ) \cdot {Λ}_{( 2 )}^{Ξ} . \qquad ( 4 )$$

The first linearization function Λ₍₁₎^{Σ} of the sum modulation may be the inverse function F⁻¹{Φ₍₁₎^{Σ} of the first calibration function Φ}₍₁₎^{Σ} of sum modulation nonlinearity:

$${Λ}_{( 1 )}^{Σ} = {F}^{- 1} \{ {Φ}_{( 1 )}^{Σ} \} . \qquad ( 5 )$$

The second linearization function Λ₍₂₎^{Σ} of sum modulation may be the reciprocal function F_{reciprocal}{(Φ₍₂₎^{Σ}}1/Φ₍₂₎^{Σ} of the second calibration function Φ₍₂₎^{Σ} of the sum modulation nonlinearity:

$${Λ}_{( 2 )}^{Σ} = {F}^{reciprocal} \{ {Φ}_{( 2 )}^{Σ} \} = 1 / {Φ}_{( 2 )}^{Σ} . \qquad ( 6 )$$

The first linearization function Λ₍₁₎^{Ξ} of the ratio modulation may be the inverse function F⁻¹{Φ₍₁₎^{Ξ}} of the first calibration function Φ₍₁₎^{Ξ} of the ratio modulation nonlinearity:

$${Λ}_{( 1 )}^{Ξ} = {F}^{- 1} \{ {Φ}_{( 1 )}^{Ξ} \} . \qquad ( 7 )$$

The second linearization function Λ₍₂₎^{Ξ} of the ratio modulation may be the reciprocal function F^{reciprocal}{Φ₍₂₎^{Ξ}} of the second calibration function Φ₍₂₎^{Ξ} of the ratio modulation nonlinearity:

$${Λ}_{( 2 )}^{Ξ} = {F}^{reciprocal} \{ {Φ}_{( 2 )}^{Ξ} \} = 1 / {Φ}_{( 2 )}^{Ξ} . \qquad ( 8 )$$

The calibration functions of nonlinearity of the sum and ratio modulation may be obtained during the calibration procedure of the optoelectronic channels.

The first calibration function Φ₍₁₎^{Σ} of the sum modulation nonlinearity may be equal to the assemblage of the calibration values of the sum modulated component J_{calib}^{Σ} of the light flux intensity in either of the formation windows W_{form}^{L}, W_{form}^{R} (e.g., see FIG. 2):

Φ₍₁₎^{Σ}J=_{calib}^{Σ}, (9)

whereas a linearly-varying calibration signal s_{calib}_{_{—}}ₗᵢₙ^{Σ} of the sum modulation may be applied to the control input in_{dir}^{Σ} of the ratio optical modulator 2.

The second calibration function Φ₍₂₎^{Σ} of sum modulation nonlinearity may be equal to the sequence of calibration values of ratio modulated component J_{calib}^{Σ} of the light flux intensity in either of the formation windows W_{form}^{L}, W_{form}^{R} divided by the sequence of the corresponding values of the amplitude of the monotonically-varying calibration signal s_{calib}^{Σ} of the sum modulation:

Φ₍₂₎^{Σ}≈J_{calib}^{Σ}/s_{calib}^{Σ}. (10)

The first calibration function Φ₍₁₎^{Ξ(L/R)} of the ratio modulation nonlinearity may be equal to the ratio of the assemblage of calibration values of the ratio modulated component J_{calib}^{Ξ(L)} of the light flux intensity in the left formation window W_{form}^{L} to the assemblage of the calibration values of the ratio modulated component J_{calib}^{Ξ(R)} of the light flux intensity in the right formation window W_{form}^{R}:

Φ₍₁₎^{Ξ(L/R)}≈J_{calib}^{Ξ(L)}/J_{calib}^{Ξ(R)}, (11)

whereas a linearly varying calibration signal s_{calib}_{_{—}}ₗᵢₙ^{Ξ} of the ratio modulation may be applied to the control input in_{dir}^{Ξ} of the ratio optical modulator 4.

The second calibration function φ₂^{Ξ(L/R)} of the ratio modulation nonlinearity may be equal to ratio of the assemblage of the calibration values of the ratio-modulated component J_{calib}^{Ξ(L)} of the ht flux intensity in the left formation window W_{form}^{L} to the assemblage of the calibration values of the ratio-modulated component J_{calib}^{Ξ(R)} of the light flux intensity in the right formation window W_{form}^{R}, divided by the assemblage of the corresponding values of the amplitude of the monotonically-varying calibration signal s_{calib}^{Ξ} of ratio modulation:

$${Φ}_{( 2 )}^{Ξ ( L / R )} = \frac{{J}_{calib}^{Ξ ( L )} / {J}_{calib}^{Ξ ( R )}}{{s}_{calib}^{Ξ}} . \qquad ( 12 )$$

During stereo image observation the left E^{L} and right E^{R} eyes of the observer may be located in the left W_{V}^{L} and right W_{V}^{L} observation windows respectively, for example, in the left and right windows of passive stereo glasses wearing by the observer. The apertures of the left W_{form}^{L} and right W_{form}^{R} formation windows spatially coincides here with the apertures of the left W_{V}^{L} and right W_{V}^{R} observation windows respectively, and each of two optical converters 4, 5 may be the optical element of the corresponding window of the stereo glasses.

Symbols W^{L} (Z^{L}) and W^{R} (Z^{R}) on the figures note the spatial coincidence of the left formation window W_{form}^{L} with the left observation window W_{V}^{L} (or the left formation zone Z_{form}^{L} with the left observation zone Z_{V}^{L}) and the right formation window W_{form}^{R} with the right observation window W_{V}^{R} (or the right formation zone Z_{form}^{R} with the right observation zone Z_{V}^{R}).

The sum compensating signal sₘₙ^{Σ}^{_{—}}^{comp} may be received at the output of the electronic functional module 5 which transfer function may be equal to the linearization function Λ^{Σ} of sum modulation. The input of the electronic functional module 5 may be supplied by the initial sum signal Sₘₙ^{Σ}, which amplitude may be directly proportional to the sum Bₘₙ^{L}+Bₘₙ^{R}:

sₘₙ^{Σ}≈Bₘₙ^{L}+Bₘₙ^{R}. (13)

The ratio compensating signal sₘₙ^{Ξ}^{_{—}}^{comp} may be received on the output of the electronic functional module 7 which transfer function may be equal to the linearization function Λ^{Ξ} of the ratio modulation. The input of the electronic functional module 7 may be supplied by the initial ratio modulation signal sₘₙ^{Ξ} which amplitude may be directly proportional to the Bₘₙ^{L}/Bₘₙ^{R}:

sₘₙ^{Ξ}≈Bₘₙ^{L}/Bₘₙ^{R}. (14)

The light intensity calibration values may be measured by the output signals of photo detectors 8, 9. These signals may be applied to the inputs of the electronic processing modules 10, 11. The calibration functions Φ^{Σ} and Φ^{Ξ} of nonlinearity of the sum modulation and the ratio modulation may be calculated by the electronic processing modules 10, 11 in accordance with expressions (7)-(10). The linearization function Λ^{Σ} of sum modulation and the linearization function Λ^{Ξ} of ratio modulation may be calculated in the electronic processing modules 12, 13 in accordance with expressions (5)-(8). The transfer functions of electronic functional modules 6, 7 may be equal to the functions Λ^{Σ} and Λ^{Ξ} accordingly which may be used during observation of the formed stereo image.

In case of spatially invariant (identical for all M·N image elements of each of the views) the calibration functions Φ^{Σ} and Φ^{Ξ} (calibration values of sum modulated component J_{calib}^{Σ} and ratio modulated component J_{calib}^{Ξ(L)} of the light flux intensity) may be measured using the spatial integration of the light flux intensity throughout the entire area of each of the formation windows. The spatial integration may be implemented by the wide aperture of the photo detectors 8, 9 or by using a lens for narrow aperture photo detectors 8, 9.

In case of spatially not invariant calibration functions Φ^{Σ} and Φ^{Ξ} a separate partial calibration function of nonlinearity may be determined for each partial area of spatial invariance of the formation windows.

It may be preferable to use photo detectors 8, 9 with transfer characteristics close to the corresponding characteristics of the human vision.

In case of on-line calibration process the measurement of intensity calibration values, calculation of the corresponding nonlinearity functions and transfer linearization functions may be implemented during observation of the stereo image. Then, the light fluxes from the left W_{form}^{L} and right W_{form}^{R} formation windows may simultaneously enter both the left W_{V}^{L} and right W_{V}^{L} observation windows and the apertures of photo detectors 8, 9.

The electronic functional modules 5, 6 and electronic processing modules 10, 11 may be the physical components with firmware, for example, the fast programmable digital electronic units based on Field-Programmable Gate Arrays (FPGA) or Digital Signal Processors (DSP).

The values of the brightness of the mn^{th} image elements of the left Bₘₙ^{L} and right Bₘₙ^{R} views may be numerically equal to the integral intensity values of the elementary light fluxes going to the left and right video cameras from the corresponding elements of the displayed three-dimensional scene (stereo image of which may be formed and observed in accordance with the method).

It may be equivalent to consider the compensating ratio signal sₘₙ^{Ξ(R/L)}^{_{—}}^{comp} for the ratio Bₘₙ^{R}/Bₘₙ^{L} of the brightness of the right and left views:

sₘₙ^{Ξ(L/R)}^{_{—}}^{comp}≈(Bₘₙ^{R}/Bₘₙ^{L})·Λ_{Ξ}, (15)

in which the optical conversion of the ratio modulation may be implemented in the opposite polarity in comparison with the signal sₘₙ^{Ξ(L/R)}^{_{—}}^{comp}=sₘₙ^{Ξ}^{_{—}}^{comp} (3),(4). Such case corresponds, for example, to mutual interchanging optical converters 4 and 5. The corresponding calibration functions may be determined as:

$$\begin{matrix}{Φ}_{( 1 )}^{Ξ ( R / L )} \approx \frac{{J}_{calib}^{Ξ ( R )} / {J}_{calib}^{Ξ ( L )}}{{s}_{calib}^{Ξ}} , & ( 16 ) \\ {Φ}_{12}^{Ξ ( R / L )} = \frac{{F}^{- 1} \{ {J}_{calib}^{Ξ ( R )} / {J}_{calib}^{Ξ ( L )} \}}{{s}_{calib}^{Ξ}} . & ( 17 )\end{matrix}$$

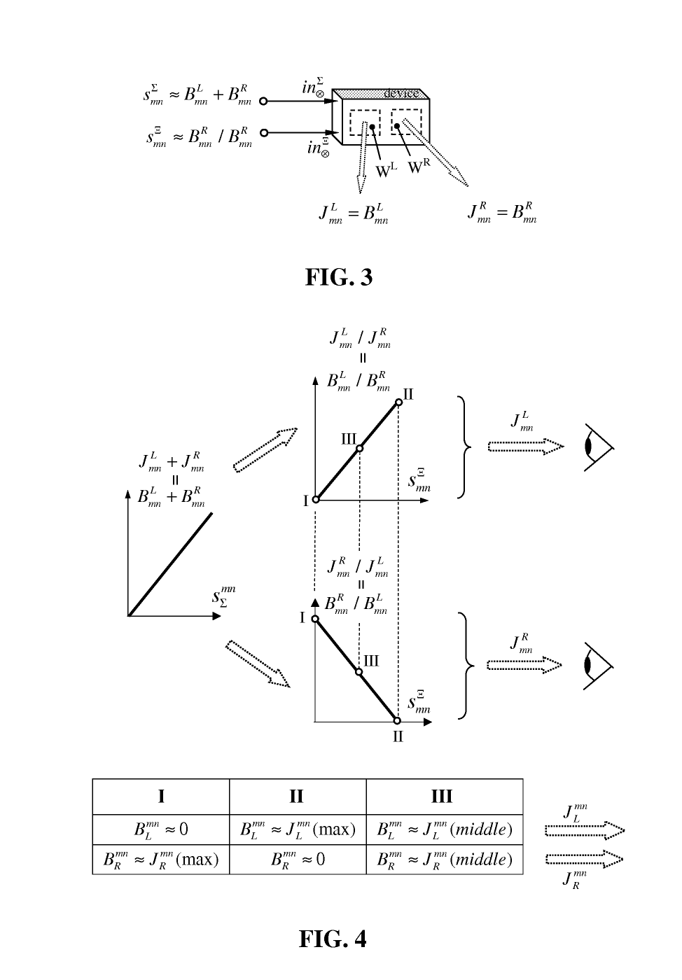

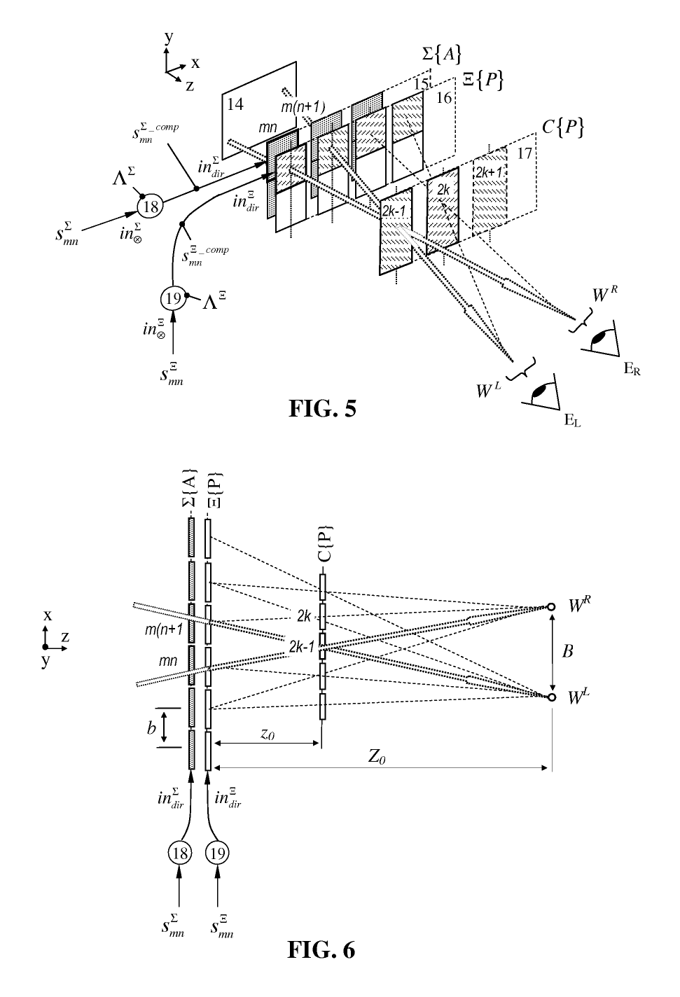

The separation of the stereo image views may be illustrated by considering the joint operation of two linearized optoelectronic channels (e.g., see FIG. 3), which outputs may be two formation windows W_{form}^{L}, W_{form}^{R} (or two observation windows W_{V}^{L}, W_{V}^{R}) The input of the optoelectronic channel, that may transmit the sum modulated component of the light flux, corresponds to the input [symbol] (e.g., see FIG. 1) of the functional module 6. The input of the optoelectronic channel, that transmits the ratio modulated component of the light flux, corresponds to the input [symbol] of functional module 7. The outputs of the both optoelectronic channels may be formation windows W_{form}^{L}, W_{form}^{R}. The optoelectronic channel of the sum modulation may be linearized in light intensity due to compensating the initial nonlinearity of transmission of the sum Bₘₙ^{L}+Bₘₙ^{R} by performance of the linearization function Λ^{Σ} of sum modulation. The corresponding sum of the light flux intensities Jₘₙ^{L}+Jₘₙ^{R} in both formation windows W_{form}^{L},W_{form}^{R} may be equal to the sum of the brightness values of the elementary images of the left and right views:

J_{L}^{mn}J_{R}^{mn}=B_{L}^{mn}+B_{R}^{mn}. (18)

The optoelectronic channel of ratio modulation may be linearized in light intensity due to compensation of the initial nonlinearity of transmission of the ratio Bₘₙ^{L}/Bₘₙ^{R} by performance of the linearization function Λ^{Ξ} of the ratio modulation. The ratio of the corresponding light flux intensities in the left and right formation windows W_{form}^{L},W_{form}^{R} may be:

Jₘₙ^{L}/Jₘₙ^{R}≈Bₘₙ^{L}/Bₘₙ^{R}. (19)

Joint solving the system of equations (18) and (19) leads to a condition:

Jₘₙ^{L}≈Bₘₙ^{L}; Jₘₙ^{R}≈Bₘₙ^{R}. (20)

The condition (20) corresponds to the desired separation of the stereo image views in the left W_{form}^{L} and right W_{form}^{R} formation windows. The intensity Jₘₙ^{L} of the mn^{th} element of the cross section of light flux in the left W_{form}^{L} observation windows and the intensity Jₘₙ^{R} of the mn^{th} element of the cross section of light flux in the right W_{form}^{R} formation window correspond to the values Bₘₙ^{L} and Bₘₙ^{R} of the brightness of the mn^{th} image elements of the left and right views.

From the physical point of view, the role of the linearized (in light intensity) optoelectronic channel of the sum modulation may provide the same resulting changes of light flux intensity in each formation windows W_{form}^{L}, W_{form}^{R}, directly proportional to the changes of the total quantity Bₘₙ^{L}+Bₘₙ^{R}. The role of the linearized (in light intensity) optoelectronic channel of the ratio modulation may be to distribute the light flux (in intensity value) directly proportional to the ratio (Bₘₙ^{L}/Bₘₙ^{R}) in the left formation window W_{form}^{L} and directly proportional to the ratio (Bₘₙ^{L}/Bₘₙ^{R}) in the right formation window W_{form}^{R} without introducing any changes in the total (sum) value of the light flux in both formation windows W_{form}^{L}, W_{form}^{R}. When choosing the sum signal sₘₙ^{Σ} in accordance with expression (1), any positive increment in the amplitude of sₘₙ^{Σ} at the control input of the linearized optoelectronic channel of the sum modulation may cause the corresponding positive increase in the intensity in both formation windows W_{form}^{L}, W_{form}^{R} (e.g., see FIG. 4). Thus, in each window W_{form}^{L}, W_{form}^{R} any positive increment in the amplitude of sₘₙ^{Σ} calls for the intensity value increment, that may be directly proportional to the value of the increment in the sum Bₘₙ^{L}+Bₘₙ^{R}. So in the physical meaning, the sum modulator (controlled by a sum signal) may operate as a uniform-effect optical modulator causing the optical intensity changes which may be the same in a value and in a sign in each of left W_{form}^{L} and right W_{form}^{R} formation windows.

When choosing the ratio signal sₘₙ^{Ξ} in accordance with expressions (3), (4), any positive increment in the amplitude of the sₘₙ^{Ξ} at the control input of the linearized optoelectronic channel of the ratio modulation may cause a positive increase in the light flux intensity value in one of the formation windows (for example, in the left formation window W_{form}^{L}). This increase of light flux intensity may be directly proportional to the indicated increment in the sₘₙ^{Ξ} amplitude. The same positive increment in the amplitude of the sₘₙ^{Ξ} may cause a corresponding negative increment (decrease) in the light flux intensity value in the other (right) formation window W_{form}^{R}. If the brightness Bₘₙ^{R} may be close to zero, the light intensity at the output of the optoelectronic channel of the sum modulation may correspond only to the brightness Bₘₙ^{L}. Thus, the whole light flux may be directed to the left formation window W_{form}^{L} while applying the corresponding signal sₘₙ^{Ξ} to the control input of the optoelectronic channel of the ratio modulation. The amplitude of this signal may be directly proportional to Bₘₙ^{L}/Bₘₙ^{R} with maximum amplitude leading to maximum (within the limit of dynamic range of each optoelectronic channel) increment in the light intensity in the left formation window W_{form}^{L}. Simultaneously it leads to disappearance of the light flux in the right formation window W_{form}^{R}. On the contrary, with Bₘₙ^{L} close to zero (at maximum Bₘₙ^{R}) the whole light flux may be directed to the right formation window W_{form}^{R}. Finally, any relation between the Bₘₙ^{L} and Bₘₙ^{R} values may lead to redistribution of the same light flux energy between the left W_{form}^{L} and the right W_{form}^{R} formation windows. So, in the physical meaning, the ratio modulator (controlled by a ratio signal) may act as a difference-effect optical modulator causing the optical intensity changes which may be identical in a value in the left W_{form}^{L} and right W_{form}^{R} formation windows but different in a sign in the left W_{form}^{L} and right W_{form}^{R} formation windows.

Thus, the desired separation of the views (formation of stereo image) may be indicated in the method from a physical point of view.

The maximum separation of the stereo image views (e.g., a stereo image with maximum contrast and dynamic range) may be achieved under two conditions. First, if the extreme points of dynamic range of the sum modulation variance may be chosen as a minimum and a maximum value of the sum modulation parameter. Second, if the extreme points of the dynamic range of the ratio modulation variance may be chosen as two complementary values of the ratio modulation parameter. The optical converters 4, 5 may both be implemented to provide the identical light flux intensity values in both formation windows W_{form}^{L}, W_{form}^{R} for any value of the sum modulation parameter. So, in both formation windows W_{form}^{L}, W_{form}^{R} the optical converters 4, 5 may form a minimum light flux intensity value at the one extreme value (at minimum, for example) of the sum modulation parameter and may form maximum intensity value at another extreme value (at maximum) of the sum modulation parameter. So, in case of the first value of the complementary ratio modulation, one of the optical converters 4, 5, for example, the optical converter 4 (that may be implemented to form the maximum light flux intensity value at the first complementary value of the ratio modulation parameter) may form the maximum light flux intensity value in the left formation window W_{form}^{L}. Another optical converter 5 (implemented to form the minimum light flux intensity value at the first complementary value of the ratio modulation parameter) may form the minimum (in the limit tends to zero) light flux intensity value in the right observation window W_{form}^{R}. In case of using the second complementary value of the ratio modulation parameter the minimum and maximum intensity values of the light flux may be crossly interchanged in the left W_{form}^{L} and right W_{form}^{R} observation windows.

The second embodiment of the method of forming and observing stereo images with maximum spatial resolution, comprises:

receiving a light wave from an optical source 14;

providing the first optical modulator 15, that may be matrix-addressed in M rows and N columns, for modulating an intensity of the light wave to implement the sum modulation of the light wave in the mn^{th} element of the first optical modulator 15 in accordance with the sum of the values Bₘₙ^{L} and Bₘₙ^{R} of brightness of mn^{th} elements of images of left and right views, wherein n=1, 2, . . . , N, m=1, 2, . . . , M; whereas applying to the control input of the first optical modulator a sum compensating signal sₘₙ^{Σ}^{_{—}}^{comp} which amplitude may be directly proportional to the linearization function Λ^{Σ} of the sum modulation;

providing the second optical modulator 16, that may be matrix-addressed in M rows and N columns, for modulating a polarization of the light wave to implement the ratio modulation of the light wave in the mn^{th} element of the second optical modulator 16 in accordance with functions of algebraic relations between values Bₘₙ^{L} and Bₘₙ^{R} of brightness of mn^{th} elements of images of the left and right views;

whereas assigning complementary values of optical modulation parameters in the adjacent 2i and (2i−1) columns of the second optical modulator 16, wherein i=1, 2, . . . , N, and applying to the control input of the second optical modulator 16 a ratio compensating signal sₘₙ^{Ξ}^{_{—}}^{comp} which amplitude may be directly proportional to the linearization function Λ^{Ξ} of the ratio modulation;

providing a N-column addressed spatially-periodic optical converter 17 with complementary optical conversion parameters in its adjacent 2k and (2k−1) columns, wherein k=1, 2, . . . , N, for converting light modulation characteristic into light intensity modulation to form the first group of N light beams and second group of N light beams in the left W_{V}^{L} and right W_{V}^{R} view formation windows respectively, wherein the intensity values Jₘₙ^{L} and Jₘₙ^{R} of the first and second groups of N light beams may be equal to the values Bₘₙ^{L} and Bₘₙ^{R} of brightness of mn^{th} elements of images of the left and right views respectively;

whereas directing to the left view formation window W_{form}^{L} the first N/2 light beams of the first group passing through N/2 even 2i columns of the second optical modulator 16 and through N/2 even 2k columns of the spatially-periodic optical converter 17, and the second N/2 light beams of the first group passing through N/2 odd (2i−1) columns of the second optical modulator 16 and through N/2 odd (2k−1) columns of the spatially-periodic optical converter 17, directing to the right view formation window W_{form}^{R} the first N/2 light beams of the second group passing through N/2 odd (2i−1) columns of the second optical modulator 16 and through N/2 even 2k columns of the spatially-periodic optical converter 17, and the second N/2 light beams of the of the second group passing through N/2 even 2i columns of the second optical modulator 16 and through N/2 odd (2k−1) columns of the spatially-periodic optical converter 17;

observing left and right views of the stereo image in left W_{V}^{L} and right W_{V}^{R} observation windows, which may be optically coupled with the left W_{form}^{L} and right W_{form}^{R} formation windows respectively.

The first linearization function Λ₍₁₎^{Σ} of the sum modulation may be the inverse function F⁻¹{Φ₍₁₎^{Σ}} (5) of the first calibration function Φ₍₁₎^{Σ} (9) of the sum modulation nonlinearity. The second linearization function Λ₍₂₎^{Σ} of the sum modulation may be the reciprocal function F^{reciprocal}{Φ₍₂₎^{Σ}} (6) equal to the reciprocal 1/Φ₍₂₎^{Σ} of the second calibration function Φ₍₂₎^{Ξ} of sum modulation nonlinearity. The first linearization function Λ₍₁₎^{Ξ} of the ratio modulation may be the inverse function F⁻¹{Φ₍₁₎^{Ξ}} (7) of the first calibration function Φ₍₁₎^{Ξ} of the ratio modulation nonlinearity. The second linearization function Λ₍₂₎^{Ξ} of the ratio modulation may be the reciprocal function F^{reciprocal}{Φ₍₂₎^{Ξ}} (8) equal to the reciprocal 1/Φ₍₂₎^{Ξ} of the second calibration function Φ₍₂₎^{Ξ} (12) of ratio modulation nonlinearity.

The first calibration function Φ₍₁₎^{Σ} of sum modulation nonlinearity may be equal to the assemblage of the calibration values of the sum modulation component J_{calib}^{Σ} (9) of the light flux intensity in either of the formation windows W_{form}^{L}, W_{form}^{R} whereas the linearly-varying calibration signal s_{calib}_{_{—}}ₗᵢₙ^{Σ} of sum modulation may be applied to the control input in_{dir}^{Σ} of the sum optical modulator 16. The second calibration function Φ₍₂₎^{Σ} of sum modulation nonlinearity may be equal to the ratio (10) of the sequence of calibration values of the ratio component J_{calib}^{Σ} of the light flux intensity on the output of either of the formation windows W_{form}^{L}, W_{form}^{R} to the sequence of corresponding amplitude values of the monotonically-varying calibration signal s_{calib}^{Σ} of the sum modulation. The first calibration function Φ₍₁₎^{Ξ(L/R)} of the ratio modulation nonlinearity may be equal to the ratio (11) of the sequence of the calibration values of the ratio component J_{calib}^{Ξ(L)} of the light flux intensity in the left formation window W_{form}^{L} to the sequence of the calibration values of the ratio component J_{calib}^{Ξ(R)} of the light flux form intensity in the right formation window W_{form}^{R}, whereas the linearly-varying calibration signal s_{calib}^{Ξ} of ratio modulation may be applied to the control input in_{dir}^{Ξ} of the ratio optical modulator 4. The second calibration function Φ₂^{Ξ(L/R)} of the ratio modulation nonlinearity may be equal to the ratio (12) of the sequence of the calibration values of the ratio component J_{calib}^{Ξ(L)} of the light flux intensity in the left formation window W_{form}^{L} to the sequence of the calibration values of the ratio component J_{calib}^{Ξ(R)} of the light flux intensity in the right formation window W_{form}^{R}, divided by the sequence of the corresponding values of the amplitude of the monotonically-varying calibration signal s_{calib}^{Ξ} of the ratio modulation.

The sum compensating signal sₘₙ^{Σ}^{_{—}}^{comp} (1) may be obtained at the output of the electronic functional module 18 which transfer function may be equal to the linearization function Λ^{Σ} of the sum modulation whereas the initial sum signal sₘₙ^{Σ} may be applied to the input [symbol] of the electronic functional module 18. The amplitude of sₘₙ^{Σ} may be directly proportional to the sum Bₘₙ^{L}+Bₘₙ^{R} of the values of the brightness of the mn^{th} image elements of the left and right views.

The ratio compensating signal sₘₙ^{Ξ}^{_{—}}^{comp} (2) may be obtained on the output of the electronic functional module 19 which transfer function may be equal to the linearization function Λ^{Ξ} of the ratio modulation whereas the initial ratio signal sₘₙ^{Ξ} may be applied to the input [symbol] ^{Ξ} of the electronic functional module 19. The amplitude of sₘₙ^{Ξ} may be directly proportional to the ratio Bₘₙ^{L}/Bₘₙ^{R}.

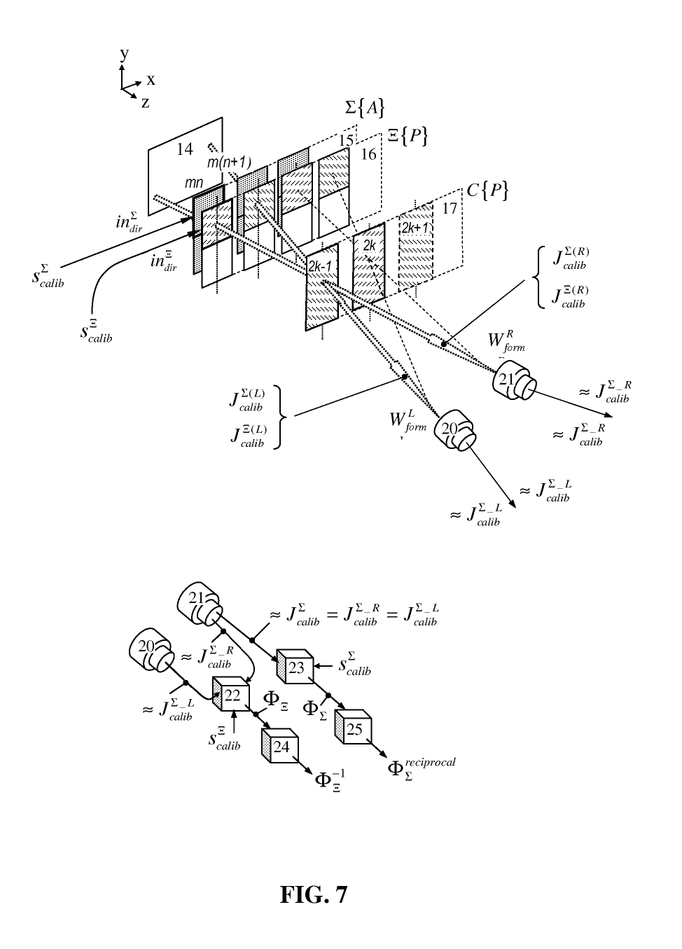

The calibration values of the light flux intensity may be measured by output signals of the photo detectors 20, 21 (e.g., see FIG. 7), disposed in the formation zones Z_{form}^{L},Z_{form}^{L}. The calibration signal s_{calib}^{Σ} of the sum modulation and the calibration signal s_{calib}^{Ξ} of the ratio modulation may be applied respectively to the control input in_{dir}^{Σ} of the first (sum) optical modulator 15 and to the control input in_{dir}^{Ξ} of the second (ratio) optical modulator 17.

The output signals of the photo detectors 20, 21 may be applied to the inputs of the electronic processing modules 22, 23. The calibration function Φ^{Ξ} of the ratio modulation nonlinearity and the calibration function Φ^{Σ} of sum modulation nonlinearity may be calculated in electronic processing modules 22, 23 in accordance with expressions (9)-(12). The inverse function F⁻¹{Φ^{Σ}} of the calibration function Φ^{Σ} of the ratio modulation nonlinearity and the reciprocal function F^{reciprocal}{(Φ^{Σ}} may be calculated in electronic processing modules 24, 25 in accordance with expressions (5)-(8). Thus, the linearization functions Λ^{Σ} and Λ^{Ξ} of the sum and ratio modulation may be determined, and the corresponding transfer functions may be assigned to electronic functional modules 18 and 19 in the process of observing the stereo image.

The left E^{L} and right E^{L} eyes of the observer may be located in the left Z_{V}^{L} and right Z_{V}^{R} observation zones respectively. These zones may be formed in a space by mutual intersection of the optical beams which may be formed and directed by the spatially-periodic optical converter 17. Such a layout allows to observe the stereo image without special means (stereo glasses). Along the axis Z, a set of such two-dimensional observation zones Z_{V}^{L},Z_{V}^{R} may exist according to different positions of the observer's eyes (within the limits of the depth of the space, defined by the extent of the three-dimensional formation zones Z_{V}^{L},Z_{V}^{R}). The average distance Z₀ from the observer's eyes E^{L}, E^{L} (from the observation zones Z_{V}^{L},Z_{V}^{R}) to optical conversion plane C may be determined by the expression (e.g., see FIG. 6):

Z₀/B=z₀/b, (21)

where

B may be the distance between the centers of the observer's eyes (between the centers of the observation zones),

z₀ may be the distance between the plane Ξ of the ratio optical modulator 16 position to the plane C of the N column-addressed spatially-periodic optical converter 17 position,

b may be the period of the arrangement of the mn^{th} image elements.

The particular embodiments of the method may correspond to different kinds of the sum optical modulators 2, 15, ratio optical modulators 3, 16, optical converters 4, 5, 17 and consequently may correspond to different particular calibration functions Φ^{Σ}, Φ^{Ξ} of the sum modulation and ratio modulation nonlinearity. The form and dimensionality of Φ^{Σ}, Φ^{Ξ} (number of variables or arguments of calibration function Φ of nonlinearity) may be determined by the physical mechanism of the sum and ratio modulation. In accordance with one aspect of the present invention, it may not be necessary to know these physical mechanisms or the analytical expressions describing the variance of the sum and ratio modulation optical parameters depending on the control signal amplitude. Also, it may not be necessary to know analytical describing relationships between these optical parameters. The necessary and sufficient information for the subsequent linearization of transfer functions of optoelectronic channels may be the results of calibration measurements of the intensity values in the formation windows W_{form}^{L}, W_{form}^{R} (formation zones Z_{form}^{L}, Z_{form}^{R}) depending on the amplitudes of the sum and ratio calibration signals s_{calib}^{Σ}, s_{calib}^{Ξ}.

The direct sum or direct ratio optical modulation may correspond to a direct change in light intensity provided by the sum optical modulators 2, 15 or by the ratio optical modulators 3, 16 located in corresponding planes Σ and Ξ. The direct sum or direct ratio optical modulation may be caused, for example, by a change of the real-amplitude absorption coefficient of the working medium of the mn^{th} element of each of optical modulators 2, 15, 3, 16. This may correspond to a direct (without using a conversion effect by the optical converters 4, 5, 17) implementation of the corresponding intensity variations in both formation windows W_{form}^{L}, W_{form}^{R} (in both formation zones Z_{form}^{L},Z_{form}^{R}). In this case, the role of the optical converters 4, 5, 17 may be to pass through without changing the directly modulated sum and ratio components of the light flux intensity. The real amplitude A of a light wave may be described by the real-amplitude factor in the expression Aexp(−iθ) of the complex amplitude of the light wave, where θ may be the phase of the light wave. Modulation of the value A of the real-amplitude of a light wave may cause the corresponding modulation of the light intensity J that may be equal to |A|².

The indirect sum or ratio modulation of the light wave may correspond to modulation of the remaining (i.e., excepting direct real-amplitude variations) physical characteristics of the light wave. In this case, the role of the optical converters 4, 5, 17 may be to convert the light wave physical characteristics into the corresponding light flux intensity variations in the formation windows W_{form}^{L},W_{form}^{R} (zones Z_{form}^{L},Z_{form}^{R}). The conversion parameters may be identical (uniform) in both formation windows W_{form}^{L},W_{form}^{R} (zones Z_{form}^{L},Z_{form}^{R}) for the sum modulation. But the conversion parameters may be complementary (mutually supplementary or opposite) between the two formation windows W_{form}^{L},W_{form}^{R} (zones Z_{form}^{L},Z_{form}^{R}) for the ratio modulation.

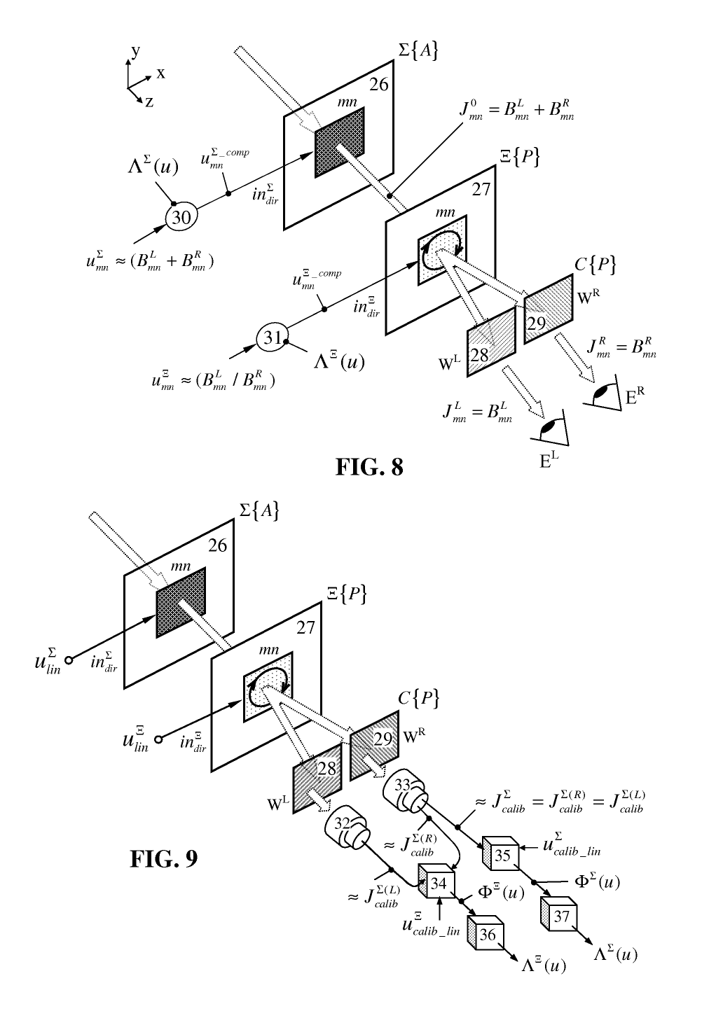

The first preferred embodiment of the method (e.g., see FIG. 8) comprises:

providing the real-amplitude optical modulator 26, that may be matrix-addressed in M rows and N columns, for modulating the real-amplitude A (direct modulating intensity J) of the light wave to implement a direct sum modulation Σ{A} in the mn^{th} element of the real-amplitude optical modulator 26;

providing the phase-polarization optical modulator 27, that may be matrix-addressed in M rows and N columns, for modulating the polarization state P of the light wave to implement the indirect ratio modulation C{P} in the mn^{th} element of the phase-polarization optical modulator 27;

providing the first and second polarization analyzers 28, 29 with complementary polarization parameters to convert the indirect (polarization) ratio modulation C{P} into the ratio component of the light flux intensity, forming the light fluxes of mn^{th} image elements Bₘₙ^{L} and Bₘₙ^{R} of the left and right views in the left and right formation windows W_{form}^{L} and W_{form}^{R} respectively.

The real-amplitude optical modulator 26 may be controlled by the first sum compensating electronic signal u₍₁₎ₘₙ^{Σ}^{_{—}}^{comp}, which amplitude may be directly proportional to the first linearization function Λ₍₁₎^{Σ} of the sum modulation (taken from the sum Bₘₙ^{L}+Bₘₙ^{R}):

u₍₁₎ₘₙ^{Σ}^{_{—}}^{comp}≈Λ₍₁₎^{Σ}{Bₘₙ^{L}+Bₘₙ^{R}}, (22)

or by the second sum compensating electronic signal u₍₂₎ₘₙ^{Σ}^{_{—}}^{comp} which amplitude may be directly proportional to the product of the sum Bₘₙ^{L}+Bₘₙ^{R} into the second linearization function Λ₍₂₎^{Σ} of the sum modulation:

u₍₂₎ₘₙ^{Σ}^{_{—}}^{comp}≈(Bₘₙ^{L}+Bₘₙ^{R})·Λ₍₂₎^{Σ}. (23)

The phase-polarization optical modulator 27, in one case, may be controlled by the first ratio compensating electronic signal s_{(1)mn(L/R)}^{Ξ}^{_{—}}^{comp} which amplitude may be directly proportional to the first linearization function Λ₍₁₎^{Ξ} of the ratio modulation, taken from the ratio Bₘₙ^{L}/Bₘₙ^{R}:

u₍₁₎ₘₙ^{Ξ}^{_{—}}^{comp}≈Λ₍₁₎^{Ξ}{Bₘₙ^{L}/Bₘₙ^{R}}. (24)

In another case, the phase-polarization optical modulator 27 may be controlled by the second ratio compensated electronic signal u₍₂₎ₘₙ^{Ξ}^{_{—}}^{comp} which amplitude may be proportional to the product of the ratio Bₘₙ^{L}/Bₘₙ^{R} into the second linearization function Λ₍₂₎^{Ξ} of ratio modulation:

u₍₂₎ₘₙ^{Ξ}^{_{—}}^{comp}≈(Bₘₙ^{L}/Bₘₙ^{R})·Λ₍₂₎^{Ξ}. (25)

The first linearization function Λ₍₁₎^{Σ} of the sum modulation may be the inverse function F⁻¹{Φ₍₁₎^{Σ}(u)} of the first calibration function Φ₍₁₎^{Σ} of the sum modulation nonlinearity:

Λ₍₁₎^{Σ}(u)=F⁻¹{Φ₍₁₎^{Σ}(u)}. (26)

The second linearization function Λ₍₂₎^{Σ} of the sum modulation may be the reciprocal function F^{reciprocal}{Φ₍₂₎^{Σ}(u)}, which may be the reciprocal 1/Φ₍₂₎^{Σ}(u) of the second calibration function Φ₍₁₎^{Σ} of the sum modulation nonlinearity:

Λ₍₂₎^{Σ}(u)=F^{reciprocal}{Φ₍₂₎^{Σ}(u)}=1/Φ₍₂₎^{Σ}(u). (27)

The first linearization function Λ₍₁₎^{Ξ} of the ratio modulation may be defined as the inverse function F⁻¹{Φ₍₁₎^{Ξ}(u)} of the first calibration function Φ₍₁₎^{Ξ} of the ratio modulation nonlinearity:

Λ₍₁₎^{Ξ}(u)=F⁻¹{Φ₍₁₎^{Ξ}(u)}. (28)

The second linearization function Λ₍₂₎^{Ξ} of the ratio modulation may be the reciprocal function F^{reciprocal}{Φ₍₂₎^{Ξ})}, which may be the reciprocal value 1/Φ₍₂₎^{Ξ} of the second calibration function Φ₍₂₎^{Ξ} of the ratio modulation nonlinearity:

Λ₍₂₎^{Ξ}(u)=F^{reciprocal}{Φ₍₂₎^{Ξ}(u)}=1/Φ₍₂₎^{Ξ}(u). (29)

The first calibration function Φ₍₁₎^{Σ} of the sum modulation nonlinearity may be equal to the assemblage of the calibration values of the sum component J_{calib}^{Σ}(u) of the light flux intensity in the either of the formation windows W_{form}^{L},W_{form}^{R}.

Φ₍₁₎^{Σ}(u)=J_{calib}^{Σ}(u) (30)

whereas the sum optical modulator 26 may be controlled by the linearly-varying electronic calibration signal u_{calib}_{_{—}}ₗᵢₙ^{Σ} of the sum modulation.

The second calibration function Φ₍₂₎^{Σ} of the sum modulation nonlinearity may be equal to the ratio of the sequence of calibration values of the sum component J_{calib}^{Σ} of the light flux intensity (in either of the formation windows W_{form}^{L},W_{form}^{R}) to the sequence of the corresponding amplitude values of the linearly-varying electronic calibration signal u_{calib}_{_{—}}ₗᵢₙ^{Σ} of the sum modulation:

Φ₍₂₎^{Σ}(u)≈J_{calib}^{Σ}(u)/u_{calib}_{_{—}}ₗᵢₙ^{Σ}. (31)

The first calibration function Φ₍₁₎^{Ξ(L/R)}(u) of the ratio modulation nonlinearity may be equal to the ratio of the sequence of the calibration values of the ratio component J_{calib}^{Ξ(L)}(u) of the light flux intensity in the left formation window W_{form}^{L} to the sequence of the calibration values of the ratio component J_{calib}^{Ξ(R)}(u) of the light flux intensity in the right formation window W_{form}^{R}:

Φ₍₁₎^{Ξ(L/R)}≈J_{calib}^{Ξ(L)}/J_{calib}^{Ξ(R)}, (32)

whereas the ratio optical modulator 27 may be controlled by the linearly-varying electronic calibration signal u_{calib}_{_{—}}ₗᵢₙ^{Ξ} of the ratio modulation.

The second calibration function Φ₂^{Ξ(L/R)}(u) of the ratio modulation nonlinearity Φ^{Ξ} may be equal to the ratio of the sequence of the calibration values of the ratio component J_{calib}^{Ξ(L)}(u) of the light flux intensity in the left formation window W_{form}^{L} to the sequence of the calibration values of the ratio component J_{calib}^{Ξ(R)}(u) of the light flux intensity in the right formation window W_{form}^{R}, divided by the sequence of the corresponding values of the amplitude of the linearly-varying electronic calibration signal u_{calib}_{_{—}}ₗᵢₙ^{Ξ} of the ratio modulation:

$${Φ}_{( 2 )}^{Ξ ( L / R )} ( u ) = \frac{{F}^{- 1} \{ {J}_{calib}^{Ξ ( L )} ( u ) / {J}_{calib}^{Ξ ( R )} ( u ) \}}{{u}_{calib\_lin}^{Ξ}} . \qquad ( 33 )$$

The amplitude limits of u_{calib}_{_{—}}ₗᵢₙ^{Σ} may correspond to changes in light flux intensity J_{calib}^{Σ}(u) from minimum calibration value to maximum one. The limits of u_{calib}_{_{—}}ₗᵢₙ^{Ξ} amplitude may correspond to changes in the calibration values of the ratio component J_{calib}^{Ξ}(u) of the light flux intensity from minimum calibration value to maximum one at constant (preferably, at maximum) light flux intensity in the optical input of the phase-polarization optical modulator 27.

The sum compensating signal sₘₙ^{Σ}^{_{—}}^{comp} may be received at the output of the electronic functional module 30 which transfer function may correspond to the linearization function Λ^{Σ}(u) of the sum modulation. The initial sum signal uₘₙ^{Σ} may be applied to the input of the electronic functional module 30. The amplitude of uₘₙ^{Σ} may be directly proportional to the sum Bₘₙ^{L}+Bₘₙ^{R} of the brightness values of the mn^{th} image elements of the left and right views, i.e. uₘₙ^{Σ}≈Bₘₙ^{L}+Bₘₙ^{R}.

The ratio compensating signal s_{mn(L/R)}^{Ξ}^{_{—}}^{comp} may be received at the output of the electronic functional module 31, which transfer function may correspond to the linearization function Λ^{Ξ}(u) of the ratio modulation. The initial ratio modulation signal uₘₙ^{Ξ} may be applied to the input of the electronic functional module 31. The amplitude of uₘₙ^{Ξ} may be directly proportional to ratio Bₘₙ^{L}/Bₘₙ^{R}, i.e. uₘₙ^{Ξ}≈Bₘₙ^{L}/Bₘₙ^{R}.

The output signals of the photo detectors 32, 33 (e.g., see FIG. 9) may be applied to the inputs of the electronic processing modules 34, 35. The calibration function Φ^{Ξ} of the ratio modulation nonlinearity and the calibration function Φ^{Σ} of the sum modulation nonlinearity may be calculated in the electronic processing modules 34, 35 in accordance with expressions (30)-(33). The inverse function F⁻¹{Φ^{Ξ}} of calibration function Φ^{Ξ} of the ratio modulation nonlinearity and the reciprocal function F^{reciprocal}{Φ^{Σ}} of the calibration function Φ^{Σ} may be calculated in the electronic processing modules 36, 37 in accordance with expressions (26)-(29). During observing the stereo image, the corresponding transfer functions of the electronic functional modules 31 and 30 may be set accordingly with the obtained linearization functions Λ^{Ξ}, Λ^{Σ} of the ratio and sum modulation.

The procedure of linearization of the real-amplitude sum modulation (Σ{A}-modulation) and the procedure of linearization of the polarization ratio modulation (Ξ{P}-modulation) for the first embodiment of the method may be implemented separately.

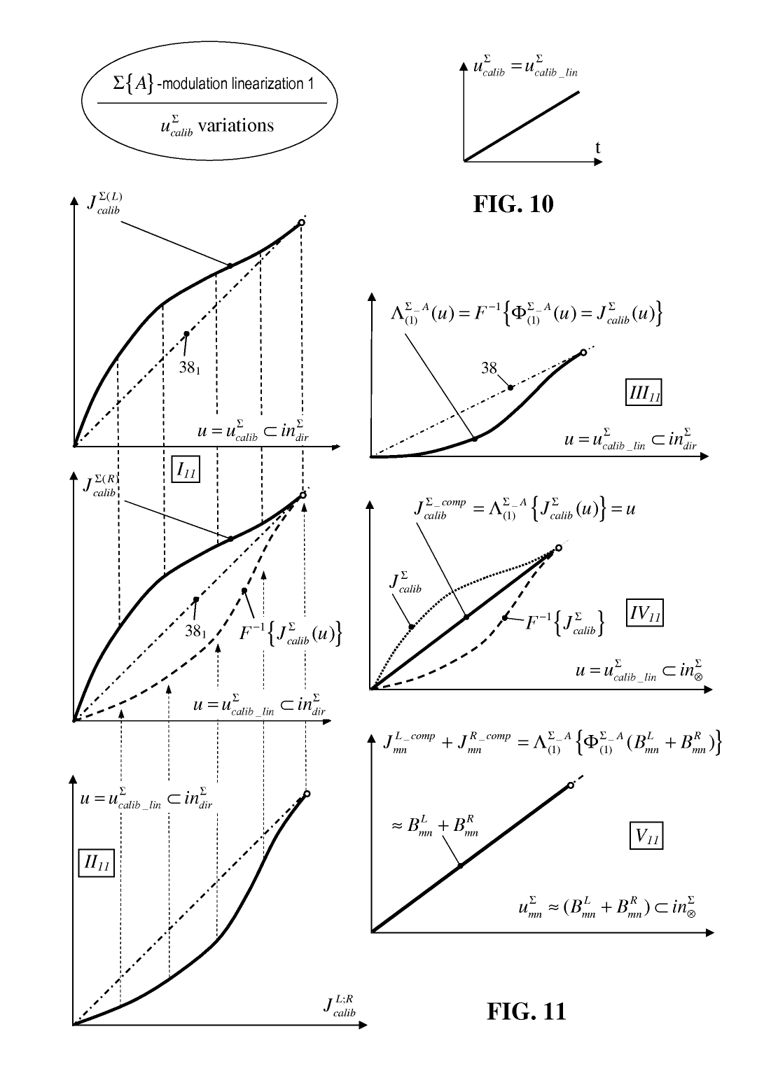

For linearization of Σ{A}-modulation, the calibration electronic signal u_{calib}_{_{—}}ₗᵢₙ^{Σ} of Σ{A}-modulation may be applied to the control input in_{dir}^{Σ} of the real-amplitude optical modulator 26 (hereinafter, Σ{A}-modulator). The amplitude of u_{calib}_{_{—}}ₗᵢₙ^{Σ} may be linearly increased in time t (e.g., see FIG. 10). The amplitude of the electronic calibration signal u_{calib}_{_{—}}ₗᵢₙ^{Ξ} of Ξ{P}-modulation at the control input in_{dir}^{Σ} of the phase-polarization modulator 27 (hereinafter, Ξ{P}-modulator) may be equal to 0 (corresponds to absence of Ξ{P}-modulation). The first and second procedures of Σ{A}-modulation linearization may correspond to the first Λ₍₁₎^{Σ} and second Λ₍₂₎^{Σ} linearization functions of the Σ{A}-modulation.

When using the first linearization function Λ₍₁₎^{Σ} of Σ{A}-modulation, the light flux intensity values J_{calib}^{Σ(L)} and J_{calib}^{Σ(R)} in the left W_{form}^{L} and right W_{form}^{R} formation windows may correspond to calibration values of the sum component (Σ{A}-component) of the light flux intensity J_{calib}^{Σ} (e.g., see FIG. 11). In the general case, the value of J_{calib}^{Σ} may represent the nonlinear function of voltage values of the linearly-varying amplitude of calibration signal u_{calib}_{_{—}}ₗᵢₙ^{Σ} of the Σ{A}-modulation. The signal u_{calib}_{_{—}}ₗᵢₙ^{Σ} may be applied to the control input in_{dir}^{Σ} of the Σ{A}-modulator so u_{calib}_{_{—}}ₗᵢₙ^{Σ} may be indicated on the drawing as the signal argument u=u_{calib}_{_{—}}ₗᵢₙ^{Σ}, belonging to the input in_{dir}^{Σ}, i.e. u=u_{calib}_{_{—}}ₗᵢₙ^{Σ}⊂in_{dir}^{Σ}. Therefore J_{calib}^{Σ} may be illustrated by a curve with deviations from sloped straight line 38 (a graph of a direct proportional dependence). The form of the curved function J_{calib}^{Σ} may be the same for both formation windows W_{form}^{L}, W_{form}^{R} (graph I₁₁). The linearization of the Σ{A}-modulation with the use of the first linearization function Λ₍₁₎^{Σ} may be achieved by taking the inverse function of the nonlinearity function Φ₍₁₎^{Σ}(u) of Σ{A}-modulation. The value of Φ₍₁₎^{Σ}(u) may be equal to the sum of the values of the Σ{A}-modulated component of light flux intensity J_{calib}^{Σ} in accordance with expressions (30), (28). The graphic way of obtaining an inverse function may be to get the inverse function graph by interchanging of the argument and initial values of the function relative to which the inverse function should be taken. The values of the argument u_{calib}_{_{—}}ₗᵢₙ^{Σ} may be plotted along the y-axis. The values of J_{calib}^{Σ} may be plotted along the x-axis to obtain the graph of the inverse function (e.g., see graph II₁₁ in FIG. 11). This graph may be transferred to the initial coordinates (graph III₁₁) to obtain the resulting graph of the inverse function Λ_{(1)P}^{Σ}=F⁻¹{Φ_{(1)P}^{Σ}(u)=J_{calib}^{Σ}(u)}. To get the compensated (with corrected nonlinearity) Σ{A}-component J_{calib}^{Σ}^{_{—}}^{comp}(u) of the light flux intensity (graph IV₁₁), the compensating electronic signal u_{calib}_{_{—}}ₗᵢₙ^{Σ}^{_{—}}^{comp}:

u_{calib}_{_{—}}ₗᵢₙ^{Σ}^{_{—}}^{comp}=Λ₍₁₎^{Σ}{u_{calib}_{_{—}}ₗᵢₙ^{Σ}^{_{—}}^{comp}} (34)

may be applied to the control input in_{dir}^{Σ} of the electronic module of the Σ{A}-modulator as a result of taking the inverse function of the initial calibration signal u_{calib}_{_{—}}ₗᵢₙ^{Σ}^{_{—}}^{comp}. The compensating electronic signal (26) may gain nonlinear properties, which may be inversed with respect to the nonlinear properties of Σ{A}-modulation. The result of operation of the Σ{A}-modulator under control of the compensating signal (26) may be the forming of the compensated Σ{A}-component J_{calib}^{Σ}^{_{—}}^{comp}(u) of the light flux intensity. The compensated Σ{A}-component J_{calib}^{Σ}^{_{—}}^{comp}(u) may not have the nonlinearity of Σ{A}-modulation that may be presented in the initial Σ{A}-component J_{calib}^{Σ}. The graph IV₁₁ illustrates a direct proportional dependence of the Σ{A}-component J_{calib}^{Σ}^{_{—}}^{comp}(u) on the amplitude of the initial signal u_{calib}_{_{—}}ₗᵢₙ^{Σ}. The initial signal u_{calib}_{_{—}}ₗᵢₙ^{Σ} may be applied to the input [symbol] of the electronic functional module with transfer function Λ₍₁₎^{Σ}. The amplitude of the initial signal u_{calib}_{_{—}}ₗᵢₙ^{Σ} may be indicated on the drawing as the signal argument u_{calib}_{_{—}}ₗᵢₙ^{Σ}, belonging to the input [symbol] , i.e., u=u_{calib}_{_{—}}ₗᵢₙ^{Σ}⊂ [symbol] . Analytically, this directly proportional dependence may be described as:

J_{calib}^{Σ}^{_{—}}^{comp}=Λ₍₁₎^{Σ}{J_{calib}^{Σ}(u)}=J_{calib}^{-1(Σ)}{J_{calib}^{Σ}(u)}=u (35)

where J_{calib}^{-1(Σ)} may be the inverse function of the function J_{calib}^{Σ}. Taking the inverse function of the original function may correspond to receiving the argument of the original function, i.e., to receiving the variable itself. This variable describes the change of signal u_{calib}_{_{—}}ₗᵢₙ^{Σ} voltage (change of the linearly-varying amplitude) producing the change of J_{calib}^{Σ}. So the values of u may be actually plotted along the y-axis (vertical axis) of graph IV₁₁ (e.g., see FIG. 11). At the same time, u may be the argument of the signal u_{calib}_{_{—}}ₗᵢₙ^{Σ}, and so it may be plotted along the axis of the arguments (horizontal axis) of graph IV₁₁. Because the dependence of u on u may always be linear, hence the linearity of the graph may be followed as it may be described by expression (27).

The information signal uₘₙ^{Σ}≈Bₘₙ^{L}+Bₘₙ^{R} may be applied to the input [symbol] of the electronic functional module with the transfer function Λ₍₁₎^{Σ} (corresponding indication may be uₘₙ^{Σ}≈Bₘₙ^{L}+Bₘₙ^{R}⊂ [symbol] on the drawing, graph V₁₁). The resulting total intensity Jₘₙ^{L}^{_{—}}^{comp}+Jₘₙ^{R}^{_{—}}^{comp} of the light flux in the two formation windows:

Jₘₙ^{L}^{_{—}}^{comp}+Jₘₙ^{R}^{_{—}}^{comp}=Λ₍₁₎^{Σ}{Φ₍₁₎^{Σ}(Bₘₙ^{L}+Bₘₙ^{R})}==Φ₍₁₎^{-1(Σ)}{Φ₍₁₎^{Σ}(Bₘₙ^{L}+Bₘₙ^{R})}=Bₘₙ^{L}+Bₘₙ^{R} (36)

may be directly proportional to Bₘₙ^{L}+Bₘₙ^{R}. It may correspond to graph V₁₁ (e.g., see FIG. 11) in the form of a straight line in accordance with the same linearization algorithm (as examined in the example of the signal u_{calib}_{_{—}}ₗᵢₙ^{Σ} with linearly-varying amplitude in graph IV₁₁). It may correspond to the desired linearization of Σ{A}-modulation relative to a arbitrary signal in the form of the sum of the values Bₘₙ^{L}+Bₘₙ^{R}. Indeed, the value of Bₘₙ^{L}+Bₘₙ^{R} may actually be plotted along the axis of the arguments and also along the y-axis of graph V₁₁ as a result of compensation of the nonlinearity of Σ{A}-modulation whereas the supplied arbitrary signal may pass through the electronic functional module with the transfer function Λ₍₁₎^{Σ}. Also, the influence of the first linearization function Λ₍₁₎^{Σ} on the nonlinearity of Σ{A}-modulation may be invariant relative to the form of the supplied signal. In case of the calibration signal u_{calib}_{_{—}}ₗᵢₙ^{Σ} all the deviations of the supplied signal (i.e., deviations of the amplitude of Bₘₙ^{L}+Bₘₙ^{R}) from linear dependence may be identical both for the y-axis and x-axis. So the described linearity (36) of graphic dependence:

J_{calib}^{Σ}^{_{—}}^{comp}=Λ₍₁₎^{Σ}{J_{calib}^{Σ}(u)}=J_{calib}^{-1(Σ)}{J_{calib}^{Σ}(u)}=u (37)

may be followed.)

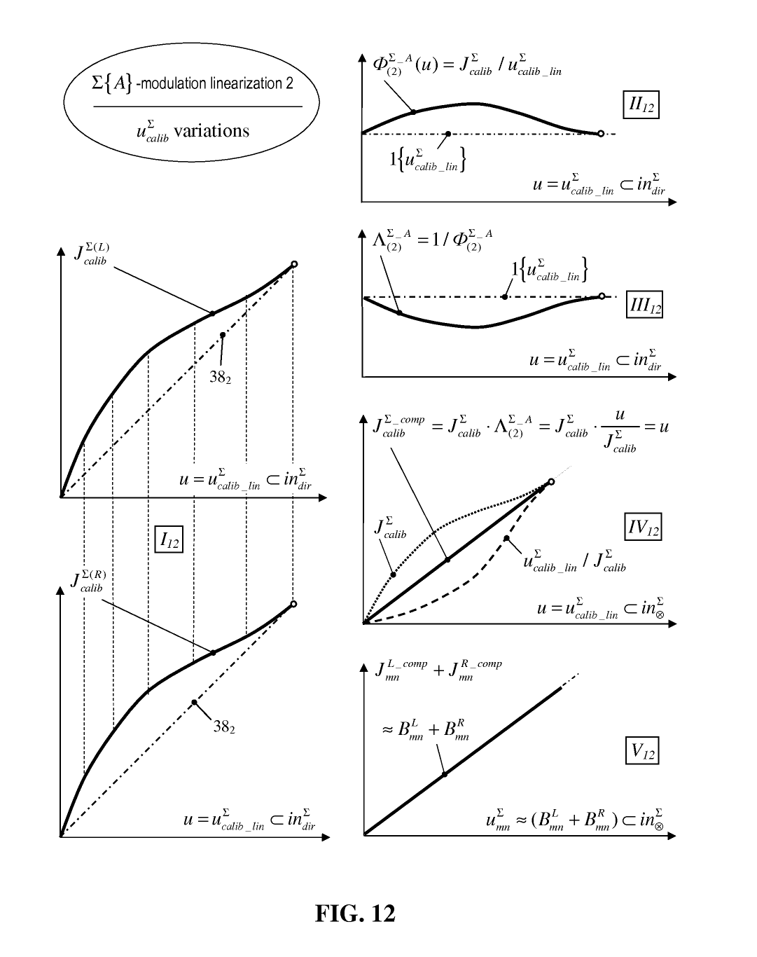

When using the second linearization function Λ₍₂₎^{Σ}, the light flux intensity values J_{calib}^{Σ(L)} and J_{calib}^{Σ(R)} in the left W_{form}^{L} and right W_{form}^{R} formation windows may still be represented by the curve J_{calib}^{Σ} (e.g., see FIG. 12), having essential deviations from inclined straight line 38. That may be a graph of direct proportional dependence (graph I₁₂), whereas the linearly-varying calibration signal u_{calib}_{_{—}}ₗᵢₙ^{Σ} of Σ{A}-modulation may be applied to the control input in_{dir}^{Σ} of Σ{A}-modulator. The second calibration function Φ₍₂₎^{Σ}^{_{—}}^{A}(u) of Σ{A}-modulation nonlinearity may be equal to the ratio of J_{calib}^{Σ}(u) to the value of its argument. So this function (graph II₁₂) may be characterized by deviations from a straight line 1{u_{calib}_{_{—}}ₗᵢₙ^{Σ}}. This line may be the plot of the unit transmission coefficient of the calibration signal u_{calib}_{_{—}}ₗᵢₙ^{Σ} of Σ{A}-modulation. The second linearization function Λ₍₂₎^{Σ}^{_{—}}^{A}(u) may be represented by the curve (e.g., see graph III₁₂ in FIG. 12), that may be mirror symmetric of the curve Φ₍₂₎^{Σ}(u) relative to the straight line 1{u_{calib}^{Σ}} due to the definition of the function Λ₍₂₎^{Σ}^{_{—}}^{A}(u) as the reciprocal of the function Φ₍₂₎^{Σ}^{_{—}}^{A}(u).

To obtain the compensated (with corrected nonlinearity) Σ{A}-component J_{calib}^{Σ}^{_{—}}^{comp}(u) of the light flux intensity (graph IV₁₂), the compensating signal u_{calib}_{_{—}}ₗᵢₙ^{Σ}^{_{—}}^{comp}

u_{calib}_{_{—}}ₗᵢₙ^{Σ}^{_{—}}^{comp}=Λ₍₂₎^{Σ}^{_{—}}^{A}{u_{calib}_{_{—}}ₗᵢₙ^{Σ}^{_{—}}^{comp}}. (38)

may be applied to the control input in_{dir}^{Σ} of the electronic functional module of the Σ{A}-modulator. The J_{calib}^{Σ}^{_{—}}^{comp}(u) may be the result of multiplication of the calibration values J_{calib}^{Σ} of the light flux intensity in either of the formation windows into the second linearization function Λ₍₂₎^{Σ}^{_{—}}^{A}. The latter may be the reciprocal of the second nonlinearity function Φ₍₂₎^{Σ}^{_{—}}^{A} of Σ{A}-modulation in accordance with the formula (6). So the function Λ₍₂₎^{Σ}^{_{—}}^{A} may be the inverse function of the intensity values J_{calib}^{Σ}, multiplied by voltage values of the calibration signal u_{calib}_{_{—}}ₗᵢₙ^{Σ}:

$${J}_{calib}^{Σ\_ comp} = {J}_{calib}^{Σ} \cdot {Λ}_{( 2 )}^{Σ\_ A} = {J}_{calib}^{Σ} \cdot ( 1 / {Φ}_{( 2 )}^{Σ\_ A} ) = {J}_{calib}^{Σ} \cdot \frac{u}{{J}_{calib}^{Σ}} = u . \qquad ( 39 )$$

The direct proportional dependence of the intensity values J_{calib}^{Σ}^{_{—}}^{comp}(u) on values of u may be followed. It may be shown as graph IV₁₂ in FIG. 12 (analogously to the graph IV₁₁).

The information signal uₘₙ^{Σ}≈Bₘₙ^{L}+Bₘₙ^{R} may be applied to the input [symbol] of the electronic functional module with transfer function Λ₍₂₎^{Σ}. The resulting total intensity Jₘₙ^{L}^{_{—}}^{comp}+Jₘₙ^{R}^{_{—}}^{comp} of the light flux in two formation windows W_{form}^{L}, W_{form}^{R}:

$$\begin{matrix}{J}_{mn}^{L\_comp} + {J}_{mn}^{R\_comp} = {Λ}_{( 2 )}^{Σ - A} \cdot {Φ}_{( 1 )}^{Σ\_ A} \{ ( {B}_{mn}^{L} + {B}_{mn}^{R} ) \} = \\ = \frac{u}{{J}_{calib}^{Σ}} \cdot {J}_{mn}^{Σ} \{ {B}_{mn}^{L} + {B}_{mn}^{R} \} \\ = {B}_{mn}^{L} + {B}_{mn}^{R}\end{matrix} \qquad ( 40 )$$

may be directly proportional to Bₘₙ^{L}+Bₘₙ^{R} and may correspond to graph V₁₂ in the form of a straight line. The nonlinearity may be compensated as the result of the ratio of two functions providing a correction factor Bₘₙ^{L}+Bₘₙ^{R} to the voltage values.

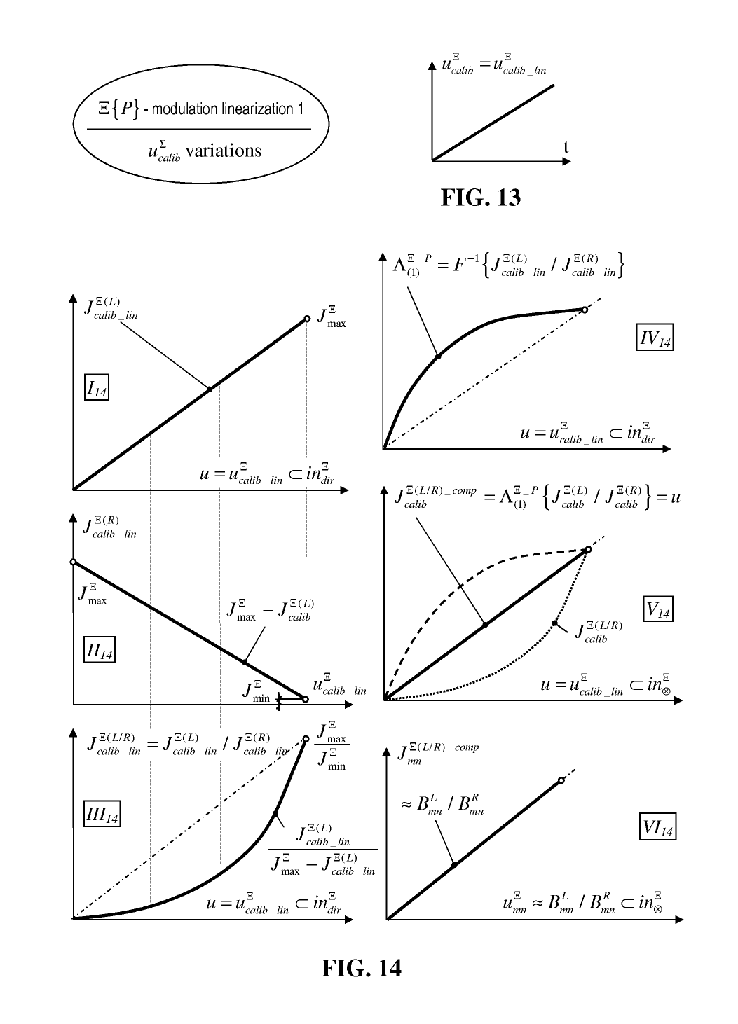

For linearization of Ξ{P}-modulation, the ratio calibration electronic signal uₗᵢₙ^{Ξ} with linearly increasing amplitude (e.g., see FIG. 13) may be applied to the control input in_{dir}^{Ξ} of the Ξ{P}-modulator. The voltage value on the control input in_{dir}^{Σ} of the Σ{P}-modulator may be a constant and preferably corresponds to the constant maximum value of the light flux intensity at the optical input of the Ξ{A}-modulator. It allows for obtaining the maximum dynamic range and high precision for calibration intensity values.

The first and second linearization procedures of Ξ{P}-modulation may correspond to the first Λ₍₁₎^{Ξ}^{_{—}}^{P} and second Λ₍₂₎^{Ξ}^{_{—}}^{P} linearization functions of Ξ{P}-modulation. When using the first linearization function Λ₍₁₎^{Ξ}^{_{—}}^{P}, the intensity values J_{calib}^{Ξ(L)} and J_{calib}^{Ξ(R)} of the light flux in the left W_{form}^{L} and right W_{form}^{R} formation windows may be represented by the calibration values J_{calib}^{Ξ} of the Ξ{P}-component of the light flux (e.g., see FIG. 14). For clarity of illustration of the subsequent realization of the linearization algorithm for the ratio J_{calib}^{Ξ(L/R)}=J_{calib}^{Ξ(L)}/J_{calib}^{Ξ(R)} of intensities, each of J_{calib}^{Ξ(L)} and J_{calib}^{Ξ(R)} may be represented by a linear function of the voltage value u of calibration signal u_{calib}^{Ξ} of Ξ{P}-modulation. This signal may be applied to the control input in_{dir}^{Ξ} of the Ξ{P}-modulator. The voltage value u of calibration signal u_{calib}^{Ξ} may be shown on the drawing as the signal argument u=u_{calib}_{_{—}}ₗᵢₙ^{Ξ}, belonging to the input in_{dir}^{Ξ} (i.e. u=u_{calib}_{ₗᵢₙ}^{Ξ}⊂in_{dir}^{Ξ}). The J_{calib}^{Ξ(L)} values may be represented by the straight line J_{calib}^{Ξ(L)}{u_{calib}_{_{—}}ₗᵢₙ^{Ξ}} for the left formation window (graph I₁₄) with positive derivative. The J_{calib}^{Ξ(R)} values may be represented by the straight line J₀^{Ξ}−J_{calib}^{Ξ}{u_{calib}_{_{—}}ₗᵢₙ^{Ξ}} for the right formation window (graph II₁₄) with negative derivative.

The graphic dependence of the relation J_{calib}^{Ξ(L/R)} (e.g., see graph III₁₄ in FIG. 14), may be nonlinear even with the linear graphic dependences for J_{calib}^{Ξ(L)} and J_{calib}^{Ξ(R)}, because J_{calib}^{Ξ(L/R)}:

J_{calib}^{Ξ(L/R)}(u)=J_{calib}^{Ξ(L)}(u)/J_{calib}^{Ξ(R)}(u)=J_{calib}^{Ξ(L)}(u)/Jₘₐₓ^{Ξ}−J_{calib}^{Ξ}(u) (41)

may be a hyperbolic dependence of the voltage value u with the maximum value Jₘₐₓ^{Ξ}/Jₘᵢₙ^{Ξ}. Here, Jₘₐₓ and Jₘᵢₙ may be constant values, equal to the maximum and minimum values accordingly of the light intensity calibration values. The linearization of {ΞP}-modulation using the first linearization function Λ₍₁₎^{Ξ}^{_{—}}^{P} may be implemented by taking the inverse function of the function Φ₍₁₎^{Ξ}^{_{—}}^{P}(u) of the Ξ{P}-modulation nonlinearity. The first calibration function Φ₍₁₎^{Ξ}^{_{—}}^{P}(u) in accordance with expression (32) for the ratio of intensities between the left W_{form}^{L} and right W_{form}^{R} formation windows may be equal to Φ₍₁₎^{Ξ(L/R)}(u)≈J_{calib}^{Ξ(L)}(u)/J_{calib}^{Ξ(R)}(u) i.e., the Φ₍₁₎^{Ξ}^{_{—}}^{P}(u) corresponds to the graph III₁₄. The graph IV₁₄ (e.g., see FIG. 14) may correspond to the first linearization function Λ₍₁₎^{Ξ} which may be the inversed function of the function Φ₍₁₎^{Ξ}^{_{—}}^{P}(u).

To obtain the compensated (with corrected nonlinearity) Ξ{P}-component J_{calib}^{Ξ}^{_{—}}^{comp}(u) of the light flux intensity (graph V₁₄), the compensating electronic signal u_{calib}_{_{—}}ₗᵢₙ^{Ξ}^{_{—}}^{comp}:

u_{calib}_{_{—}}ₗᵢₙ^{Ξ}^{_{—}}^{comp}=Λ₍₁₎^{Ξ}^{_{—}}^{P}{u_{calib}_{_{—}}ₗᵢₙ^{Ξ}} (42)

may be applied to the control input in_{dir}^{Ξ} of the electronic functional module of the Ξ{P}-modulator. The compensating electronic signal u_{calib}_{_{—}}ₗᵢₙ^{Ξ}^{_{—}}^{comp} may be a result of taking (calculating) the inverse function of the initial calibration signal u_{calib}_{_{—}}ₗᵢₙ^{Ξ}. So, the signal u_{calib}_{_{—}}ₗᵢₙ^{Ξ}^{_{—}}^{comp} may acquire nonlinear properties, which may be inversed relative to the nonlinear properties of Ξ{P}-modulation. The result of operation of the Ξ{P}-modulator, controlled by the compensating signal u_{calib}_{_{—}}ₗᵢₙ^{Ξ}^{_{—}}^{comp}, may be implementing a compensated Ξ{P}-component of J_{calib}^{Ξ}^{_{—}}^{comp}(u) of the light flux intensity. The compensated Ξ{P}-component may not have the {ΞP}-modulation nonlinearity that may be present in the initial Ξ{P}-component J_{calib}^{Ξ(L)}(u)/J_{calib}^{Ξ(R)}(u). So the graph VI₁₄ of the direct proportional dependence of the Ξ{P}-component of J_{calib}^{Ξ(L)}(u)/J_{calib}^{Ξ(R)}(u) on the amplitude of the initial signal of u_{calib}_{_{—}}ₗᵢₙ^{Ξ} may be valid. Analytically, this directly proportional dependence may be described as:

J_{calib}^{Ξ}^{_{—}}^{comp}=Λ₍₁₎^{Ξ}^{_{—}}^{P}{J_{calib}^{Ξ(L)}(u)/J_{calib}^{Ξ(R)}(u)}=Λ₍₁₎^{Ξ}^{_{—}}^{P}{J_{calib}^{Ξ(L/R)}(u)}==J_{calib}⁻¹^{_{—}}^{Ξ(L/R)}{J_{calib}^{Ξ(L/R)}(u)}=u (43)

where J_{calib}⁻¹^{_{—}}^{Ξ(L/R)} may be the inverse function of the function J_{calib}^{Ξ(L/R)}. Taking the inverse function of the original function corresponds to obtaining the argument u of the original function. So, the values of u may be actually plotted along the y-axis (vertical axis) of the graph V₁₄ (e.g., see FIG. 14). As the value of u may be the argument of the signal u_{calib}_{_{—}}ₗᵢₙ^{Ξ} so the values of u may be plotted also along the horizontal axis of the arguments of graph V₁₄. The dependence of u on u may always be linear, so the graphic dependence (43) may be a straight line.

If the signal uₘₙ^{Σ} may be applied to the input [symbol] of the electronic functional module having transfer function Λ₍₁₎^{Ξ}^{_{—}}^{P}, the resulting compensated ratio of the intensities Jₘₙ^{Ξ(L/R)} ^{_{—}}^{comp} between the two formation windows W_{form}^{L}, W_{form}^{R}:

$$\begin{matrix}{J}_{mn}^{Ξ ( L / R ) \_comp} = {Λ}_{( 1 )}^{Ξ\_ P} \{ {Φ}_{( 1 )}^{Ξ\_ P} ( {B}_{mn}^{L} / {B}_{mn}^{R} ) \} \\ = {J}_{calib}^{- 1 \_Ξ ( L / R )} \{ {J}_{mn}^{Ξ ( L / R )} ( {B}_{mn}^{L} / {B}_{mn}^{R} ) \} = \\ = {J}_{calib}^{- 1 \_Ξ ( L / R )} \{ {B}_{mn}^{L} / {B}_{mn}^{R} \cdot {J}_{calib}^{Ξ ( L / R )} ( u ) \} \\ = {B}_{mn}^{L} / {B}_{mn}^{R} \cdot {J}_{calib}^{- 1 \_Ξ ( L / R )} \{ {J}_{calib}^{Ξ ( L / R )} ( u ) \} = \\ = {B}_{mn}^{L} ( u ) / {B}_{mn}^{R} ( u )\end{matrix} \qquad ( 44 )$$

may be directly proportional to Bₘₙ^{L}/Bₘₙ^{R} may correspond to graph VI₁₄ (e.g., see FIG. 14) in the form of a straight line. This may indicate implementation of the desired linearization of Ξ{P}-modulation relative to the arbitrary ratio Bₘₙ^{L}/Bₘₙ^{R}.

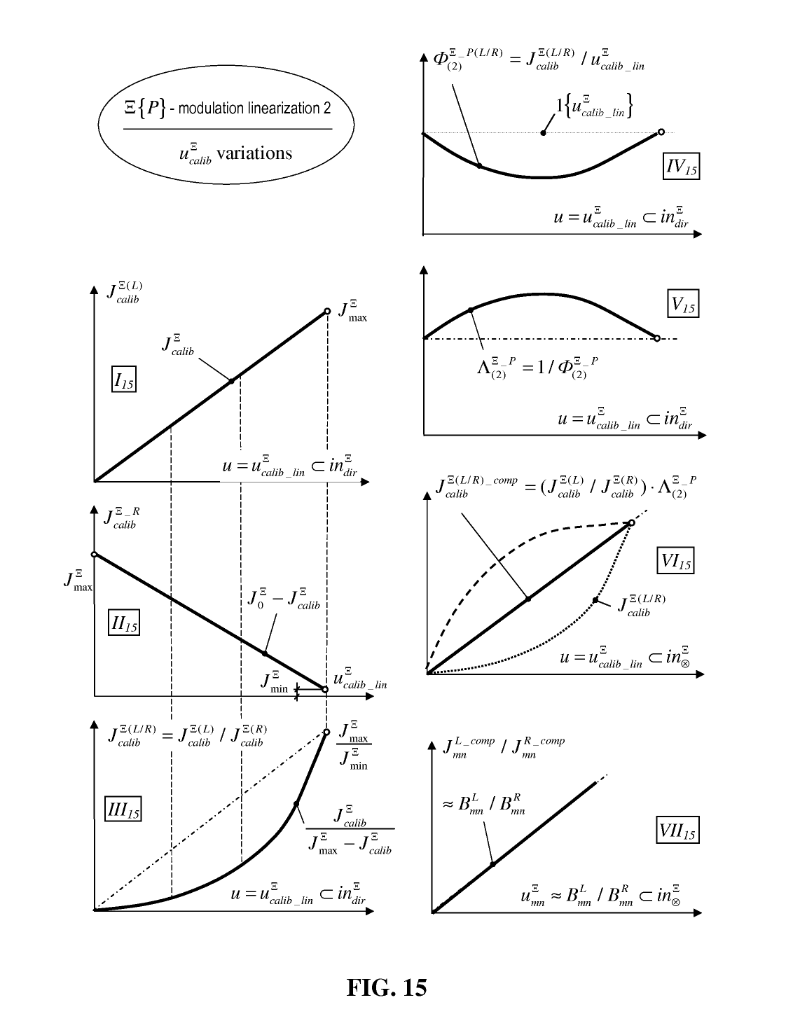

When using the second linearization function Λ₍₂₎^{Ξ}^{_{—}}^{P}, the light flux intensity values J_{calib}^{Σ(L)} and J_{calib}^{Σ(R)} in the left W_{form}^{L} and right W_{form}^{R} formation windows (e.g., see FIG. 15) may be represented, as before, by nonlinear dependence J_{calib}^{Ξ(L/R)} (graph III₁₅) even in case of linear graphic dependences for J_{calib}^{Ξ(L)} and J_{calib}^{Ξ(R)} (graphs I₅ and II₁₅). The linearly-varying calibration signal u_{calib}_{_{—}}ₗᵢₙ^{Ξ} may be applied to the control input in_{dir}^{Ξ} of the Ξ{P}-modulator.

The second calibration function Φ₍₂₎^{Ξ}^{_{—}}^{P}(u) of Ξ{P}-modulation nonlinearity may be equal to the result of dividing J_{calib}^{Ξ(L/R)}(u) by its argument u (e.g., see graph IV₁₅ in FIG. 15) and may be characterized by deviations from the straight line 1{u_{calib}^{Ξ}}. This line may be the graphic presentation of the unit transmission coefficient of the calibration signal u_{calib}^{Ξ} of Ξ{P}-modulation. The second linearization function Λ₍₂₎^{Ξ}^{_{—}}^{P}(u) may be represented by the curve (e.g., see graph V₁₅ in FIG. 15), that may be the minor symmetric of the curve function Φ₍₂₎^{Ξ}^{_{—}}^{P}(u) relative to straight line 1{u_{calib}^{Ξ}}. This may be a result of defining the function Λ₍₂₎^{Ξ}^{_{—}}^{P}(u) as the inverse function of the function Φ₍₂₎^{Ξ}^{_{—}}^{P}(u).

To obtain the compensated Ξ{P}-component of J_{calib}^{Ξ}^{_{—}}^{comp}(u) of the light flux intensity (e.g., see graph VI₁₅ in FIG. 15), the compensating electronic signal u_{calib}_{_{—}}ₗᵢₙ^{Ξ}^{_{—}}^{comp}:

u_{calib}_{_{—}}ₗᵢₙ^{Σ}^{_{—}}^{comp}=Λ₍₂₎^{Ξ}^{_{—}}^{P}{u_{calib}_{_{—}}ₗᵢₙ^{Ξ}^{_{—}}^{comp}} (45)

may be applied to the control input of in_{dir}^{Σ} of the electronic functional module of the Ξ{P}-modulator. The signal u_{calib}_{_{—}}ₗᵢₙ^{Ξ}^{_{—}}^{comp} may be the result of multiplication of two functions. The first function may describe the calibration values of the relation J_{calib}^{Ξ(L/R)}=J_{calib}^{Ξ(L)}/J_{calib}^{Ξ(R)} of the light flux intensities between the two formation windows W_{form}^{L}, W_{form}^{R}. The second function may be the linearization function Λ₍₂₎^{Ξ}^{_{—}}^{P} which may be the reciprocal (8) of the second calibration function Φ₍₂₎^{Σ} of Ξ{P}-modulation nonlinearity. In turn, Φ₍₂₎^{Σ} may be equal to relation of the intensity values J_{calib}^{Ξ(L/R)} divided by voltages values u of the calibration signal u_{calib}_{_{—}}ₗᵢₙ^{Σ}:

$$\begin{matrix}{J}_{calib}^{Ξ ( L / R ) \_comp} = {J}_{calib}^{Ξ ( L / R )} \cdot {Λ}_{( 2 )}^{Ξ} \\ = {J}_{calib}^{Ξ ( L / R )} \cdot ( 1 / {Φ}_{( 2 )}^{Σ} ) \\ = {J}_{calib}^{Ξ ( L / R )} \cdot \frac{u}{{J}_{calib}^{Ξ ( L / R )}} \\ = u\end{matrix} \qquad ( 46 )$$

The direct proportional dependence of the intensity values J_{calib}^{Ξ(L/R)} ^{_{—}}^{comp}(u) follows, as simultaneously u may be the argument of the u_{calib}_{_{—}}ₗᵢₙ^{Σ} and so it may be plotted along the horizontal axis of the arguments of graph VI₁₅ (e.g., see FIG. 15).

If the initial signal uₘₙ^{Ξ} may be applied to the input [symbol] of the electronic functional module having the transfer function Λ₍₂₎^{Ξ}, the resulting ratio of intensities Jₘₙ^{Ξ(L/R)} of the light flux in the two formation windows W_{form}^{L}, W_{form}^{R}:

$$\begin{matrix}{J}_{mn}^{Ξ ( L ) \_comp} / {J}_{mn}^{Ξ ( R ) \_comp} = {J}_{mn}^{Ξ ( L / R ) \_comp} \\ = {Λ}_{( 2 )}^{Ξ} \cdot {Φ}_{( 2 )}^{Ξ} \{ ( {B}_{mn}^{L} / {B}_{mn}^{R} ) \} = \\ = \frac{u}{{J}_{calib}^{Ξ ( L / R )}} \cdot {J}_{mn}^{Ξ ( L / R )} \{ {B}_{mn}^{L} / {B}_{mn}^{R} \} \\ = {B}_{mn}^{L} / {B}_{mn}^{R}\end{matrix} \qquad ( 47 )$$

may be directly proportional to Bₘₙ^{L}/Bₘₙ^{R} and corresponds to graph VII₁₅ (e.g., see FIG. 15) in the form of a straight line. Due to dividing the function Jₘₙ^{Ξ(L/R)} by the function J_{calib}^{Ξ(L/R)} the nonlinearity may be compensated. So, the resulting ratio may be a correction factor to the voltage value corresponding to changes of Bₘₙ^{L}/Bₘₙ^{R}.

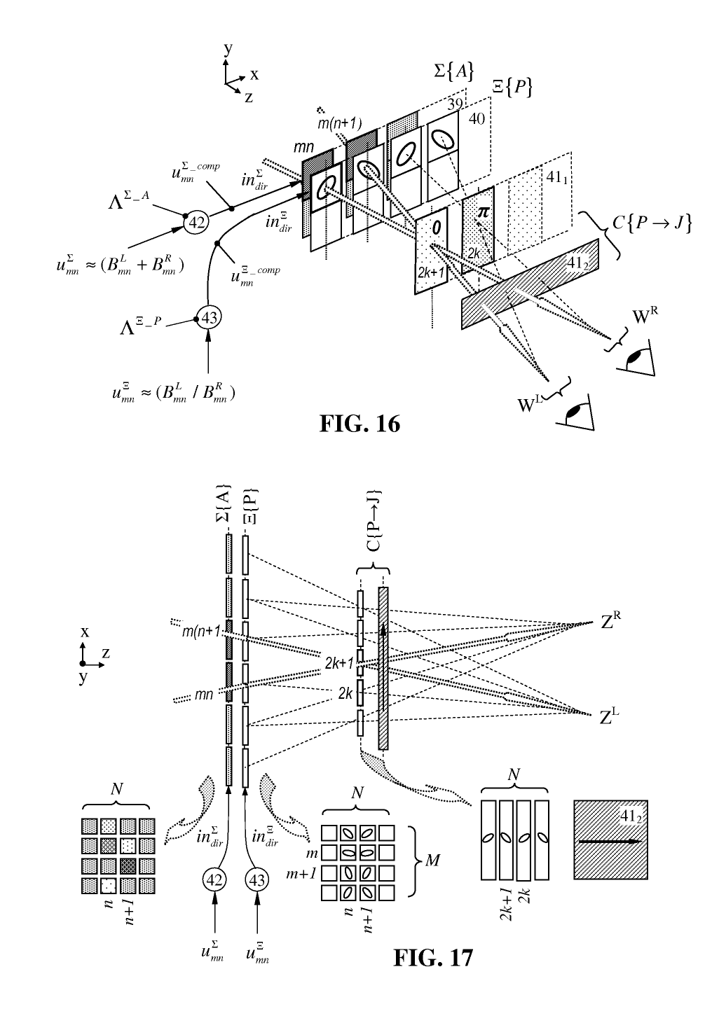

The second preferred embodiment of the method (e.g., FIGS. 16 and 17) comprises:

receiving a light wave from an optical source;

providing the real-amplitude optical modulator 39, that may be matrix-addressed in M rows and N columns, for modulating the light flux intensity to implement a direct sum modulation Σ{A} of the light wave in the mn^{th} element of the real-amplitude optical modulator 39, whereas applying a sum compensating signal sₘₙ^{Σ}^{_{—}}^{comp} to the control input of the real-amplitude optical modulator 39, wherein the amplitude of sₘₙ^{Σ}^{_{—}}^{comp} may be directly proportional to the linearization function Λ^{Σ} of the sum modulation,

providing the phase-polarization optical modulator 40, that may be matrix-addressed in M rows and N columns, for modulating the polarization state P of the light wave to implement an indirect ratio modulation C{P} in the mn^{th} element of the phase-polarization optical modulator 40, whereas setting complementary values of optical modulation parameters in the adjacent 2i and (2i−1) columns of the ratio optical modulator 40, wherein i=1, 2, . . . , N, and applying a ratio compensating signal sₘₙ^{Ξ}^{_{—}}^{comp} to the control input of the ratio optical modulator 40 wherein the amplitude of sₘₙ^{Ξ}^{_{—}}^{comp} may be directly proportional to the linearization function Λ^{Ξ} of the ratio modulation;

providing a N-column addressed spatially-periodic phase-polarization converter 41 comprising a static phase-polarization transparency 41₁ (that may be electrically addressed by N columns and has mutually orthogonal parameters of polarization state conversion in its adjacent 2k and (2k−1) columns, wherein k=1, 2, . . . , N) and a linear polarization analyzer 41₂, to form the first group of N light beams and second group of N light beams respectively in the left Z_{form}^{L} and right Z_{form}^{R} formation zones by converting a ratio C{P} polarization modulation into corresponding variations of the ratio component of the light flux intensity, wherein the intensity values Jₘₙ^{L} and Jₘₙ^{R} may be equal to the values Bₘₙ^{L} and Bₘₙ^{R} of brightness of mn^{th} elements of images of the left and right views respectively;

whereas directing to the left formation zone Z_{form}^{L} the first N/2 light beams of the first group passing through N/2 even 2i columns of the phase-polarization optical modulator 40 and through N/2 even 2k columns of the a static phase-polarization transparency 41₁, and the second N/2 light beams of the first group passing through N/2 odd (2i−1) columns of the phase-polarization optical modulator 40 and through N/2 odd (2k−1) columns of a static phase-polarization transparency 41₁;

directing to the right view formation zone Z_{form}^{R} the first N/2 light beams of the second group passing through N/2 odd (2i−1) columns of the phase-polarization optical modulator 40 and through N/2 even 2k columns of the a static phase-polarization transparency 41₁, and the second N/2 light beams of the of the second group passing through N/2 even 2i columns of the phase-polarization optical modulator 40 and through N/2 odd (2k−1) columns of the a static phase-polarization transparency 41₁;

observing left and right views of the stereo image in left Z_{V}^{L} and right Z_{V}^{R} observation zones, which may be optically coupled with the left Z_{form}^{L} and right Z_{form}^{R} formation zones respectively.

The amplitude of the first sum compensating signal s₍₁₎ₘₙ^{Σ}^{_{—}}^{comp}≈Λ₍₁₎^{Σ}{Bₘₙ^{L}+Bₘₙ^{R}} (22) may be directly proportional to the first linearization function Λ₍₁₎^{Σ} of the sum modulation, taken from the sum Bₘₙ^{L}+Bₘₙ^{R}. The amplitude of the second compensating sum signal s₍₂₎ₘₙ^{Σ}^{_{—}}^{comp}≈(Bₘₙ^{L}+Bₘₙ^{R})·Λ₍₂₎^{Σ} (23) may be directly proportional to the product of the sum Bₘₙ^{L}+Bₘₙ^{R} into the second linearization function Λ₍₂₎^{Σ} of the sum modulation. The amplitude of the first ratio compensating signal s₍₁₎ₘₙ^{Ξ}^{_{—}}^{comp}≈Λ₍₁₎^{Ξ}{Bₘₙ^{L}/Bₘₙ^{R}} (24) may be directly proportional to the first linearization function Λ₍₁₎^{Ξ} of the ratio modulation, taken from the ratio Bₘₙ^{L}/Bₘₙ^{R}. The amplitude of the second ratio compensating signal s₍₂₎ₘₙ^{Ξ}^{_{—}}^{comp}≈(Bₘₙ^{L}/Bₘₙ^{R})·₍₂₎^{Ξ} (25) may be directly proportional to the product of the ratio Bₘₙ^{L}/Bₘₙ^{R} into the second linearization function Λ₍₂₎^{Ξ} of the ratio modulation.

The first linearization function Λ₍₁₎^{Σ} of the sum modulation may be the inverse function Λ₍₁₎^{Σ}=F⁻¹ {Φ₍₁₎^{Σ}} (26). The second linearization function Λ₍₂₎^{Σ} of the sum modulation may be the reciprocal function Λ₍₂₎^{Ξ}=F^{reciprocal}{Φ₍₂₎^{Ξ}=1/Φ₍₂₎^{Ξ}} (27). The first linearization function Λ₍₁₎^{Ξ} of ratio modulation may be the inverse function Λ₍₁₎^{Ξ}=F⁻¹{Φ₍₁₎^{Ξ}} (28). The second linearization function Λ₍₂₎^{Ξ} of the ratio modulation may be the reciprocal function Λ₍₂₎^{Ξ}=F^{reciprocal}{Φ₍₂₎^{Ξ}}=1/Φ₍₂₎^{Ξ} (29)

The first calibration function Φ₍₁₎^{Σ} of the sum modulation nonlinearity may be determined as the assemblage Φ₍₁₎^{Σ}=J_{calib}^{Σ} (30), whereas applying a linearly-varying calibration signal s_{calib}_{_{—}}ₗᵢₙ^{Σ} of the sum modulation to the control input of the real-amplitude optical modulator 39. The second calibration function Φ₍₂₎^{Σ} of the sum modulation may be determined as the ratio Φ₍₁₎^{Σ}≈J_{calib}^{Σ}/s_{calib}_{_{—}}ₗᵢₙ^{Σ} (31) whereas applying the calibration signal s_{calib}_{_{—}}ₗᵢₙ^{Σ} of sum modulation applying to the control input of the real-amplitude optical modulator 39. The first calibration function Φ₍₁₎^{Ξ} of the ratio modulation may be determined according with the expression (32) whereas applying the calibration signal s_{calib}_{_{—}}ₗᵢₙ^{Ξ} of the ratio modulation to the control input of the phase-polarization optical modulator 40. The second calibration function Φ₍₂₎^{Ξ} of the ratio modulation may be determined according with the expression (33) whereas applying the signal s_{calib}_{_{—}}ₗᵢₙ^{Ξ} of the ratio modulation to the control input of the phase polarization optical modulator 40.

The sum compensating signal sₘₙ^{Σ}^{_{—}}^{comp} may be received at the output of the electronic functional module 42 which transfer function may be the linearization function Λ^{Σ}^{_{—}}^{A}(u) of the sum modulation, whereas the initial sum signal uₘₙ^{Σ} may be applied to the input of the electronic functional module 42. The amplitude of uₘₙ^{Σ} may be directly proportional to the sum Bₘₙ^{L}+Bₘₙ^{R} of the values of the brightness of the mn^{th} image elements of the left and right views.

The ratio compensating signal sₘₙ^{Ξ}^{_{—}}^{comp} may be received at the output of the electronic functional module 43 which transfer function may be the linearization function Λ^{Σ}^{_{—}}^{P}(u) of the ratio modulation, whereas the initial signal uₘₙ^{Ξ} may be applied to the input of the electronic functional module 43. The amplitude of uₘₙ^{Ξ} may be directly proportional to the ratio uₘₙ^{Ξ}≈Bₘₙ^{L}/Bₘₙ^{R}.

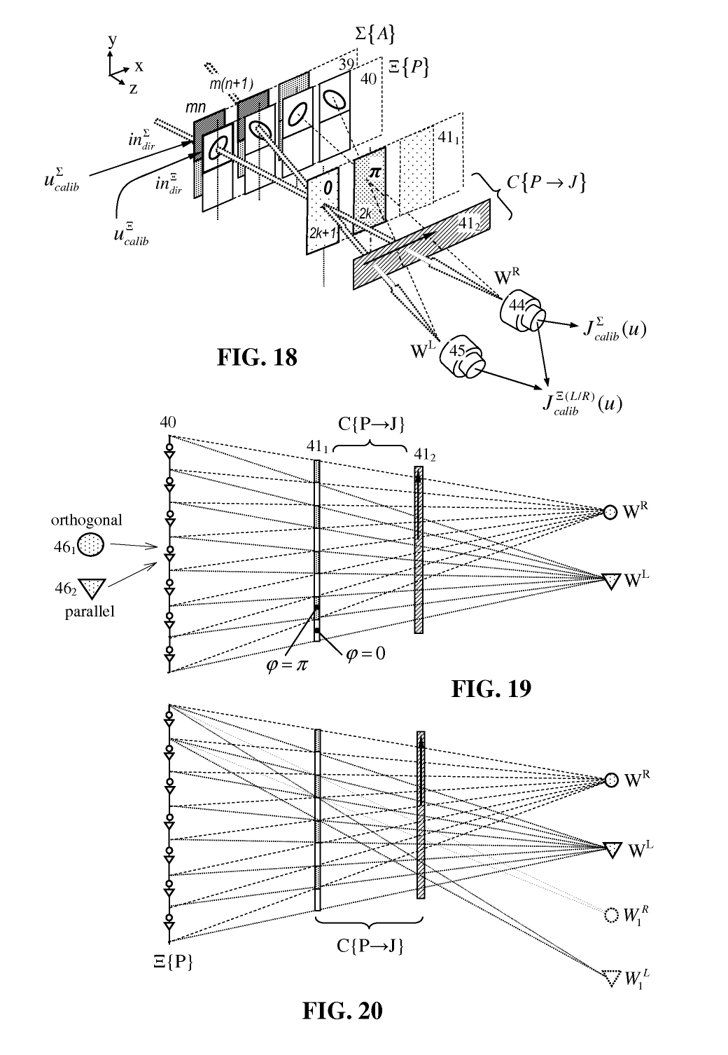

The calibration and linearization procedures (e.g., see FIG. 18) for the second preferred embodiment of method may be analogous to corresponding procedures for the first preferred embodiment of method, illustrated in FIGS. 10-15 and described by expressions (34)-(47). The photo detectors 42, 43, which apertures may be located in the left Z_{form}^{L} and right Z_{form}^{R} formation zones respectively, may be used for measuring the intensity calibration values.

Separation of the image elements of the left and right images may be implemented by operation of the linear polarizer 41₂ in collaboration with the phase-polarization transparency 41₁ (e.g., see FIG. 19). The separation may be illustrated by grouping the circular elements 45 and triangular 46 in different formation zones. The circular element 45 and triangular element 46 may correspond respectively to the orthogonal component and the parallel component of general polarization in plane C{P} relative to the polarization axis of linear polarization analyzer 41₂. To disclose the method, it may be sufficient to examine only the central pair of formation zones Z_{form}^{L}, Z_{form}^{R}. However, simultaneously the peripheral pairs of the formation zones (e.g., see FIG. 20) may also be formed. Separation in such zones (for example, in the peripheral pair Z₁^{L}, Z₁^{R} of the first order) may be implemented analogously to the central pair of formation Z_{form}^{L}, Z_{form}^{R}, which may correspond to the pair of the zero order.

The third embodiment of the method comprises:

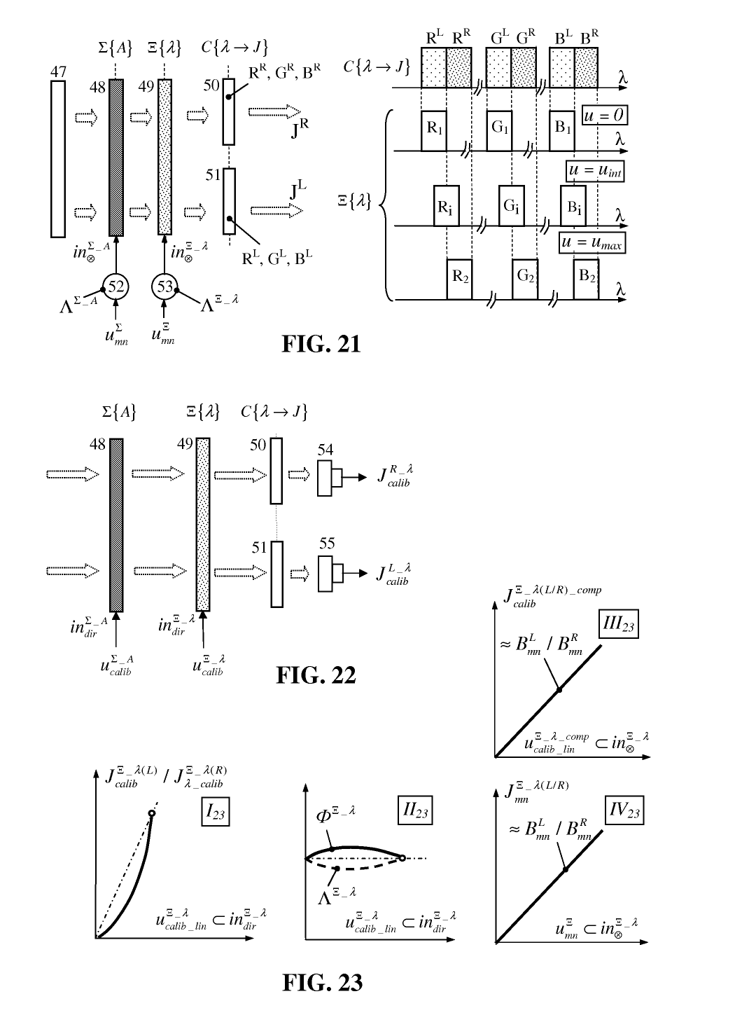

providing an optical source 47 (e.g., see FIG. 21) to receive a light flux with the first spectrum R₁, G₁, B₁;

providing a real-amplitude optical modulator 48 for modulating the real amplitude A of the light flux to implement a sum modulation Σ{A};

providing an optical spectral modulator 49 for the controlled changing the wavelength λ with transition from the first spectrum R₁, G₁, B₁ to the second spectrum R₂, G₂, B₂ to implement an indirect ratio modulation (Ξ{λ}-modulation), whereas changing the voltage at the control input of the optical spectral modulator 49 from the first (minimum) to the second (maximum) value;

providing the first and second optical spectral analyzers 50, 51 for comb spectral analysis to implement a conversion C{λ→J) of the indirect ratio modulation into the ratio component of the light flux intensity and forming by this the light fluxes of the mn^{th} image elements of the left Bₘₙ^{L} and right Bₘₙ^{R} views in the left W_{form}^{L} and right W_{form}^{L} formation windows.

The special characteristic R^{L}, G^{L}, B^{L} and R^{R}, G^{R}, B^{R} of the first and second optical spectral analyzers 50, 51 may correspond to the first R₁, G₁, B₁ and second spectrum R₂, G₂, B₂ respectively. The sum compensating signal sₘₙ^{Σ}^{_{—}}^{comp} may be applied to the control input of the real-amplitude optical modulator 48. The ratio compensating signal sₘₙ^{Ξ(L/R)} ^{_{—}}^{comp} may be applied to the control input of optical spectral modulator 49.

The sum compensating signal sₘₙ^{Σ}^{_{—}}^{A}^{_{—}}^{comp} (1), (2) may be received at the output of the electronic functional module 52. The transfer function of this module may be the linearization function Λ^{Σ}^{_{—}}^{A} of Σ{A}-modulation satisfying expressions (5),(6). The initial sum signal sₘₙ^{Σ} (13) may be applied to the input of the electronic functional module 52.

The ratio compensating signal sₘₙ^{Ξ}^{_{—}}^{λ}^{_{—}}^{comp} may be received at the output of the electronic functional module 53. The transfer function of this module may be the linearization function Λ^{Ξ}^{_{—}}^{λ} of Ξ{λ}-modulation satisfying expressions (7), (8). The initial ratio signal sₘₙ^{Ξ} (14) may be applied to the input of the electronic functional module 53.

The spectrum R₁, G₁, B₁ of the light flux, passing through the optical spectral modulator 49, may correspond to the spectral characteristic R^{L}, G^{L}, B^{L} of first optical spectral analyzer 51 in the absence of voltage on its control input (u=0). At the maximum value of the control voltage (u=uₘₐₓ) at the control input of optical spectral modulator 49 the passed through light flux may be characterized by the spectrum R₂, G₂, B₂, corresponding to the spectral characteristic R^{R},G^{R},B^{R} of the second optical spectral analyzer 50. At an intermediate value of the control voltage (u=uᵢₙₜ) the passed through light flux may have the spectrum R₁, G₁, B₁.

Consequently, at u=0 the light flux may have the maximum intensity at the output of first optical spectral analyzer 51 and the minimum intensity at the output of second optical spectral analyzer 51 (vice versa at u=uₘₐₓ). In such a way, the complementary optical characteristics of the optical conversion of the Ξ{λ}-modulation into a corresponding component of light flux intensity may be provided.

The photo detectors 54, 55 (e.g., see FIG. 22) may measure the calibration intensity values. The calibration procedures for determining the linearization function Λ^{Σ}^{_{—}}^{A} of the sum real-amplitude modulation and for the linearization function Λ^{Ξ}^{_{—}}^{λ} of the ratio spectral modulation may be analogous to the calibration procedures, which may be illustrated in FIGS. 10-15 and described by expressions (34)-(47). For example, the ratio of the light flux intensities J_{calib}^{Ξ}^{_{—}}^{λ(L)}/J_{calib}^{Ξ}^{_{—}}^{λ(R)}=J_{calib}^{Ξ}^{_{—}}^{λ(L/R)} in the left and right formation windows may take the form of graph I₂₃ (e.g., see FIG. 23) if the calibration signal with linearly-varying amplitude u_{calib}_{_{—}}ₗᵢₙ^{Ξ}^{_{—}}^{λ}⊂in_{dir}^{Ξ}^{_{—}}^{λ} may be applied to the control input in_{dir}^{Ξ} of the optical spectral analyzer 49. The linearization function Λ^{Ξ}^{_{—}}^{λ} of ratio spectral modulation may be received, for example, due to calculating the inverse values (8) of the ratio modulation spectral nonlinearity function Φ^{Ξ}^{_{—}}^{λ} (graph II₂₃). When a compensating calibration signal u_{calib}_{_{—}}ₗᵢₙ^{Ξ}^{_{—}}^{λ}^{_{—}}^{comp}⊂in [symbol] ^{_{—}}^{λ} may be applied to the control input of the electronic functional module 53, a linear dependence of the compensated ratio J_{calib}^{Ξ}^{_{—}}^{λ(L/R)} ^{_{—}}^{comp} of light intensities may be present in the left and right formation windows (graph III₂₃). When the compensating information signal uₘₙ^{Ξ}=in [symbol] ^{_{—}}^{λ} has the form (4), a linear dependence of the intensity values Jₘₙ^{Ξ}^{_{—}}^{λ(L/R)} of ratio spectral modulation (graph IV₂₃) may be present (e.g., see FIG. 23). Thus, the separation of the stereo image views may be achieved in accordance with expressions (18)-(20).

The fourth embodiment of the method comprises:

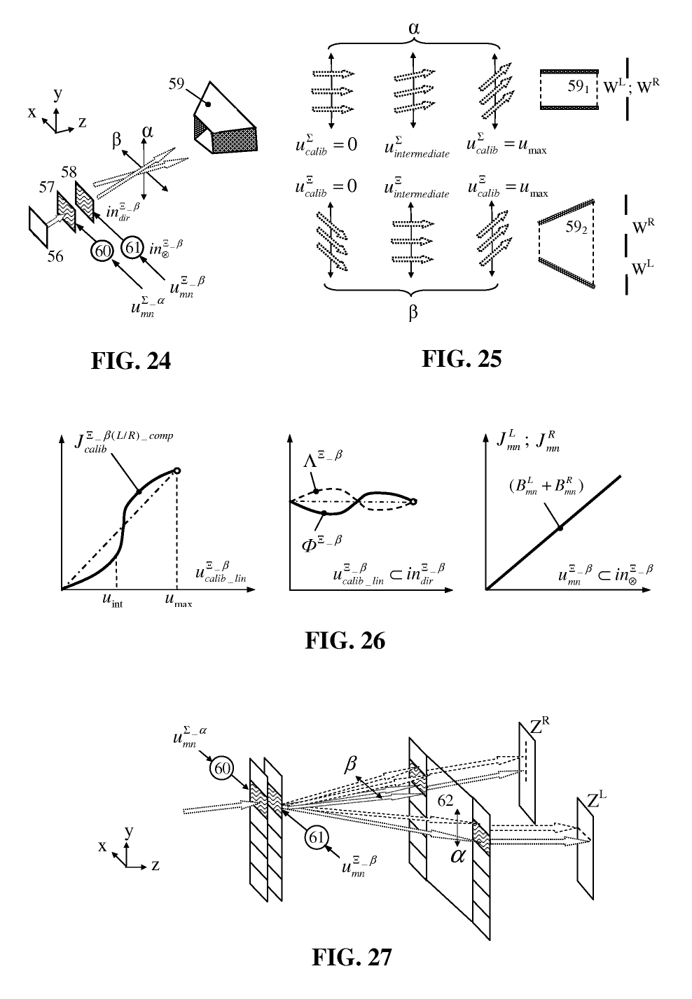

receiving a collimated (parallel) light flux from an optical source 56 (e.g., see FIG. 24);

providing a sum diffraction optical modulator 57 (hereinafter, Σ{A}-modulator 57) for changing the deflection angle α of the light flux in the first transverse direction (along the coordinate y) to implement a sum diffraction modulation Σ{A};

providing a ratio diffraction optical modulator 58 (hereinafter, Ξ{β}-modulator 58) for changing the deflection angle β of the light flux in the second transverse direction (along the x coordinate) to implement a ratio diffraction modulation Ξ{β};

providing a louver optical analyzer 59, that may be asymmetric in two mutually orthogonal transverse directions, to separate the light flux component J^{Σ} in the first transverse direction in accordance to the sum diffraction modulation Σ{α} and to separate the light flux component in a second transverse direction in accordance to the ratio diffraction modulation Ξ{β} in both formation windows.

The sum compensating electronic signal uₘₙ^{Σ}^{_{—}}^{α}^{_{—}}^{comp} and the ratio compensating electronic signal uₘₙ^{Ξ}^{_{—}}^{β}^{_{—}}^{comp} may be supplied to the control inputs of Σ{A}-modulator 57 and Ξ{β}-modulator 58 respectively.

The sum compensating signal uₘₙ^{Σ}^{_{—}}^{α}^{_{—}}^{comp} (1), (2) may be received at the output of the electronic functional module 60. The transfer function of this module may be the linearization function Λ^{Σ}^{_{—}}^{α} of Σ{α}-modulation in accordance with expressions (5), (6). The initial sum signal sₘₙ^{Σ} with amplitude (13) may be applied to the input of functional module 60. A ratio compensating signal sₘₙ^{Ξ}^{_{—}}^{β}^{_{—}}^{comp} may be received at the output of the electronic functional module 61. Transfer function of this module may be the linearization function Λ^{Ξ}^{_{—}}^{β} of Ξ{β}-modulation which satisfies expressions (7), (8) whereas an initial ratio signal sₘₙ^{Ξ} with amplitude (14) may be applied to the input of the electronic functional module 61.

The change of the deflection angle α of the light flux (e.g., see FIG. 25), caused by amplitude change of the sum compensating electronic signal uₘₙ^{Σ}^{_{—}}^{α}^{_{—}}^{comp}, may lead to changing an overlapping factor of the light flux in vertical direction (along coordinate y) of the section 59₁ of the asymmetric louver analyzer 59. In this direction, the overlapping factor may be identical for both formation zones Z_{form}^{L}, Z_{form}^{R}. The change of the amplitude of the ratio compensating electronic signal sₘₙ^{Ξ}^{_{—}}^{β}^{_{—}}^{comp} may cause the change of the light flux deflection angle β leading to a different (mutually opposite) overlapping factor of the light flux for the left Z_{form}^{L} and right Z_{form}^{R} formation zones. For example, increasing the angle β on some increment, the transmission coefficient of the horizontal section 59₂ of the asymmetric louver analyzer 59 for one of the formation zones may be increased, whereas the transmission coefficient for another formation zone may be decreased.

The calibration procedures for obtaining the linearization function Λ^{Σ}^{_{—}}^{α} of Σ{α}-modulation and the linearization function Λ^{Ξ}^{_{—}}^{β} of Ξ{β}-modulation may be analogous to the corresponding procedures for the first or second embodiments of the method, illustrated in FIGS. 10-15 and described by relations (34)-(47). For example, after obtaining the calibration values of the ratio J_{calib}^{Ξ}^{_{—}}^{β(L/R)} ^{_{—}}^{comp} in the left and right formation zones (e.g., see FIG. 26), the linearization function Λ^{Ξ}^{_{—}}^{β} of Ξ{β}-modulation may be determined by calculating the inverse values of the corresponding values of the nonlinearity function Φ^{Ξ}^{_{—}}^{β}, which may lead to the linearization of the Ξ{β}-component of the information variations of the light flux intensity Jₘₙ^{Ξ}^{_{—}}^{β(L/R)} depending on the amplitude of the ratio compensating electronic information signal uₘₙ^{Ξ}^{_{—}}^{β}.

For parallel forming of all M·N elements of the both views of stereo image, a matrix 62 of the asymmetric louver analyzers 59 (e.g., see FIG. 27) may be used, that may be implemented, for example, by nano-technological means or by a holographic method.

The fifth embodiment of the method comprises:

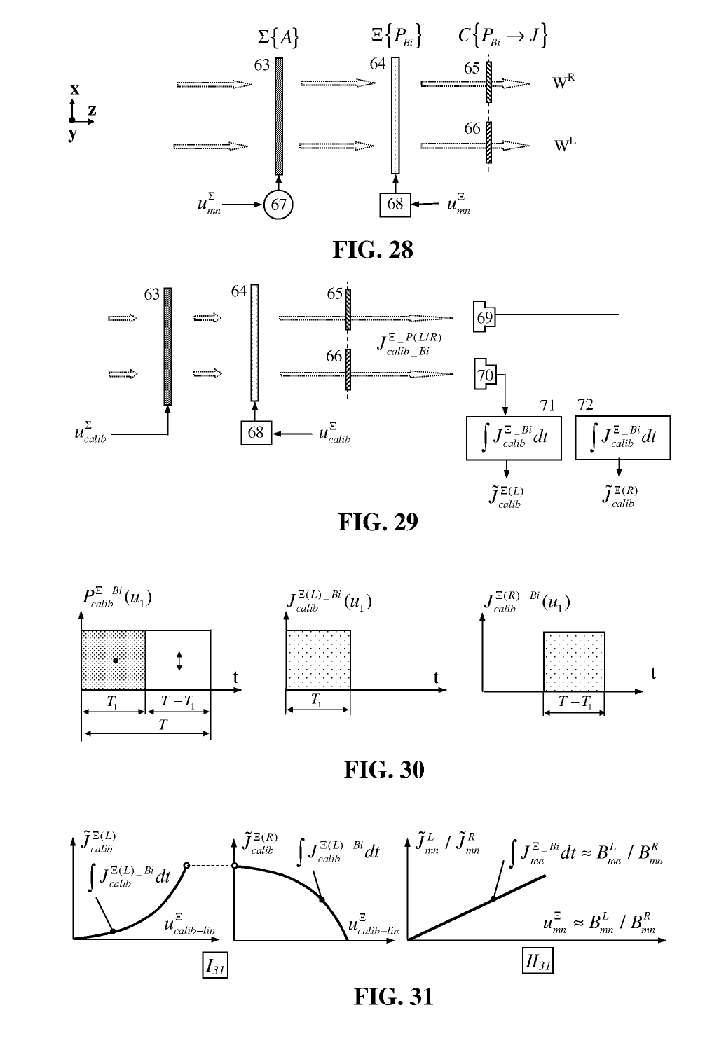

providing an analog real-amplitude optical modulator 63 (e.g., see FIG. 28) for implementing an analog modulation of real-amplitude A of the light flux to implement a sum modulation Σ{A};

providing a bistable polarization modulator 64 for implementing a pulse-width modulation (PWM) between two mutually orthogonal polarization states of the light flux to implement a bistable polarization ratio modulation Ξ{P_{Bi}} (hereinafter, Ξ{P_{Bi}}-modulation);

providing the first 65 and second 66 polarization analyzer with complementary polarization states to implement a polarization conversion C{P_{Bi}→J} of the bistable ratio modulation into bistable variations of the ratio component of light flux intensity, wherein the analog linearization function Λ_{analog}^{Σ}^{_{—}}^{A} of the sum modulation may be determined in accordance with expressions (26), (27).

The first linearization function Λ_{(1)Bi}^{Ξ}^{_{—}}^{P} of Ξ{P_{Bi}}-modulation may be the inverse function of the first calibration function Φ_{(1)Bi}^{Ξ}^{_{—}}^{P} of Ξ{P_{Bi}}-modulation nonlinearity:

Λ_{(1)Bi}^{Ξ}^{_{—}}^{P}(u)≈F⁻¹{Φ_{(1)Bi}^{Ξ}^{_{—}}^{P}(u)}. (48)

In turn, the function Φ_{(1)Bi}^{Ξ}^{_{—}}^{P} may be defined as the ratio \tilde{J}_{calib}_{_{—}}_{Bi}^{Ξ}^{_{—}}^{P(L/R)}(u) of the time-averaged calibration values \tilde{J}_{calib}_{_{—}}_{Bi}^{Ξ}^{_{—}}^{P(L)}(u) of the Ξ{P_{Bi}}-component of the light flux intensity in the left formation window to the time-averaged calibration values \tilde{J}_{calib}_{_{—}}_{Bi}^{Ξ}^{_{—}}^{P(R)}(u) of the Ξ{P_{Bi}}-component of the light flux intensity in the right formation window:

Φ_{Bi}^{Ξ}^{_{—}}^{P}(u)≈\tilde{J}_{calib}_{_{—}}_{Bi}^{Ξ}^{_{—}}^{P(L)}(u)/\tilde{J}_{calib}_{_{—}}_{Bi}^{Ξ}^{_{—}}^{P(R)}(u)=\tilde{J}_{calib}_{_{—}}_{Bi}^{Ξ}^{_{—}}^{P(L/R)}(u), (49)

wherein

$${\tilde{J}}_{calib\_Bi}^{Ξ\_ P ( L )} ( u ) = {\int }_{t}^{ } {J}_{calib\_Bi}^{Ξ\_ ( L )} d t , \\ {\tilde{J}}_{calib\_Bi}^{Ξ\_ P ( R )} ( u ) = {\int }_{t}^{ } {J}_{calib\_Bi}^{Ξ\_ P ( R )} d t \\ {\tilde{J}}_{calib\_Bi}^{Ξ\_ P ( L / R )} ( u ) = {\int }_{t}^{ } {J}_{calib\_Bi}^{Ξ\_ P ( L )} d t / {\int }_{t}^{ } {J}_{calib\_Bi}^{Ξ\_ P ( L )} d t . \qquad ( 50 )$$

The calibration pulse-width signal u_{calib}_{_{—}}ₗᵢₙ_{_{—}}_{Bi}^{Ξ}^{_{—}}^{P} with linearly-varying pulse width may be applied to the control input of the bistable polarization modulator 64. The second linearization function Λ_{(2)Bi}^{Ξ}^{_{—}}^{P} of {P_{Bi}}-modulation may be defined as the reciprocal function of the second calibration function Φ_{(2)Bi}^{Ξ}^{_{—}}^{P} of the bistable modulation nonlinearity:

ũ_{calib}_{_{—}}ₗᵢₙ^{Ξ}^{_{—}}^{P}=∫₀^{T}u_{calib}_{_{—}}ₗᵢₙ _{_{—}}_{Bi}^{Ξ}^{_{—}}^{P}dt. (51)

wherein the function Φ_{(2)Bi}^{Ξ}^{_{—}}^{P} may be:

$${Φ}_{( 2 ) Bi}^{Ξ\_ P} \approx \frac{{\tilde{J}}_{calib\_Bi}^{Ξ\_ P ( L )} ( u ) / {\tilde{J}}_{calib\_Bi}^{Ξ\_ P ( R )} ( u )}{{\tilde{u}}_{calib\_lin \_Bi}^{Ξ\_ P}} = \frac{{\tilde{J}}_{calib\_Bi}^{Ξ\_ P ( L / R )} ( u )}{{\tilde{u}}_{calib\_lin \_Bi}^{Ξ\_ P}} \qquad ( 52 )$$

and

ũ_{calib}_{_{—}}ₗᵢₙ^{Ξ}^{_{—}}^{P}=∫₀^{T}u_{calib}_{_{—}}ₗᵢₙ_{_{—}}_{Bi}^{Ξ}^{_{—}}^{P}dt. (53)

The sum compensating signal uₘₙ^{Σ}^{_{—}}^{A}^{_{—}}^{comp} (1), (2) may be received at the output of electronic functional module 67 with transfer function corresponding to an analog linearization function Λ_{analog}^{Σ}^{_{—}}^{A} of sum modulation which satisfies expressions (5),(6). The initial sum signal analog (13) may be applied to the input of the electronic functional module 67.

The ratio bistable compensating signal sₘₙ_{_{—}}_{Bi}^{Ξ}^{_{—}}^{P}^{_{—}}^{comp} comp may be received at the output of the PWM-transformer 68. The transfer function of this module may correspond to a bistable linearization function Λ_{Bi}^{Σ}^{_{—}}^{P} of the ratio modulation which satisfies the expressions (40), (44). The initial ratio signal sₘₙ^{Ξ} (14) may be applied to the input of the PWM-transformer 68.

The analog calibration electronic signal u_{calib}_{_{—}}ₗᵢₙ^{Ξ} with linearly-varying amplitude may be converted by the PWM-transformer 68 into variable-duration pulses with constant amplitude which may be used for driving the bistable polarization modulator 64.

A special feature of the procedure of obtaining the modulation function of bistable ratio polarization with pulse-width modulation of light flux intensity (e.g., see FIG. 29) may include measuring the intensity of calibration optical pulses in the two formation windows W_{form}^{L}.,W_{form}^{R}. The high speed photo detectors 69, 70 may be used which outputs may be connected with the inputs of time integrators 71, 72. The bistable optical modulator 64 may be controlled a calibration electronic signal u_{calib}_{_{—}}ₗᵢₙ^{Ξ}^{_{—}}^{Bi}. This signal may be produced by the PWM-transformer 68 and may have the form of a sequence of control electric pulses with linearly-varying (linearly increasing) width. The role of the bistable optical modulator 64 may be to implement alternatively two mutually orthogonal polarization states of the light flux. One polarization state may correspond to the zero logical level of the amplitude of the control electric pulses. Another polarization state may correspond to the unit logical level of amplitude. For example, the PWM-transformer 68, controlled by the first value u₁ of the analog calibration signal, may produce an electric pulse with a small width T₁. The result may be the practically instant forming the vertical (relative to the plane of the drawing in FIG. 30) polarization state of the light flux, produced by the bistable optical modulator 64. Due to operation of polarization analyzers 65, 66 with mutually orthogonal polarization characteristics the short (with duration T₁) light pulse may appear in the left formation window and the long light pulse with complementary (T−T₁) duration may appear in the right formation window.

In the next cycle, the PWM transformer 68, controlled by the second analog calibration signal u_{calib}_{_{—}}ₗᵢₙ^{Ξ} of value u₂ (where u₂>u₁), may produce an electric pulse with a greater width T₂. Respectively, the light pulse of greater (with time T₂) duration may appear in the left formation window, and the light pulse of reduced duration T−T₂ may appear in the right observation window. After measurement of intensity of the optical pulses by photo detectors 69, 70, the corresponding electronic signals may be applied to the inputs of time integrators 71, 72. These integrators may be characterized by constant time T of integration relative to the pulse repetition period in the calibration electronic signal u_{calib}_{_{—}}ₗᵢₙ^{Ξ}. The electronic signals at the outputs of the time integrators 71, 72 may be analog ones. The envelopes of these signals may correspond to time-averaged calibration values of ratio components \tilde{J}_{calib}^{Ξ(L)} and \tilde{J}_{calib}^{Ξ(R)} (e.g., see FIG. 31, graph I₃₁) of the light flux intensity in the left and right formation windows respectively. Integration in time of the calibration intensity values makes it possible to obtain linearization using analog transfer functions, analog nonlinearity functions and analog linearization functions even in case of bistable ratio polarization modulation. These functions may be calculated using analog or digital electronic functional modules as it was done in another particular embodiments of the method in accordance with expressions (49), (50), (52).

When viewing the stereo image during the operation of bistable polarization modulator 64, the light pulses (linearly changing in width relative to a changing the ratio Bₘₙ^{L}/Bₘₙ^{R}) may arrive to the formation windows W_{form}^{L},W_{form}^{R} (to the observer's eyes located in observation windows W_{V}^{L},W_{V}^{R}). The human vision may be characterized by short-term optical memory, which performs temporary integration of arriving light pulses. So, light pulses with constant level and variable duration may be perceived as a continuous light flux with intensity values proportional to the durations of the optical pulses with constant intensity level. Such condition takes place if the frequency of arrival of optical pulses to each eye of the observer may be higher than a critical value, for example, if the frequency of arrival of the pulses may not be below 50-60 hertz (such frame rate of television systems was selected to meet the same condition). Then, the light energy may be distributed between the two formation windows W_{form}^{L},W_{form}^{R} according with temporal parameters of the bistable PWM. For example, the duration Tₘₙ of the one light pulse (sent to the left formation window) may be directly proportional to the ratio B_{L}^{mn}/B_{R}^{mn} at the same time another light pulse with duration of T−Tₘₙ may be sent to the right formation window. If the optical pulse duration Tₘₙ in the left observation window linearly increases, the left eye may perceive the equivalent linear increase of the light flux intensity, proportional to an increase in the ratio B_{L}^{mn}/B_{R}^{mn} as a result of the time integrating property of the human vision. In the right observation window, the right eye may perceive a decrease of the time-averaged light flux intensity in accordance with the ratio B_{L}^{mn}/B_{R}^{mn}. The perceived time-averaged light flux intensity values may graphically correspond to straight lines which ordinates may be numerically equal to integrals over duration T (e.g. see FIG. 31, graph II₃₁). This means that the expression (19) may be fulfilled for the considered light flux intensities. Simultaneously, a sum modulation of the light flux component, which may be proportional to the sum Bₘₙ^{L}+Bₘₙ^{R}, may be implemented by the analog real-amplitude optical modulator 63 after the sum modulation linearization in accordance with expressions (7)-(10). Then, the expression (18) for light flux intensities in the observation windows may also be fulfilled, leading to fulfillment of the expression (20), i.e., to the desired separation of the views (to forming and observing a stereo image).

When calculating nonlinearity functions, known characteristic of nonlinear perception by human vision of changes in image brightness (intensity of light fluxes entering the eyes) may be taken into account.

The special feature of the embodiments of the method with glasses-free observation may be that measuring of intensity calibration values may be implemented in the formation zones Z_{form}^{L}, Z_{form}^{L} (instead of the formation windows W_{form}^{L}, W_{form}^{R} in the first embodiment of the method).

In all considered embodiments of the method a nonlinear interaction between the physical parameters of Σ-modulation and Ξ-modulation may be absent. It allows the use of separate (mutually independent) calibration procedures for each kind of modulation. The result of each independent procedure may be one-dimensional linearization function of Σ-modulation and one-dimensional linearization function of Ξ-modulation, which arguments may be the values only of their own calibration signals for Σ-modulation and Ξ-modulation.

The absence of nonlinear interaction in the first, second, third and fifth embodiments of the method may be caused by differences in physical parameters of Σ-modulation and Ξ-modulation of the light flux (light wave). The real-amplitude modulation may be used for Σ-modulation and the polarization or spectral modulation may be used for Ξ-modulation. In the fourth particular embodiment of the method, the same kind of modulation (the diffraction modulation) may be used for both Σ-modulation and Ξ-modulation. The nonlinear interaction may be absent here as a result of using two mutually orthogonal directions in space for implementing Σ-modulation and Ξ-modulation.

On the contrary, using the same degree of freedom of the space of the modulation parameters for realization both Σ-modulation and Ξ-modulation may lead to their nonlinear interaction. The nature of the interaction may be determined by the concrete physical mechanism of operation of the sum (uniform-effect) optical modulator and/or the ratio (difference-effect) optical modulator.

The sixth embodiment of the method comprises:

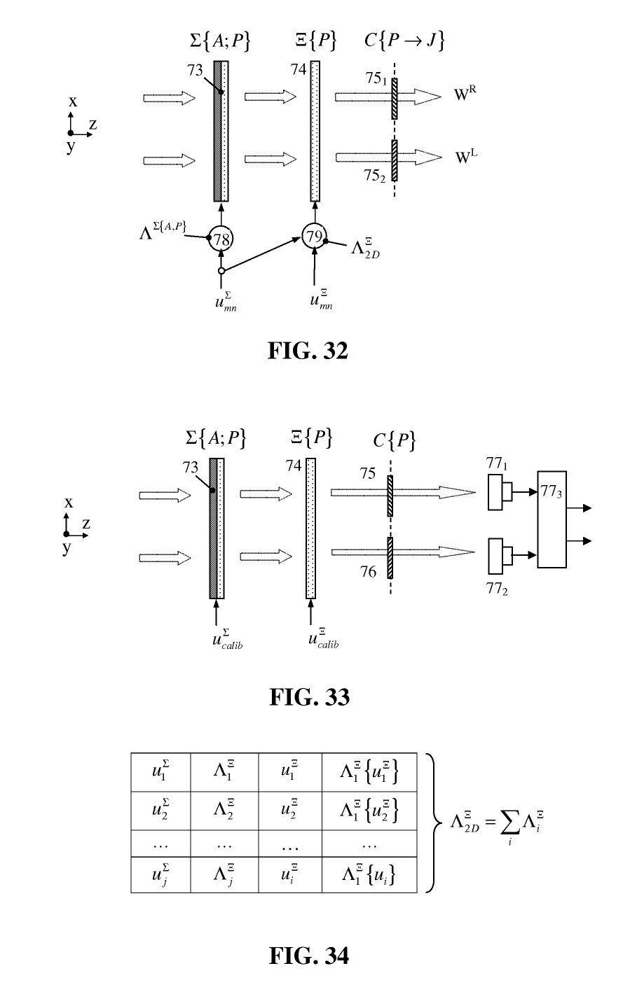

providing a combined (real-amplitude and polarization) optical modulator 73 (e.g., see FIG. 32) for combined modulating a real amplitude A and a polarization state P of the light flux to implement a combined sum modulation Σ{A; P} in the form of a real-amplitude sum modulation as a main sum modulation in combination with a polarization modulation as a concomitant sum modulation;

providing a polarization modulator 74 for modulating the polarization state P of the light flux to implement a ratio polarization modulation Ξ{P} as a main ratio modulation;

providing polarization analyzers 75, 76 with complementary polarization characteristics for converting a ratio polarization modulation conversion C{P→J) into the corresponding variations of the ratio component of the flux light intensity and a concomitant sum polarization modulation in the corresponding variations of the total intensity of the light flux.

The special feature of the sixth embodiment of the method may be the presence of two (main A and concomitant P) physical parameters of Σ-modulation, where the concomitant Σ-modulation parameter (polarization state of the light flux) may be similar to the main parameter of Ξ-modulation. By definition the main parameter of Σ-modulation (or Ξ-modulation) may be such one that may be purposefully used for calculating the sum (or the ratio) of the values of the brightness of the left and right views. The form of the information signal sₘₙ^{Σ} (or sₘₙ^{Ξ}), applied to the control input of Σ-modulator (or Ξ-modulator) allows to achieve the required characteristics of the main parameter of Σ-modulation (or Ξ-modulation). The concomitant parameter of Σ-modulation (or Ξ-modulation) may be such physical parameter of the light flux (light wave), presence of which may not be necessary for calculating the sum (or the ratio) of values of the brightness of the left and right views, but its presence may be caused by particular features of concrete implementation of Σ-modulator (or Ξ-modulator).

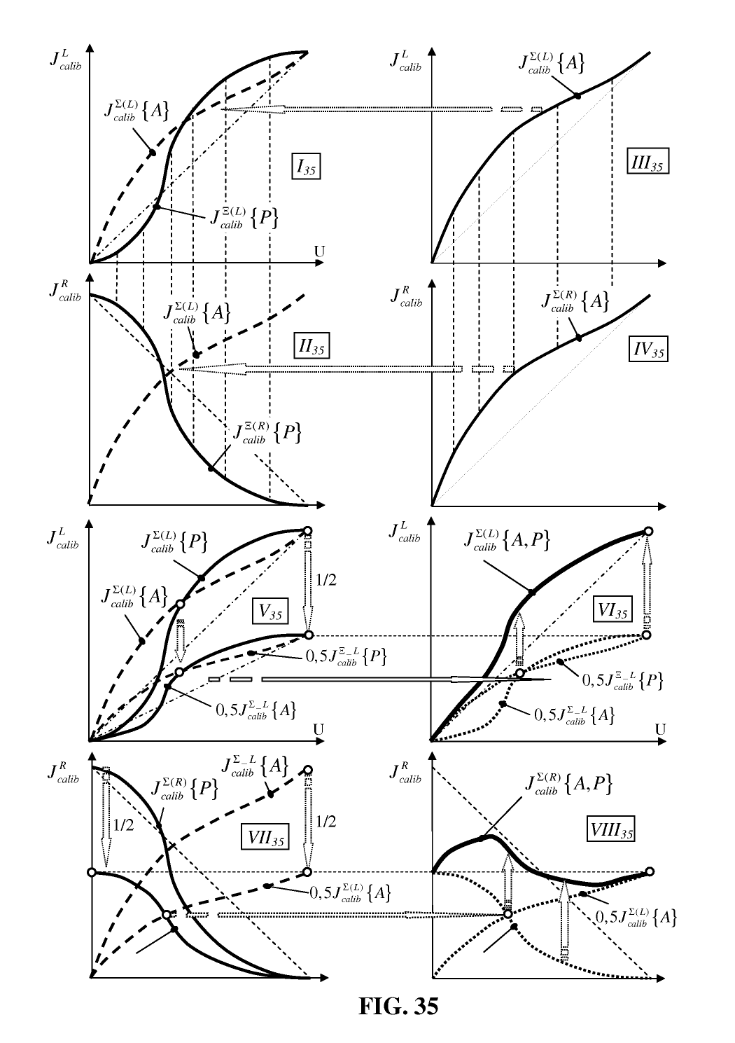

In the sixth embodiment of the method, the presence of the concomitant polarization modulation in Σ-modulation may lead to the appearance of asymmetry in the graphs of the calibration intensity values of the sum component of the light flux intensity between the two formation windows W_{form}^{L}, W_{form}^{R} (e.g., see FIG. 35) in case of implementation of a separate calibration procedure for Σ-modulation. This may be the fundamental difference from calibration procedures in the absence of the concomitant Σ-modulation. During implementation of the calibration of Σ-modulation, the presence of the concomitant polarization P modulation may be equivalent to having additional ratio modulated calibration components J_{calib}^{Ξ(L)}{P} (graph I₃₅) and J_{calib}^{Ξ(R)}{P} (graph II₃₅) in the left W_{form}^{L} and right W_{form}^{R} formation windows accordingly (e.g., see FIG. 35). Absence of polarization P modulation may lead to symmetrical calibration curves J_{calib}^{Σ(L)}{A} (graph III₃₅) and J_{calib}^{Σ(R)}{A} (graph IV₃₅) in the corresponding formation windows. The graph V₃₅, VI₃₅, VII₃₅ and VIII₃₅ illustrate the appearance of the asymmetry in the calibration intensities values. The graph V₃₅ and graph VII₃₅ may be the intermediate sketches corresponding to normalization i.e., to halving the initial values of intensities J_{calib}^{Σ}{A} and J_{calib}^{Ξ}{P}. The graph VI₃₅ and graph VII₃₅ (e.g., see FIG. 35) shows the final calibration curves of light intensities in the left and right formation windows as a result of summation of the corresponding normalized curves. In each formation window, the resulting calibration intensity values (corresponding to a nonlinearity of Σ-modulation) may be obtained using transformation P→I of the concomitant polarization P modulation.

The concomitant Σ-modulation parameter may also serve as the main parameter for the Ξ-modulation. To restore the symmetry of the graphs for Σ-modulation, the joint calibration procedure for Σ-modulation and Ξ-modulation may be implemented. After this Σ-modulation symmetry may be restored due to mutual compensation of polarization parameters of the concomitant Σ-modulation and Ξ-modulation. The received assemblage of the compensating values of Ξ-modulation polarization calibration parameter may be the assemblage of the starting points of the main Ξ-modulation component. Such starting point may be different for each value of the control signal amplitude. The joint calibration procedure may lead to the two-dimensional function describing the calibration intensity values J_{calib}^{Ξ{Σ}}(u_{calib}^{Ξ}; u_{calib}^{Σ}) of Ξ-modulation nonlinearity, which may become a function of two variables, namely, of its own ratio calibration signal u_{calib}^{Ξ} and of crossed sum calibration signal u_{calib}^{Σ}.

The scheme of observing stereo images using linearization function Λ^{Σ}^{_{—}}^{A}^{_{—}}^{P} of combined Σ{A; P} sum modulation nonlinearity and linearization function Λ^{Ξ}^{_{—}}^{P} of ratio polarization nonlinearity (e.g., see FIG. 32) comprises a sum optical modulator 73, a ratio optical modulator 74 and two polarization analyzers 75, 76. The corresponding scheme of joint calibration (e.g., see FIG. 33) may have photo detectors 77, 78 to determine the calibration values of light intensity. In the scheme of observing stereo images, the initial sum signal uₘₙ^{Σ} and initial ratio signal uₘₙ^{Ξ} may be applied to the inputs of the electronic functional modules 78 and 79 accordingly. During a joint calibration procedure, two sets of calibration values may be stored in the memory of the electronic functional module 79, and compensating values of the signal u_{calib}^{Σ} may be determined for each resolvable value of the signal u_{calib}^{Σ} amplitude. Then, the separate calibration procedure for Ξ-modulation may be implemented with using the stored values of the calibration signal of Ξ-modulation as the initial values for calibration of the main Ξ-modulation only. One set J_{calib}^{Σ}^{_{—}}^{A}(u_{calib}^{Σ}) (relating to Σ-modulation) may be one-dimensional. This set may be used for calculating the one-dimensional nonlinearity function and the one-dimensional linearization function of Σ-modulation in accordance with relations (26), (27). Another set J_{calib}^{Ξ{Σ}}(u_{calib}^{Ξ}; u_{calib}^{Σ}) of calibration values may be two-dimensional (represented, for example, by selection of data from the table in FIG. 34). This set may be used for calculating the two-dimensional nonlinearity function and the linearization function of the Ξ-modulation. The obtained linearization functions may be data for the transfer functions which may be set for electronic functional modules 78 and 79. The latter may have two inputs, one for inputting its own Ξ-modulation information signal, the other for inputting the cross Ξ-modulation information signal.

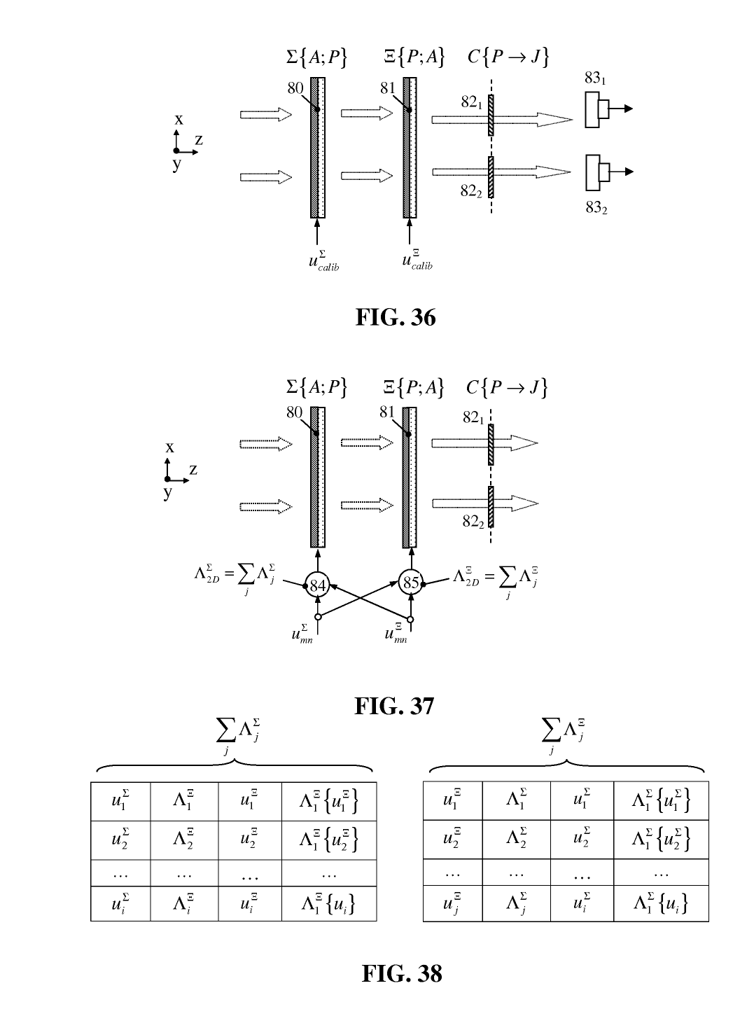

In the seventh embodiment of the method the calibration scheme (e.g., see FIG. 36) may comprise an amplitude polarization modulator 80 for implementation of main real-amplitude modulation and concomitant polarization modulation as components of the combined Σ{A, P}-modulation). An amplitude polarization modulator 81 may be used for implementation of main polarization modulation and concomitant real-amplitude modulation as components of the combined Ξ{P, A}-modulation. Both of the Σ{A, P}-modulation and Ξ{P, A)-modulation may be converted by polarization analyzers 82, 83 into corresponding variations of intensity in the left and right formation windows. The corresponding calibration signals may be applied to the control inputs of the combined (real-amplitude and polarization) modulator 80 and combined (real-amplitude and polarization) modulator 81. The photo detectors 82₁ and 83₁ may allow for determining the calibration values of light intensity.

Joint calibration procedures may be necessary to obtain the two-dimensional function of Σ-modulation nonlinearity and two-dimensional function of Ξ-modulation nonlinearity. Corresponding two-dimensional linearization function

$${\sum }_{j} {Λ}_{j}^{Σ}$$

of Σ-modulation and two-dimensional linearization function

$${\sum }_{j} {Λ}_{j}^{Ξ}$$

of Ξ-modulation may be calculated and used as the transfer functions of the electronic functional modules 84, 85 (e.g., see FIG. 37), and each of them may have two inputs for this. Each of linearization functions

$${\sum }_{j} {Λ}_{j}^{Ξ}$$

and

$${\sum }_{j} {Λ}_{j}^{Ξ}$$

may be two-dimensional (e.g., see FIG. 38). The linearization function

$${\sum }_{j} {Λ}_{j}^{Σ}$$

of the combined sum modulation nonlinearity may have definite value Λⱼ^{Σ} for each value of the linearization function Λⱼ^{Ξ} of the combined ratio modulation nonlinearity (and vice versa).

In a general case, Σ-modulation and/or Ξ-modulation may be characterized by the assemblage of various parameters. Some of them may relate to the main parameters, while the remaining ones may relate to the concomitant parameters. To account for the interaction of the corresponding Σ-modulation and/or Ξ-modulation parameters, joint calibration procedures may be used for all pairs of interacting parameters. As a result, the multidimensional functions of nonlinearity and the corresponding linearization functions of the Σ-modulation and/or Ξ-modulation may be calculated.

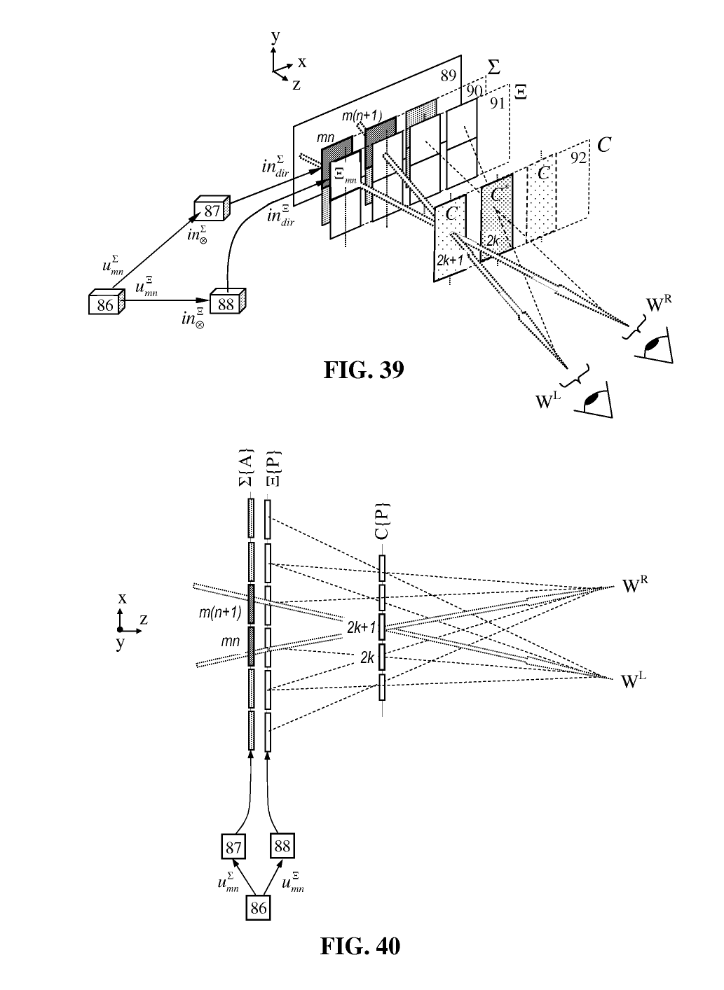

The first embodiment of the device for forming and observing stereo images with maximum resolution may comprise a stereo video signal source 86 (e.g., see FIG. 39), the first 87 and second 88 electronic functional modules, an optical source 89 and sequentially located on the same optical axis a sum optical modulator 90, that may be electrically addressed in M rows and N columns, a ratio optical modulator 91, that may be electrically addressed in M rows and N columns, a N column-addressed spatially-selective optical converter 92, that may be electrically addressed in N columns. The optical states of the working medium in adjacent (2k−1) and 2k columns of the ratio optical modulator 91 may be complementary. The N column-addressed spatially-selective optical converter 92 may have the first and second complementary states of the working medium between its adjacent (2i−1) and 2i columns. The aperture of an mn^{th} element of the sum optical modulator 90 may be optically coupled with an aperture of the mn^{th} element of the ratio optical modulator 91, wherein n=1, 2, . . . , N, m=1, 2, . . . , M, i=1, 2, . . . , N, k=1, 2, . . . , N.

The axis of symmetry of the left formation zone Z_{form}^{L} may be the common intersection line of the first group of N planes, wherein the first N/2 planes of the first group may pass through the axes of symmetry of the odd (2k−1) columns of the N column-addressed spatially-selective optical converter 92 and through the axes of symmetry of the even 2i columns of the electrically controlled ratio optical modulator 91, whereas the second N/2 planes of the first group may pass through the axes of symmetry of the even 2k columns of the N column-addressed spatially-selective optical converter 92 and through the axes of symmetry of the odd (2i−1) columns of the electrically controlled ratio optical modulator 91; and the axis of symmetry of the right formation zone Z_{form}^{R} may be the common intersection line of second group of N planes, wherein the first N/2 planes of the second group may pass through the axes of symmetry of the even 2k columns of the N column-addressed spatially-selective optical converter 92 and through the axes of symmetry of the even 2i columns of the electrically controlled ratio optical modulator 91, whereas the second N/2 planes of the second group may pass through the axes of symmetry of the odd (2k−1) columns of the N column-addressed spatially-selective optical converter 92 and through the axes of symmetry of the odd (2i−1) columns of the electrically controlled ratio optical modulator 91.

The transfer function T^{Σ} of first electronic functional module 87 may be the inverse function of the transfer function Φ^{ch}^{_{—}}¹ of the first optoelectronic channel:

T^{Σ}=F⁻¹{Φ^{ch}^{_{—}}¹}. (54)

The input the first optoelectronic channel may be the control input of the electrically controlled sum optical modulator 90. The output of the first optoelectronic channel may be either of the left or right formation zones Z_{form}^{L} or Z_{form}^{R}.

The first optoelectronic channel of the device may be by definition the optoelectronic channel for the sum modulation transmitting (e.g., see FIGS. 3 and 4). The transfer function Φ^{ch}^{_{—}}¹ of the first optoelectronic channel may be the values of the light intensity in either of the left Z_{form}^{L} or right Z_{form}^{R} formation zones, divided by the amplitude of the control signal at the input of electrically controlled sum optical modulator 90. So, the transfer function Φ^{ch}^{_{—}}¹ of the first optoelectronic channel may be equal to the calibration function Φ^{Σ} of the sum modulation which may be determined during the corresponding calibration procedure of the first optoelectronic channel. In accordance with it the transfer function T^{Σ} of first electronic functional module 87 may be equal to the linearization function Λ^{Σ} of the sum modulation.

The transfer function T^{Ξ} of second electronic functional module 88 may be the inverse function of the transfer function Φ^{ch}^{_{—}}² of the second optoelectronic channel:

T^{Ξ}=F⁻¹{Φ^{ch}^{_{—}}²}. (55)

The input of the second optoelectronic channel may be the control input of the electrically controlled ratio modulator 91. The outputs of the second optoelectronic channel may be both left and right formation zones Z_{form}^{L} and Z_{form}^{R}. The second optoelectronic channel of the device may be by definition the optoelectronic channel for the ratio modulation transmitting (e.g., see FIGS. 3 and 4). The transfer function Φ^{ch}^{_{—}}² of the second optoelectronic channel may be the ratio of the values of the light intensity in the left Z_{form}^{L} formation zone to the light intensity in right Z_{form}^{R} formation zones, divided by the amplitude of the control signal at the input of the electrically controlled ratio optical modulator 91. So, the transfer function Φ^{ch}^{_{—}}² of the second optoelectronic channel may be equal to the calibration function Φ^{Ξ} of the ratio modulation which may be determined during the corresponding calibration procedure of the second optoelectronic channel. In accordance with one aspect of the present invention, the transfer function T^{Ξ} of the second electronic functional module 88 may be equal to the linearization function Λ^{Ξ} of the ratio modulation.

The characteristic (function) of transition between two arbitrary complementary optical states may be characterized by a single value of function for each value of the argument.

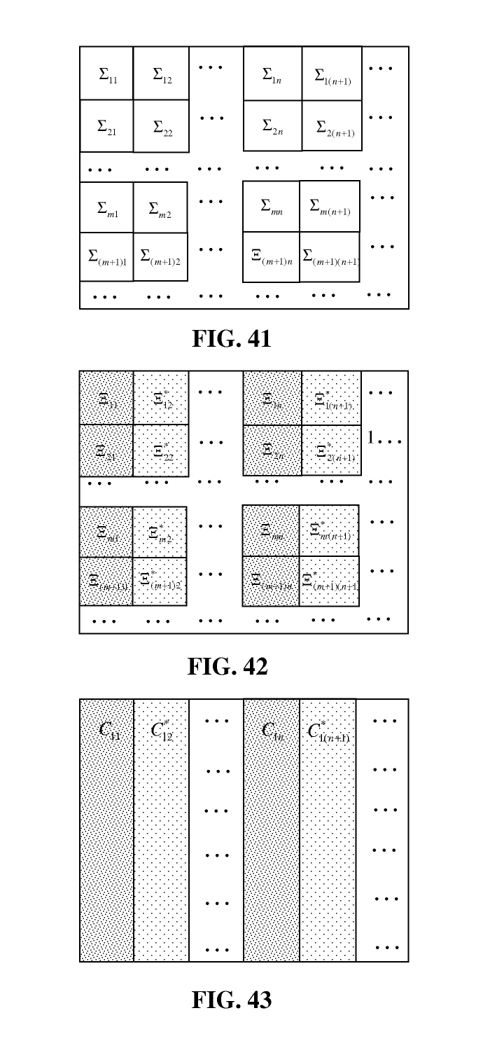

The initial optical state of the working medium of the sum optical modulator 90 may be the same for its each element Σₘₙ (e.g., see FIG. 41). The initial states of the working medium of the ratio optical modulator may be complementary in adjacent columns n and (n+1), which contain, for example, elements Ξₘₙ and Ξₘₙ₍ₙ₊₁₎* (e.g., see FIG. 42), and in adjacent columns C₁ₙ and C₁₍ₙ₊₁₎* of the N column-addressed spatially-selective optical converter 92 (e.g., see FIG. 43).

The first embodiment of the device operates according with the corresponding embodiment of the method. The first calibration function Φ₍₁₎^{Σ} of the sum modulation nonlinearity may be equal to the transfer function Φ^{ch}^{_{—}}¹ of the first optoelectronic channel. The first linearization function Λ₍₁₎^{Σ} of the sum modulation may be equal to the transfer function T^{Σ} of electronic functional module 87. The first calibration function Φ₍₁₎^{Ξ} of the ratio modulation nonlinearity may be equal to the transfer function Φ^{ch}^{_{—}}² of the second optoelectronic channel. The first linearization function Λ₍₁₎^{Ξ} of ratio modulation may be the transfer function T^{Ξ} of the electronic functional module 87.

The linearization procedure of transfer functions of the first and second optoelectronic channels of the device may be implemented in accordance with the graphic dependences, represented in FIGS. 10, 11, 13 and 14, with the schematic diagram shown in FIG. 18 and with a diagram for calculating linearization functions according to the example shown in FIG. 9. The linearized device may operate in accordance with expressions (26), (27). So, the desired separation of the stereo image views may be followed in accordance with expression (20).

The optical state S of the working medium may be described by a generalized complex function of the form:

S=Kexp(−iΘ), (56)

where K may be real-amplitude transmission (absorption) coefficient, Θ may be the generalized phase. The physical meaning of Θ may be determined by the chosen optical characteristic of the working medium which may be responsible for forming the transfer function of the optoelectronic channel of the device. Two complementary optical states may be mutually opposite, and in each specific case it may take the concrete form. In one case, two complementary optical states of the working medium (initial state S and complementary state S*) may correspond to two complex conjugate values of function (56), where S*=Kexp (iΘ). But complementary properties may be caused not only by mutually opposite signs of generalized phase Θ, but may be presented by two extreme values of real amplitude transmission coefficient K. In case of variations of the real-amplitude transmission coefficient only (if the generalized phase Θ may be equal to 0), two complementary optical states may correspond to maximum and minimum values K of optical transmission. For example, the maximum value of the real-amplitude absorption coefficient of the light flux may be complementary to its minimum (zero) value when using polarization converters (analyzers) with mutually orthogonal polarization characteristics. The value of K may be spectrally dependent (be a function of the light wavelength λ) or dependent on the value of angle to the normal of the surface of the sum optical modulator 90 or the ratio optical modulator 91 (for an angle-selective working medium). In case of optically anisotropic working medium, when Θ=2πδ, wherein δ may be the phase delay between ordinary and extraordinary rays, two complementary optical states may correspond to two δ values, which may differ by π/2. In case of optically active medium Θ_{φ}=φ, wherein φ may be the angle of optical activity, change of optical state may correspond to a change of the angular position of the polarization state (described by plane polarization or elliptic polarization). Two complementary optical states may correspond to two values of φ that differ by 90°. In case of working medium with controlled optical thickness the generalized phase Θ_{d,λ}=2λdn/λ, wherein d may be the physical thickness value, n may be the refractive index value of the working medium. In case of linear polarization the complementary values of the anisotropic optical thickness of the ratio optical modulator may be the thickness values corresponding to zero and 180° (differing by the value π) initial phase shifts between ordinary and extraordinary rays in the working medium. In case of circular polarization a ratio modulation implementation may correspond to zero and 90° (π/2) values of initial phase shift of light polarization between the formation windows. Any values that may be multiples of the phase shift by the value of 2π, may be algebraically added to the phase shift values in all cases without affecting the resulting complementary optical states.

The sum optical modulator, ratio optical modulator and optical converter may be mutually interchanged in the method and device along the direction of propagation of the light flux (along the optical axis of the device). In the corresponding particular embodiments the operations of the sum modulating, ratio modulating and optical conversion (spatial selection) of spatial optical signals may be invariant relative to the interchanging owing to universality of the calibration procedures of linearization of optoelectronic channels.

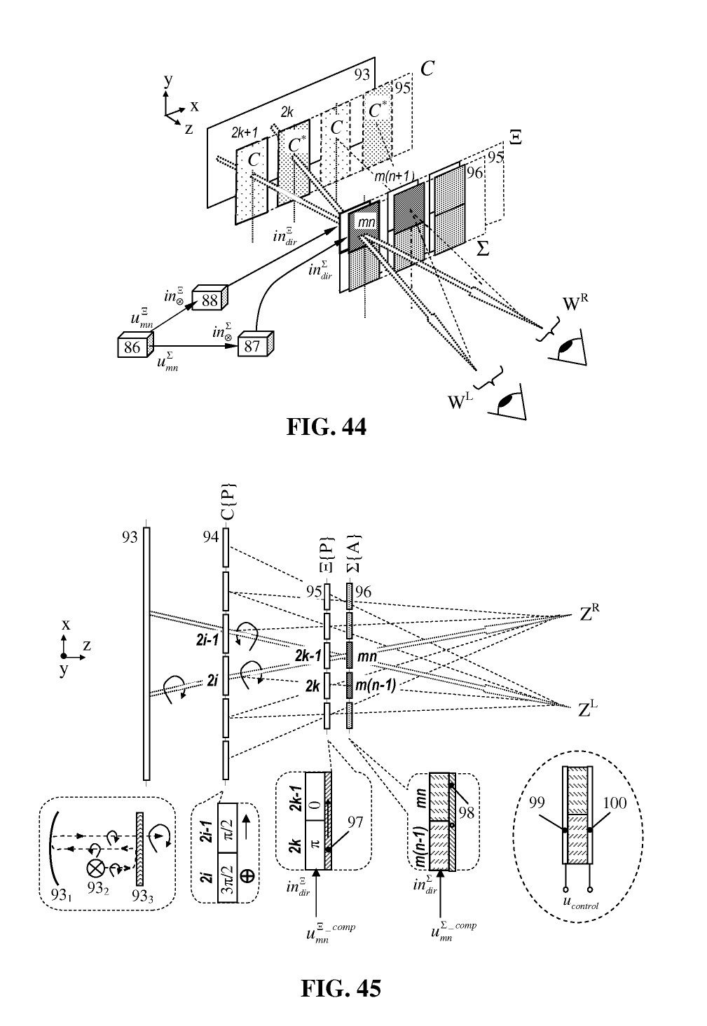

The second embodiment of the device (characterized by inversed order of arrangement of the optical components in comparison with the first embodiment of the device) may comprise sequentially arranged along the optical axis an optical source 93 (e.g., see FIGS. 44 and 45), a N column-addressed spatially-selective optical converter 94, a ratio optical modulator 95 and a sum optical modulator 96. The optical source 93 may be in the form of sequentially arranged a parabolic reflector 93₁, a point light source 93₂, located in the focus of the parabolic reflector 93₁, and a transmissive-reflective (transflective) layer 93₃ of cholesteric LC with circular twisting of molecules. The working medium of the N column-addressed spatially-selective optical converter 94 may be an electrically addressable birefringent LC layer with phase delay values of π/2 and 3π/2 in adjacent (2i−1) and 2i columns respectively. The working medium of the ratio optical modulator 95 may be an electrically addressable layer with phase delay values of 0 and π in the adjacent (2k−1) and 2k columns. This layer may be adjacent to the first linear polarizer 97. The working medium of a sum optical modulator 96 may be an electrically addressable 90°-twisting LC layer. This layer may be adjacent to the second linear polarizer 98, which polarization direction may be orthogonal to the polarization direction of the first linear polarizer 97. Each of two electrically addressable LC layers may be arranged between two transparent electrodes 99, 100. A voltage LC u_{control} may be applied to these electrodes to control the optical state of a layer.

The device may work as follows. The optical source 93 may produce a circularly polarized light wave (for example, with left hand rotation of the polarization plane). The considered implementation of optical source 93 may allow close to 100% efficiency of conversion of not polarized light (emanating from the point source 93₂) into circularly polarized light. For the definiteness the transflective layer 93₃ of the cholesteric LC may pass only the left hand circularly polarized component of the light flux. The remaining components of the light flux may be reflected from the layer 93₃ of the cholesteric LC back to reflector 93₁. After reflection from the reflector 93₁ the original direction of circulation of light may be reversed. So, the iterative procedure of conversion of not polarized light into left hand circular light with a small absorption of its energy may take place. After passing through the N column-addressed spatially-selective optical converter 94, the left hand circular polarized light wave may be split into N light beams. Any pair of adjacent 2i and 2i−1 light beams (passing through 2i and 2i−1 columns of the N column-addressed spatially-selective optical converter 94 respectively) may be characterized by mutually orthogonal directions of the polarization vector of the light wave. The orthogonality of two directions of polarization may be caused by π/2 and 3π/2 phase shifts between ordinary and extraordinary rays in the adjacent (2i and 2i−1) column segments of the working medium. In the initial state, the working medium of the ratio optical modulator 95 may be characterized by phase shift values 0 and π in the adjacent segments corresponding to columns 2k−1 and 2k. Therefore, in the initial state of the device the sum optical modulator 96 may be opened as its working medium layer in all of its mn^{th} elements ensures 90°-twist of the linear polarization plane of the passed through light wave, when zero control voltage may be at the control input in_{dir}^{Σ}. The left formation zone Z_{form}^{L} may receive the light fluxes passed through the columns (2i−1) of the N column-addressed spatially-selective optical converter 94 and through the columns (2k−1) of the ratio optical modulator 95. Also, the left formation zone Z_{form}^{L} may receive the light fluxes passed through the columns 2i of the N column-addressed spatially-selective optical converter 94 and through the columns 2k of the ratio optical modulator 95. All these beams may be passed through because the light linear polarization may be parallel with the polarization axis linear polarizer 97 for all considered optical paths. In the initial state of the device, the light beams may not get in the right formation zone Z_{form}^{R}. For all combinations of i and k, corresponding to the optical paths leading to the right formation zone Z_{form}^{R}, the polarization of the passed through light beam may be orthogonal to the direction of the polarization axis of linear polarizer 97. When a calibration electronic signal u_{calib}_{_{—}}ₗᵢₙ^{Ξ} (which amplitude may be linearly increased from 0 to the maximum value) may be applied to the control input in_{dir}^{Ξ} of the ratio optical modulator 95, a light intensity reduction (up to complete extinction) may occur in the left formation window Z_{form}^{L}. Also, the corresponding light intensity increase (up to the maximum value) may occur in the right formation window Z_{form}^{R}. This may be a result of changing phase delay values in the segments of the working medium of the ratio optical modulator 95 (changing π→2π=0 for a column 2k and changing 0→π for a column 2k−1). This means that the ratio optical modulator 95 may be the difference-effect optical modulator for implementing the ratio modulation whereas a ratio compensating signal comp uₘₙ^{Ξ}^{_{—}}^{comp} may be applied to the control input in_{dir}^{Ξ} of ratio optical modulator 95. Before this the calibration procedure may be implemented for the ratio modulation corresponding to calibration procedure for the first optoelectronic channel which input may be the control input in_{dir}^{Ξ} of ratio optical modulator 95, and the outputs of the first optoelectronic channel may be both formation zones. The schematic diagrams shown in FIGS. 16-18 illustrate the required calibration procedure. The expressions (26), (27) may be used for calculating the transfer function T^{Σ}, which may be the inverse function of the nonlinearity function Φ^{ch}^{_{—}}¹ of the first optoelectronic channel with substitution of the function Φ^{ch}^{_{—}}¹ instead of the function Φ^{Σ}. The result may be the transfer function T^{Σ} (instead of the linearization function Λ^{Σ}).

When applying the calibration electronic signal u_{calib}_{_{—}}ₗᵢₙ^{Ξ} to the control input in_{dir}^{Σ} of the sum optical modulator 96, the latter may operate as a uniform-effect modulator causing identical (having the same sign and value) variations in the light flux intensity in both formation windows. Analogously, the linearization function of the second optoelectronic channel may be determined in accordance with expressions (28), (29), where the function Φ^{ch}^{_{—}}² may be substituted instead of nonlinearity function Φ^{Ξ}. Then, the result of calculating may be the transfer function T^{Ξ} instead of linearization function Λ^{Σ}. A sum modulation may be implemented when the electronic compensating signal uₘₙ^{Σ}^{_{—}}^{comp} may be applied to the control input in_{dir}^{Σ} of the sum optical modulator 96.

A color stereo image may be realized in the method and the device if to create a spatial triad of adjacent color image elements R, G, B in each mn^{th} element of the sum or ratio optical modulators. Each color pixel may have individual matrix addressing (triple number of address columns may be used in each of matrix-addressed optical modulators in comparison with a black and white image). The calibration procedures may be the same as the case of black-and-white images.

Concrete examples of the implementation of the sum optical modulator, ratio optical modulator and optical converters in the method and device (in their particular embodiments) may be determined essentially by the type and structure of the working medium.

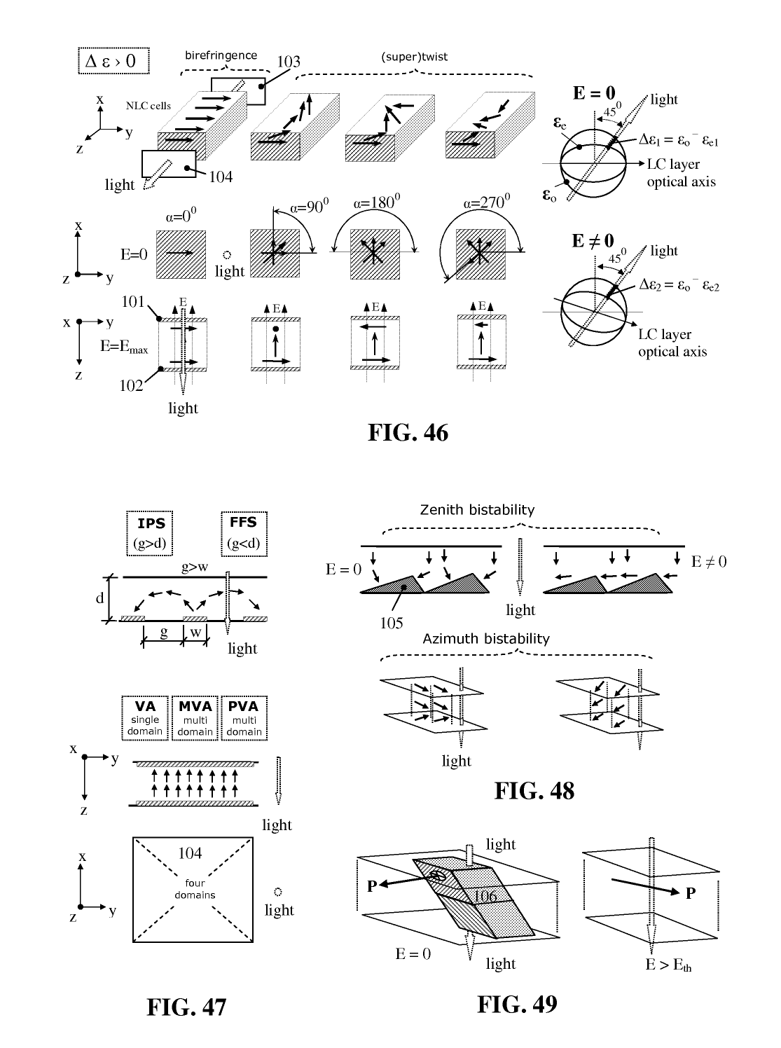

It may be preferable to use LC material as the working medium. On this basis, it may be possible to implement all optical components in the method and device. Such a solution also allows to mutually compensate a chromatic dispersion of LC media (leading to corresponding increase in the dynamic range of the stereo image) in mutually mirror-symmetric LC structures. The most useful working medium in LC imaging matrices may be a nematic LC material. It allows to implement the electrically controlled birefringent (with ECB effect) structures (S-, B-cells) [e.g., see Ref. 3] or optically active (twist- or T-cells, super-twist cells) structures with different twist angles α, in which the electrically controlled optical activity (ECOA) effect may be used. The LC media with positive sign of dielectric anisotropy (Δ∈>0) may be implemented as homogeneously oriented structures (e.g., see FIG. 46). In such structures, LC molecules may be initially oriented (at zero strength E of the control electric field) along the plane of the LC layer, wherein Δ∈=∈ₑ=∈ₒ, wherein ∈ₑ and ∈ₒ may be the dielectric permeability of the LC layer for extraordinary and ordinary rays. The change of the strength E of the control electric field may be caused by application of control voltage u_{control} to transparent electrodes 101, 102. In case of the ECB effect, such control may cause the change of the Δ∈ value, leading to phase or polarization modulation (depending on the orientation of input polarizer 103) of the light flux passing through an nematic LC cell. In case of polarization modulation, the latter may be converted into light intensity variations after passing through the polarization analyzer 104. In case of the ECOA effect, such control may cause the rotation of the polarization plane, and the most useful initial rotation values may be 90°, 180°, 270°. In case of the ECB effect, the initial and final rotation angles may be always equal to 0. The main disadvantage of LC cells with the ECB effect may not be sufficient contrast of image (no more than 30-40:1) because of chromatic dispersion of LC material. The main disadvantage of LC cells with ECOA may be small viewing angles (drop in image contrast for the viewing field angles over)20-30°. To obtain a high contrast (several hundred to one) image in combination with wide viewing angles (up to 120° and more), the complicated LC structures [e.g., see Ref. 4] with homogeneous orientation may be used (e.g., see FIG. 47). Such ones may be IPS (in-plane switching), FFS (fringe-field switching) with Δ∈>0, or homeotropic structures with vertical alignment of LC molecules (VA-structures). The VA structures may be characterized by negative sign of dielectric anisotropy (Δ∈<0). The modifications of VA structures may be poly-domain structures with vertical orientation (MVA—multi-domain VA), PVA (protrusion-type VA), where several variously oriented domains may correspond to one element of LC structure. Each domain may ensure the required angular characteristic of representation in own solid angle. In all these nematic LC structures, the different combinations of ECB and ECOA effects may be used, controlled by complex configurations of the electric field lines E. Besides the analog structures, the bistable (multi-stable) LC structures may also be used. For example, effects of zenithal and azimuthal bistability (e.g., see FIG. 48) may be caused by the appropriate form to one of control electrodes 105. It may lead to the appearance of two or more low energy levels (equally favorable in energy) for several configurations of LC molecules within one layer. It allows having the different discrete configurations of the LC layer by applying a required control voltage. The flexoelectric effect may be used in surface-stabilized LC layers on the asymmetric surface of control electrode 105. One of most promising bistable LC structures may be a ferroelectric LC structure (e.g., see FIG. 49), that may be characterized by spontaneous polarization. The smectic-C*LC structure may have chiral layers of LC molecules, in which the LC director (direction of preferred orientation of LC layer) may be inclined to the planes of layers. It finally creates reflecting and twisting asymmetry in LC layers, leading to appearance of spontaneous polarization and to formation of LC domains 106 with definite polarization direction P. A control voltage change above the threshold value (E>Eₜₕ) may produce a sharp change in the polarization direction P.

The linear polarizer 103 and the polarization analyzer 104 may be implemented within the LC layer, for example, in the form of a thin crystalline film [e.g., see Ref. 6], or with use of polarizing lyotropic LC [e.g., see Ref. 7].

In the absence of the polarization analyzer 104, all the considered analog LC structures may be used as the base cells for phase-polarization ratio modulation, for example, in the first, second and fifth embodiments of the method and for realization of the optical converter in the first and second embodiments of the device. A bistable ferroelectric LC structure may be used for implementing a pulse-width optical ratio modulation in the fifth embodiment of the method. In this case, the switching speeds may be orders of microseconds or tens of microseconds and operating switching frequencies may be about kHz or tens of kHz. This provides (with a reserve) a flicker-less fused perception of stereo images by a human vision.

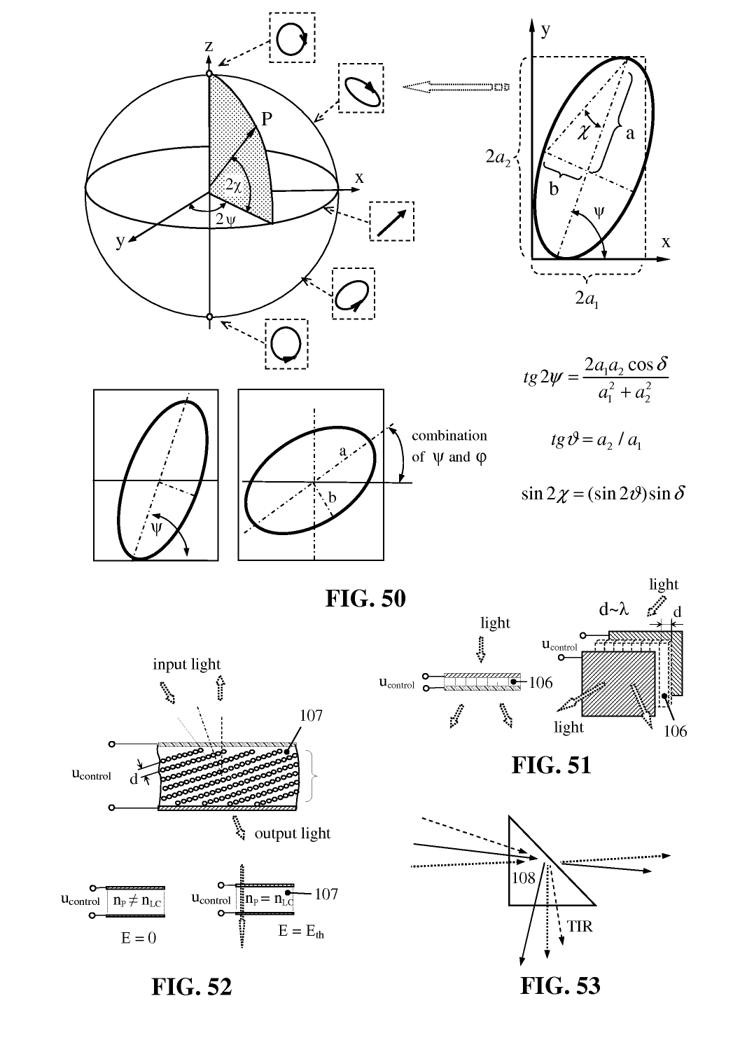

The result of the influence of any (arbitrary complex) anisotropic optical structure on the light wave may be possible to describe by influence of a combination of equivalent optical activity plate and phase shift plate. These phase plate and optical activity plate may be characterized by arbitrary orientations of optical axes and by arbitrary values of optical delay and optical activity angle. All possible polarization values of the passing through light flux may be determined geometrically on a Poincaré sphere [e.g., see Ref. 5]. The Poincaré sphere may show all possible orientations of a polarization ellipse (e.g., see FIG. 50). The ellipticity χ of the polarization ellipse may be determined only by the value of the equivalent phase shift δ. The angular orientation of the polarization ellipse may be determined by the combination of the values of the angles ψ and φ. The angle ψ may be determined by the equivalent value of the phase shift δ. The value of φ may be determined by the degree of equivalent optical activity.

Therefore, the invention may be applicable to all possible birefringent and optically active (including LC) structures using as phase-polarization modulators for implementing the ratio modulation. Optical anisotropic compensation films with required spectral and diffraction characteristics may allow expanding the angular field of view and to improve image contrast due to compensation of the dispersion of the refractive index gradient of the LC medium. Thereby the birefringent optical elements with focusing properties may be used (for example, polarization micro lenses). It allows adjusting the position of the observation zones along the z axis. In this case, the electric field gradient along the boundary of the transparent electrode may be used for adjusting the focal length. The latter may be done by adjusting the refractive index and the optical thickness of the layer of working medium. During the calibration procedures, the diffraction and spectral characteristic of optical compensation films and the refraction properties of the focusing optical layer (distribution of refractive index along the layer) may be automatically taken in account.

Any of the considered LC structures may be used (if the polarization analyzer 104 may be present) for implementing a real-amplitude (direct) sum modulation in the method and device. But, the presence of the polarizer 103 (necessary for the proper functioning of the considered single-crystal LC structures) may lead to a 50% loss of light energy in case of not polarized light wave source. To implement a polaroid-less real-amplitude light modulation it may be possible to use, for example, an electrically controlled LC grating 107 (e.g., see FIG. 51) with a period d, comparable with the light wavelength λ. Such grating may be characterized by a variable scattering coefficient of light flux in a direction orthogonal to the LC layer surface. In particular, the different kinds of LC medium dispersed in polymeric matrices PDLC (polymer-dispersed liquid crystal) may be used for this purpose. The drops of LC material may be impregnated in the polymer layer 108 (e.g., see FIG. 52) to form a controlled diffraction grating. It may scatter the light at zero control voltage u_{control} and may pass through the light at the control voltage value, corresponding to matching the refractive index n_{LC} of the LC medium and the refractive index of the polymer material. Such LC structures may be used for implementation of the sum modulation in all the embodiments of the method and device wherein the concomitant sum modulation may be absent. For implementing a direct ratio modulation in the form of intensity variations (as the difference-effect optical modulator), a beam-splitting optical element 109 (e.g., see FIG. 53) may be used. A polarized or not polarized input light beam may be directed on the face of the beam-splitting optical element 109 at different angles up to achievement of the total internal reflection (TIR). The reflected and transmitted light beams may be formed at the outputs of the beam-splitting optical element 109 as result of a combination of the refractive and reflective effects. Total intensity of both output beams, in the first approximation, may be equal to the intensity of the input light beam. The difference between intensity values of two output beams may be determined by the angle of incidence of the input light beam to the face of the beam-splitting optical element 109 [e.g., see Ref. 5].

The role of optical converters (including optical spatially-selective converters) in case of the direct sum and/or ratio modulation may be to pass through without change the corresponding sum component and/or the ratio component of light flux intensity. Also, optical converters may allow setting limits of the dynamic range of image brightness change or to correct the intermediate light intensity values to reach the monotonic behavior of transfer characteristics.

To increase the optical efficiency, a polaroid-less LC structure with the “guest-host” effect also may be used. In such a structure, the light intensity modulation may be implemented due to direct light absorption by dichroic dye molecules, introduced in the LC layer. The orientation of the dichroic dye molecules (and, correspondingly, the real-amplitude transmission coefficient of the light flux) may be changed due to changing the orientation of LC molecules under influence of the control electric field. This type of working medium may create concomitant polarization modulation, and may be used, for example, in the six and seventh embodiments of the method.

Variable real-amplitude transmission coefficient K may also be obtained, for example, using dynamic scattering effect in LC, electrowetting effect or electrochromic effect or using another electrically initiated optical effects. It may also be possible to use various light-generating matrix structures as the real-amplitude sum modulators, functionally combined with the optical source. Such ones may be, for example, any plasma- or light-emitting-diode (including OLED—organic light-emitting diode) panels.

In the second embodiment of the method, the sum and ratio optical modulators and the optical converter may be implemented with use of comb optical analyzers in the form of different interference, diffraction, holographic structures, electro-photo-chromic materials, photonic crystals (optical structures with a periodic change of dielectric constant along the optical axis). The line (discrete) spectrum of light flux may be obtained, for example, using a multilayer interference analyzer as a part of a light flux source. Deposited multilayer interference analyzers may also be the examples of concrete implementation of a comb spectral analyzer. Using a line optical spectrum with spectral line width of several tens of nanometers makes it possible to attain normal brightness and color reproduction of stereo images.

In the fourth embodiment of the method, the sum and ratio optical modulators may be in the form of volume or surface acoustooptic modulators. The louver optical converter may be in the form of three-dimensional holographic gratings (including polarization holographic ones), or in the form of micro structures implemented by the method of the routed spraying.

The working medium of optical modulators may have a composite layer structure, which may include adjacent layers of different types or a mixture of working mediums of different types in one layer. Thereby the optical compensation layers may be used in the optical structure either of the sum or ratio optical modulators, and also in the structure of the optical converter (spatially-selective optical converter). Such optical compensation allows achieving the maximum viewing angle and/or maximum dynamic range in the formed image. According to one aspect of the present invention, all the properties of the optical compensating layers may be automatically taken in account during the linearization calibration procedure. So, any possible nonlinearity function of any of the layers may be automatically included in the general nonlinearity function of the optoelectronic channels.

For implementation of the present invention, it may be possible to use any physically realizable optical structure with two or more complementary optical states with transition function between them describing by an arbitrary unambiguous physically realizable function.

The control, information, calibration signals and matrix addressing signals may be not only the electronic ones. They may be the signals of other physical nature. To obtain a signal of the required physical nature, it may be sufficient to use a corresponding converter of the signal.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of forming and observing stereo images with maximum spatial resolution, comprising:
receiving a light wave from an optical source;
providing the first optical modulator, which is matrix-addressed in M rows and N columns, for modulating an intensity or polarization or propagation direction or divergence angle or convergence angle or spectrum or phase or a combination of the said characteristics of the light wave to implement a sum modulation of the light wave in the mn^{th} element of the first optical modulator in accordance with the sum of the values Bₘₙ^{L} and Bₘₙ^{R} of brightness of mn^{th} elements of images of left and right views, wherein n=1, 2, . . . , N, m=1, 2, . . . , M;
providing the second optical modulator, which is matrix-addressed in M rows and N columns, for modulating an intensity or polarization or propagation direction or divergence angle or convergence angle or spectrum or phase or a combination of the said characteristics of the light wave to implement a ratio modulation of the light wave in the mn^{th} element of the second optical modulator in accordance with functions of algebraic relations between values Bₘₙ^{L} and Bₘₙ^{R} of brightness of mn^{th} elements of images of the left and right views;
whereas applying to the control input of the first optical modulator a sum compensating signal sₘₙ^{Σ}^{_{—}}^{comp} which amplitude is directly proportional to the linearization function Λ^{Σ} of the sum modulation;
applying to the control input of the second optical modulator a ratio compensating signal sₘₙ^{Ξ}^{_{—}}^{comp} which amplitude is directly proportional to the linearization function Λ^{Ξ} of the ratio modulation;
providing the first and second optical converters with complementary optical conversion parameters for converting the corresponding light modulation characteristic into light intensity modulation to form the first and second light fluxes in the left W_{form}^{L} and right W_{form}^{R} formation windows, wherein the intensity values Jₘₙ^{L} and Jₘₙ^{R} are equal to the values Bₘₙ^{L} and Bₘₙ^{R} of brightness of mn^{th} elements of images of the left and right views respectively; and
observing left and right views of the stereo image in the left W_{V}^{L} and right W_{V}^{R} observation windows, which are optically coupled with the left W_{form}^{L} and right W_{form}^{R} formation windows respectively.

2. The method of claim 1, wherein:
applying the first sum compensating signal s₍₁₎ₘₙ^{Σ}^{_{—}}^{comp} which amplitude s₍₁₎ₘₙ^{Σ}^{_{—}}^{comp}≈Λ₍₁₎^{Σ}{Bₘₙ^{L}+Bₘₙ^{R}} is directly proportional to the first linearization function Λ₍₁₎^{Σ} of the sum modulation, taken from the sum Bₘₙ^{L}+Bₘₙ^{R}; or
applying the second compensating sum signal s₍₂₎ₘₙ^{Σ}^{_{—}}^{comp}, which amplitude s₍₂₎ₘₙ^{Σ}^{_{—}}^{comp}≈(Bₘₙ^{L}+Bₘₙ^{R})·Λ₍₂₎^{Σ} is directly to the product of the sum Bₘₙ^{L}+Bₘₙ^{R} into the second linearization function Λ₍₂₎^{Σ} of the sum modulation; and
applying the first ratio compensating signal s₍₁₎ₘₙ^{Ξ}^{_{—}}^{comp}, which amplitude s₍₁₎ₘₙ^{Ξ}^{_{—}}^{comp}≈Λ₍₁₎^{Ξ}{Bₘₙ^{L}/Bₘₙ^{R}} is directly proportional to the first linearization function Λ₍₁₎^{Ξ} of the ratio modulation, taken from the ratio Bₘₙ^{L}/Bₘₙ^{R}; or
applying the second ratio compensating signal s₍₂₎ₘₙ^{Ξ}^{_{—}}^{comp}, which amplitude s₍₂₎ₘₙ^{Ξ}^{_{—}}^{comp}≈(Bₘₙ^{L}/Bₘₙ^{R})·Λ₍₂₎^{Ξ} is directly proportional to the product of the ratio Bₘₙ^{L}/Bₘₙ^{R} into the second linearization function Λ₍₂₎^{Ξ} of the ratio modulation;
whereas the first linearization function Λ₍₁₎^{Σ} of the sum modulation is the inverse function Λ₍₁₎^{Σ}=F⁻¹{Φ₍₁₎^{Σ}} of the first calibration function Φ₍₁₎^{Σ} of the sum modulation nonlinearity; or
the second linearization function Λ₍₂₎^{Σ} of the sum modulation is the reciprocal function Λ₍₂₎^{Ξ}=F^{reciprocal}{Φ₍₂₎^{Ξ}}=1/Φ₍₂₎^{Ξ} of the second calibration function Φ₍₂₎^{Σ} of the sum modulation nonlinearity; and
the first linearization function Λ₍₁₎^{Ξ} of ratio modulation is the inverse function Λ₍₁₎^{Ξ}=F⁻¹{(Φ₍₁₎^{Ξ}} of the first calibration function Φ₍₁₎^{Ξ} of the ratio modulation nonlinearity; or
the second linearization function Λ₍₂₎^{Ξ} of the ratio modulation is the reciprocal function Λ₍₂₎^{Ξ}=F^{reciprocal}{Φ₍₂₎^{Ξ}}=1/Φ₍₂₎^{Ξ} of the second calibration function Φ₍₂₎^{Ξ} of the ratio modulation.

3. The method of claim 1, further comprising:
applying a linearly-varying calibration signal s_{calib}_{_{—}}ₗᵢₙ^{Σ} of the sum modulation to the control input of the first optical modulator;
whereas determining the first calibration function Φ₍₁₎^{Σ} of the sum modulation nonlinearity as the assemblage Φ₍₁₎^{Σ}=J_{calib}^{Σ} of the calibration values of the ratio component J_{calib}^{Σ} of the light flux intensity in either of the formation windows, or
applying a monotonically-varying calibration signal s_{calib}^{Σ} of sum modulation to the control input of the first optical modulator; whereas determining the second calibration function Φ₍₂₎^{Σ} of the sum modulation as the ratio Φ₍₁₎^{Σ}≦J_{calib}^{Σ}/s_{calib}^{Σ} of the sequence of calibration values of the sum component J_{calib}^{Σ} of the light flux intensity in either of the formation windows to the sequence of the corresponding values of the corresponding values of the monotonically-varying calibration signal s_{calib}^{Σ}; and
applying a linearly-varying calibration signal s_{calib}_{_{—}}ₗᵢₙ^{Ξ} of the ratio modulation to the control input of the second optical modulator;
whereas determining the first calibration function Φ₍₁₎^{Ξ} of the ratio modulation as the ratio Φ₍₁₎^{Ξ}≈J_{calib}^{Ξ(L)}/J_{calib}^{Ξ(R)} of the sequence of the calibration values of the ratio component J_{calib}^{Ξ(L)} of the light flux intensity in the left formation window to the sequence of the calibration values of the ratio component J_{calib}^{Ξ(R)} of the light flux in the right formation window, or
applying a monotonically-varying calibration signal s_{calib}^{Ξ} of the ratio modulation to the control input of the second optical modulator; whereas determining the second calibration function Φ₍₂₎^{Ξ} of the ratio modulation as the ratio
$${Φ}_{( 2 )}^{Ξ} = \frac{{J}_{calib}^{Ξ ( L )} / {J}_{calib}^{Ξ ( R )}}{{s}_{calib}^{Ξ}}$$
of the sequence of the calibration values of the ratio component J_{calib}^{Ξ(L)} of the light flux intensity in the left formation window to the sequence of the calibration values of the ratio component J_{calib}^{Ξ(R)} of the light flux intensity in the right formation window, divided by the sequence of the corresponding values of the amplitude of the monotonically-varying calibration signal s_{calib}^{Ξ} of the ratio modulation.

4. The method of claim 1, wherein the linearization function Λ^{Σ} of the sum modulation depends on the ratio signal; and/or
the linearization function Λ^{Ξ} of the ratio modulation depends on the sum signal.

5. The method of claim 1, further comprising:
modulating the light flux intensity to implement a real-valued sum modulation;
modulating the polarization of the light flux to implement a polarization ratio modulation; and
providing the first and second polarization analyzers with complementary polarization parameters to convert the polarization ratio modulation of the light flux into corresponding component of light flux intensity.

6. The method of claim 1, further comprising:
modulating the light flux intensity to implement a real-valued sum modulation;
providing optical spectral modulator tunable from the first spectrum to the second spectrum to implement a spectral ratio modulation; and
providing the first and second optical spectral analyzers with the first and second spectral characteristics to convert the ratio spectral modulation of the light flux into the corresponding component of the light flux intensity.

7. The method of claim 1, further comprising:
receiving a collimated light flux;
changing a deflection angle of the light flux in the first transverse direction to implement a sum diffraction modulation;
changing a deflection angle of the light flux in the second transverse direction to implement a ratio diffraction modulation; and
providing a louver optical analyzer, that is asymmetric in two mutually orthogonal transverse directions, to separate the sum diffraction modulation component of the light flux in the first transverse direction and the ratio diffraction modulation of the light flux in the second transverse direction.

8. The method of claim 1, further comprising:
providing an analog modulation of the light flux intensity to implement an analog sum modulation;
providing a bistable polarization modulation of the light flux to implement a ratio bistable modulation; and
providing the first and second polarizators with complementary polarization states for converting the bistable ratio modulation of the light flux into the corresponding bistable variations of the light flux, whereas
the first linearization functions Λ_{(1)Bi}^{Ξ}^{_{—}}^{P} of the bistable polarization ratio modulation is equal to the inverse function Λ_{(1)Bi}^{Ξ}^{_{—}}^{P}≈F⁻¹{Φ_{(1)Bi}^{Ξ}^{_{—}}^{P}} of the first nonlinearity function Φ_{(1)Bi}^{Ξ}^{_{—}}^{P} of the bistable polarization ratio modulation;
the second linearization function Λ_{(2)Bi}^{Ξ}^{_{—}}^{P} of the bistable polarization ratio modulation is equal to the reciprocal function Λ_{(2)Bi}^{Ξ}^{_{—}}^{P}(u)≈1/Φ_{(2)Bi}^{Ξ}^{_{—}}^{P}(u) of the second nonlinearity function Φ_{(2)Bi}^{Ξ}^{_{—}}^{P P} of the bistable polarization ratio modulation.

9. The method of claim 8, further comprising:
applying a calibration pulse-width signal u_{calib}_{_{—}}ₗᵢₙ_{_{—}}_{Bi}^{Ξ}^{_{—}}^{P} with linearly-varying width of pulses to the control input of the bistable polarization modulator,
determining the first calibration function Φ_{(1)Bi}^{Ξ}^{_{—}}^{P} of the polarization bistable ratio modulation nonlinearity as the ratio Φ_{(1)Bi}^{Ξ}^{_{—}}^{P}(u)≈\tilde{J}_{calib}_{_{—}}_{Bi}^{Ξ}^{_{—}}^{P(L)}(u)/\tilde{J}_{calib}_{_{—}}_{Bi}^{Ξ}^{_{—}}^{P(R)}(u) of the sequence of time-averaged calibration values of the ratio component \tilde{J}_{calib}_{_{—}}_{Bi}^{Ξ}^{_{—}}^{P(L)}(u) of the light flux intensity in the left formation window to the sequence of time-averaged calibration values of the ratio component \tilde{J}_{calib}_{_{—}}_{Bi}^{Ξ}^{_{—}}^{P(R)}(u) of the light flux intensity in the right formation window; and
determining the second calibration function Λ_{(2)Bi}^{Ξ}^{_{—}}^{P} of the polarization bistable ratio modulation nonlinearity as the reciprocal function Λ_{(2)Bi}^{Ξ}^{_{—}}^{P}(u)≈1/Φ_{(2)Bi}^{Ξ}^{_{—}}^{P}(u) of the second bistable polarization nonlinearity function Φ_{(2)Bi}^{Ξ}^{_{—}}^{P}, wherein Φ_{(2)Bi}^{Ξ}^{_{—}}^{P} is the ratio of the sequence of time-averaged calibration values of the ratio component \tilde{J}_{calib}_{_{—}}_{Bi}^{Ξ}^{_{—}}^{P(L)(u) of the luminous flux intensity in the left formation window to the sequence of time-averaged calibration values of the ratio component \tilde{J}}_{calib}_{_{Bi}}^{Ξ}^{_{—}}^{P(R)}(u) of the luminous flux intensity in the right formation window, divided by the time-averaged ũ_{calib}_{_{—}}ₗᵢₙ_{_{—}}_{Bi}^{Ξ}^{_{—}}^{P} values of the calibration signal with monotonically-varying duration of pulses.

10. A method of forming and observing stereo images with maximum spatial resolution comprising:
receiving a light wave from an optical source;
providing the first optical modulator, which is matrix-addressed in M rows and N columns, for modulating an intensity or polarization or propagation direction or divergence angle or convergence angle or spectrum or phase or a combination of the said characteristics of the light wave to implement a sum modulation of the light wave in the mn^{th} element of the first optical modulator in accordance with the sum of the values Bₘₙ^{L} and Bₘₙ^{R} of brightness of mn^{th} elements of images of left and right views, wherein n=1, 2, . . . , N, m=1, 2, . . . , M;
providing the second optical modulator, which is matrix-addressed in M rows and N columns, for modulating an intensity or polarization or propagation direction or divergence angle or convergence angle or spectrum or phase or a combination of the said characteristics of the light wave to implement a ratio modulation of the light wave in the mn^{th} element of the second optical modulator in accordance with functions of algebraic relations between values Bₘₙ^{L} and Bₘₙ^{R} of brightness of mn^{th} elements of images of the left and right views;
whereas applying to the control input of the first optical modulator a sum compensating signal sₘₙ^{Σ}^{_{—}}^{comp} which amplitude is directly proportional to the linearization function Λ^{Σ} of the sum modulation;
setting complementary values of optical modulation parameters in the adjacent 2i and (2i−1) columns of the second optical modulator, wherein i=1, 2, . . . , N,
applying to the control input of the second optical modulator a ratio compensating signal sₘₙ^{Ξ}^{_{—}}^{comp} which amplitude is directly proportional to the linearization function Λ^{Ξ} of the ratio modulation;
providing a N-column addressed spatially-periodic optical converter with complementary optical conversion parameters in its adjacent 2k and (2k−1) columns, wherein k=1, 2, . . . , N, for converting the corresponding light modulation characteristic into light intensity modulation to form the first group of N light beams and second group of N light beams in the left Z_{form}^{L} and right Z_{form}^{R} formation zones respectively, wherein the intensity values Jₘₙ^{L} and Jₘₙ^{R} the first and second groups of N light beams are equal to the values Bₘₙ^{L} and Bₘₙ^{R} of brightness of mn^{th} elements of images of the left and right views respectively;
whereas directing to the left view formation zone Z_{form}^{L}:
the first N/2 light beams of the first group passing through N/2 even 2i columns of the second optical modulator and through N/2 even 2k columns of the spatially-periodic optical converter,
the second N/2 light beams of the first group passing through N/2 odd (2i−1) columns of the second optical modulator and through N/2 odd (2k−1) columns of the spatially-periodic optical converter,
directing to the right view formation zone Z_{form}^{R}:
the first N/2 light beams of the second group passing through N/2 odd (2i−1) columns of the second optical modulator and through N/2 even 2k columns of the spatially-periodic optical converter;
the second N/2 light beams of the of the second group passing through N/2 even 2i columns of the second optical modulator and through N/2 odd (2k−1) columns of the spatially-periodic optical converter; and
observing left and right views of the stereo image in the left Z_{V}^{L} and right Z_{V}^{R} observation zones, which are optically coupled with the left Z_{form}^{L} and right Z_{form}^{R} formation zones respectively.

11. The method of claim 10, further comprising:
applying the first sum compensating signal s₍₁₎ₘₙ^{Σ}^{_{—}}^{comp} which amplitude s₍₁₎ₘₙ^{Σ}^{_{—}}^{comp}≈Λ₍₁₎^{Σ}{Bₘₙ^{L}+Bₘₙ^{R}} is directly proportional to the first linearization function Λ₍₁₎^{Σ} of the sum modulation, taken from the sum Bₘₙ^{L}+Bₘₙ^{R}; or
applying the second compensating sum signal s₍₂₎ₘₙ^{Σ}^{_{—}}^{comp}, which amplitude s₍₂₎ₘₙ^{Σ}^{_{—}}^{comp}≈(Bₘₙ^{L}+Bₘₙ^{R})·Λ₍₂₎^{Σ} is directly proportional to the product of the sum Bₘₙ^{L}+Bₘₙ^{R} into the second linearization function Λ₍₂₎^{Σ} of the sum modulation; and
applying the first ratio compensating signal s₍₁₎ₘₙ^{Ξ}^{_{—}}^{comp}, which amplitude s₍₁₎ₘₙ^{Ξ}^{_{—}}^{comp}≈Λ₍₁₎^{Ξ}{Bₘₙ^{L}/Bₘₙ^{R}} is directly proportional to the first linearization function Λ₍₁₎^{Ξ} of the ratio modulation, taken from the ratio Bₘₙ^{L}/Bₘₙ^{R}; or
applying the second ratio compensating signal s₍₂₎ₘₙ^{Ξ}^{_{—}}^{comp}, which amplitude s₍₂₎ₘₙ^{Ξ}^{_{—}}^{comp}≈(Bₘₙ^{L}/Bₘₙ^{R})·Λ₍₂₎^{Ξ} is directly proportional to the product of the ratio Bₘₙ^{L}/Bₘₙ^{R} into the second linearization function Λ₍₂₎^{Ξ} of the ratio modulation;
whereas the first linearization function Λ₍₁₎^{Σ} of the sum modulation is the inverse function Λ₍₁₎^{Σ}=F⁻¹ {Φ₍₁₎^{Σ}} of the first calibration function Φ₍₁₎^{Σ} of the sum modulation nonlinearity; or
the second linearization function Λ₍₂₎^{Σ} of the sum modulation is the reciprocal function Λ₍₂₎^{Ξ}=F^{reciprocal}{Φ₍₂₎^{Ξ}}=1/Φ₍₂₎^{Ξ} of the second calibration function Φ₍₂₎^{Σ} of the sum modulation nonlinearity; and
the first linearization function Λ₍₁₎^{Ξ} of ratio modulation is the inverse function Λ₍₁₎^{Ξ}=F⁻¹{Φ₍₁₎^{Ξ}} of the first calibration function Φ₍₁₎^{Ξ} of the ratio modulation nonlinearity; or
the second linearization function Λ₍₂₎^{Ξ} of the ratio modulation is the reciprocal function Λ₍₂₎^{Ξ}=F^{reciprocal}{Φ₍₂₎^{Ξ}}=1/Φ₍₂₎^{Ξ} of the second calibration function Φ₍₂₎^{Ξ} of the ratio modulation.

12. The method of claim 10, further comprising:
applying a linearly-varying calibration signal s_{calib}_{_{—}}ₗᵢₙ^{Σ} of the sum modulation to the control input of the first optical modulator; whereas determining the first calibration function Φ₍₁₎^{Σ} of the sum modulation nonlinearity as the assemblage Φ₍₁₎^{Σ}=J_{calib}^{Σ} of the calibration values of the ratio component J_{calib}^{Σ} of the light flux intensity in either of the formation zones, or
applying a monotonically-varying calibration signal s_{calib}^{Σ} of sum modulation to the control input of the first optical modulator; whereas determining the second calibration function Φ₍₂₎^{Σ} of the sum modulation as the ratio Φ₍₁₎^{Σ}≈J_{calib}^{Σ}/s_{calib}^{Σ} of the sequence of calibration values of the sum component J_{calib}^{Σ} of the light flux intensity in either of the formation zones to the sequence of the corresponding values of the monotonically-varying calibration signal s_{calib}^{Σ}; and
applying a linearly-varying calibration signal s_{calib}_{_{—}}ₗᵢₙ^{Ξ} of the ratio modulation to the control input of the second optical modulator; whereas determining the first calibration function Φ₍₁₎^{Ξ} of the ratio modulation as the ratio Φ₍₁₎^{Ξ}≈J_{calib}^{Ξ(L)}/J_{calib}^{Ξ(R)} of the sequence of the calibration values of the ratio component J_{calib}^{Ξ(L)} of the light flux intensity in the left formation zone to the sequence of the calibration values of the ratio component J_{calib}^{Ξ(R)} of the light flux in the right formation zone, or
applying a monotonically-varying calibration signal s_{calib}^{Ξ} of the ratio modulation to the control input of the second optical modulator; whereas determining the second calibration function Φ₍₂₎^{Ξ} of the ratio modulation as the ratio
$${Φ}_{( 2 )}^{Ξ} = \frac{{J}_{calib}^{Ξ ( L )} / {J}_{calib}^{Ξ ( R )}}{{s}_{calib}^{Ξ}}$$
of the sequence of the calibration values of the ratio component J_{calib}^{Ξ(L)} of the light flux intensity in the left formation zone to the sequence of the calibration values of the ratio component J_{calib}^{Ξ(R)} of the light flux intensity in the right formation zone, divided by the sequence of the corresponding values of the amplitude of the monotonically-varying calibration signal s_{calib}^{Ξ} of the ratio modulation.

13. The method of claim 10, wherein the linearization function Λ^{Σ} of the sum modulation depend on the ratio signal, and/or the linearization function Λ^{Ξ} of the ratio modulation depend on the sum signal.

14. The method of claim 10, further comprising:
modulating the light flux intensity to implement a real-valued sum modulation;
modulating the polarization of the light flux to implement a polarization ratio modulation; and
providing the first and second polarization analyzers with complementary polarization parameters to convert the polarization ratio modulation of the light flux into corresponding component of light flux intensity.

15. The method of claim 2, further comprising:
modulating the light flux intensity to implement a real-valued sum modulation;
providing optical spectral modulator tunable from the first spectrum to the second spectrum to implement a spectral ratio modulation; and
providing the first and second optical spectral analyzers with the first and second spectral characteristics to convert the ratio spectral modulation of the light flux into the corresponding component of the light flux intensity.

16. The method of claim 10, further comprising:
receiving a collimated light flux;
changing a deflection angle of the light flux in the first transverse direction to implement a sum diffraction modulation;
changing a deflection angle of the light flux in the second transverse direction to implement a ratio diffraction modulation; and
providing a louver optical analyzer, that is asymmetric in two mutually orthogonal transverse directions, to separate the sum diffraction modulation component of the light flux in the first transverse direction and the ratio diffraction modulation of the light flux in the second transverse direction.

17. The method of claim 10, further comprising:
providing an analog modulation of the light flux intensity to implement an analog sum modulation;
providing a bistable polarization modulation of the light flux to implement a ratio bistable modulation; and
providing the first and second polarization analyzers with complementary polarization states for converting the bistable ratio modulation of the light flux into the corresponding bistable variations of the light flux;
whereas the first linearization functions Λ_{(1)Bi}^{Ξ}^{_{—}}^{P} of the bistable polarization ratio modulation is equal to the inverse function Λ_{(1)Bi}^{Ξ}^{_{—}}^{P}≈F⁻¹{(Φ_{(1)Bi}^{Ξ}^{_{—}}^{P}} of the first nonlinearity function Φ_{(1)Bi}^{Ξ}^{_{—}}^{P} of the bistable polarization ratio modulation;
the second linearization function Λ_{(2)Bi}^{Ξ}^{_{—}}^{P} of the bistable polarization ratio modulation is equal to the reciprocal function Λ_{(2)Bi}^{Ξ}^{_{—}}^{P}(u)≈1/Φ_{(2)Bi}^{Ξ}^{_{—}}^{P}(u) of the second nonlinearity function Φ_{(2)Bi}^{Ξ}^{_{—}}^{P P} of the bistable polarization ratio modulation.

18. The method of claim 1, wherein said sum and/or ratio modulation of the light flux is implemented due to a combination of analog and bistable or multi-stable modulation of the light flux characteristic.

19. The method of claim 17, further comprising:
applying a calibration pulse-width signal u_{calib}_{_{—}}ₗᵢₙ_{_{—}}_{Bi}^{Ξ}^{_{—}}^{P} with linearly-varying width of pulses to the control input of the bistable polarization modulator;
whereas determining the first calibration function Φ_{(1)Bi}^{Ξ}^{_{—}}^{P} of the polarization bistable ratio modulation nonlinearity as the ratio Φ_{(1)Bi}^{Ξ}^{_{—}}^{P}(u)≈\tilde{J}_{calib}_{_{—}}_{Bi}^{Ξ}^{_{—}}^{P}(u)/\tilde{J}_{calib}_{_{—}}_{Bi}^{Ξ}^{_{—}}^{P(R)}(u) of the sequence of time-averaged calibration values of the ratio component \tilde{J}_{calib}_{_{—}}_{Bi}^{Ξ}^{_{—}}^{P(L)}(u) of the light flux intensity in the left formation zone to the sequence of time-averaged calibration values of the ratio component \tilde{J}_{calib}_{_{—}}_{Bi}^{P(R)}(u) of the light flux intensity in the right formation zone.

20. An apparatus for forming and observing stereo images with maximum spatial resolution comprising:
a source of stereoscopic video signal;
an optical source;
an electrically controlled sum optical modulator, that is addressed in M rows and N columns, wherein n=1, 2, . . . , N, m=1, 2, . . . , M;
an electrically controlled ratio optical modulator, that is addressed in M rows and N columns, whereas the initial optical states of the working medium in adjacent columns of the ratio optical modulator are set complementary and an aperture of the mn^{th} element of the ratio optical modulator is optically coupled with an aperture of the mn^{th} element of the sum optical modulator;
a N column-addressed spatially-selective optical converter with complementary optical conversion parameters in its adjacent 2k and (2k−1) columns, wherein k=1, 2, . . . , N;
the left formation zone Z_{form}^{L}, the axis of symmetry of which is the common intersection line of the first group of N planes, whereas
the first N/2 planes of the first group pass through the axes of symmetry of the odd (2k−1) columns of the N column-addressed spatially-selective optical converter and through the axes of symmetry of the even 2i columns of the electrically controlled ratio optical modulator, wherein i=1, 2, . . . , N; and
the second N/2 planes of the first group pass through the axes of symmetry of the even 2k columns of the N column-addressed spatially-selective optical converter and through the axes of symmetry of the odd (2i−1) columns of the electrically controlled ratio optical modulator;
the right formation zone Z_{form}^{L}, the axis of symmetry of which is the common intersection line of second group of N planes, wherein
the first N/2 planes of the second group pass through the axes of symmetry of the even 2k columns of the N column-addressed spatially-selective optical converter and through the axes of symmetry of the even 2i columns of the electrically controlled ratio optical modulator, and
the second N/2 planes of the second group pass through the axes of symmetry of the odd (2k−1) columns of the N column-addressed spatially-selective optical converter and through the axes of symmetry of the odd (2i−1) columns of the electrically controlled ratio optical modulator;
a first electronic functional module which output is connected with the control input of the electrically controlled sum optical modulator, the input of the first electronic functional module is connected with the output of the source of stereoscopic video signal;
a second electronic functional module, which output is connected with the control input of the electrically controlled ratio optical modulator, the input of the second electronic functional module is connected with the output of the source of stereoscopic video signal;
wherein the transfer function T^{Σ} of first electronic functional module is the inverse function T^{Σ}=F⁻¹{Φ^{ch}^{_{—}}¹} of m the transfer function Φ^{ch}^{_{—}}¹ of the first optoelectronic channel;
whereas the input the first optoelectronic channel is the control input of the electrically controlled sum optical modulator and the output of the first optoelectronic channel is either of the left Z_{form}^{L} or right Z_{form}^{R} formation zones;
the transfer function Φ^{ch}^{_{—}}¹ of the first optoelectronic channel is the values of the light intensity in either of the left Z_{form}^{L} or right Z_{form}^{R} formation zones, divided by the amplitude of the control signal at the input of electrically controlled sum optical modulator;
the transfer function T^{Ξ} of second electronic functional module is the inversed function T^{Ξ}=F⁻¹{Φ^{ch}^{_{—}}²} of the transfer function Φ^{ch}^{_{—}}² of the second optoelectronic channel, whereas
the input of the second optoelectronic channel is the control input of the electrically controlled ratio modulator, and the outputs of the second optoelectronic channel are both left Z_{form}^{L} and right Z_{form}^{R} formation zones; and
the transfer function Φ^{ch}^{_{—}}^{s} of the second optoelectronic channel is the ratio of the values of the light intensity in the left Z_{form}^{L} formation zone to the light intensity in right Z_{form}^{R} formation zones, divided by the amplitude of the control signal at the input of the electrically controlled ratio optical modulator.

21. The apparatus of claim 20, wherein the output of the optical source is optically coupled with the sequentially arranged sum optical modulator, ratio optical modulator and N column-addressed spatially-periodic optical converter.

22. An apparatus of claim 20, wherein the output of the optical source is optically coupled with the sequentially arranged an N column-addressed spatially-periodic optical converter, ratio optical modulator and sum optical modulator.

23. The apparatus of claim 22, wherein at least one of the sum optical modulator or the ratio optical modulator or the optical converter includes at least one compensating or focusing or polarizing auxiliary optical layer or a combination of said.
